(19) United States
(12) Patent Application Publication
(10) Pub. No.: US 2004/0117731 A1
(43) Pub. Date: Jun. 17, 2004

(54) Automated report building system

(76) Inventor: Sergey Blyashov, San Diego, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/669,142

(22) Filed: Sep. 22, 2003

Related U.S. Application Data
(60) Provisional application No. 60/414,829, filed on Sep. 27, 2002.

(51) Int. Cl. G06F 17/21

(52) U.S. Cl. 715/507; 715/500

(57) ABSTRACT

A system and method for report generation involving creation of a report file defining a report structure. The report structure is based upon at least one report group comprised of one or more page definitions. The report file will typically contain information identifying one or more data sources associated with the at least one report group and field descriptive information relating to a plurality of fields included within the one or more page definitions. Once the report file has been created, data source information is retrieved from the one or more data sources in accordance with the field content information. The method further includes rendering an output report document based upon the report file and the data source information. The output report document includes one or more output report pages formatted consistently with each of the one or more page definitions.

### CROSS-REFERENCE TO RELATED APPLICATIONS

This application claims priority under 35 U.S.C. §119(e) to U.S. Provisional Application No. 60/414,829, entitled AUTOMATED REPORT BUILDING SYSTEM.

### FIELD OF THE INVENTION

The present invention relates to systems and methods for generating reports using information contained within a database and, more particularly, to systems and methods for automatically building reports consistent with a desired layout.

### BACKGROUND OF THE INVENTION

As is well known, the information contained within the data records of a database is often visually presented in tabular form. Various computer programs (e.g., PageMaker™, Microsoft Excel™) are used to create tables based upon such information. However, it is often a cumbersome, laborious process to create tables using these programs. For example, users are frequently required to manually specify commands to be associated with the various rows and columns of a given table. In addition, information is often entered into the cells of each table using manual techniques, which tends to be tedious and labor-intensive. Moreover, existing programs are often relatively inflexible in that it is often difficult to experiment by comparing alternate layout formats or to add/remove records from a completed table without corrupting the underlying structure.

In order to enable the content of databases to be represented more efficiently, a number of “report writer” programs have been developed to present various views of such content. For example, report writers have been developed for many relational database systems in an effort to enable publishing of the information stored in such databases in a simple tabular format. However, such report writers are not particularly well-suited to generate tabular representations of databases in which numerous types or categories of information are desired to be displayed differently. In such cases the report writer needs to be coded with specific instructions for properly handling the various display attributes associated with the information categories. Implementation of this process can be time-consuming and error-prone, particularly in cases in which the applicable database contains a large number of categories and attributes. Moreover, the report writer must generally be modified each time changes are made to the structure of the database, which may prove difficult as such changes are implemented over time.

Report writers often make use of “pivot tables”, which are standard constructs enabling tabular data to be displayed more efficiently. For example, in a Microsoft Excel™ pivot table the cells are arranged in successive pages containing “row by column” grids, with a selected one of the pages being displayed at any given time. Dimensions may generally be assigned to the rows, columns, and pages of a pivot table using menus, tool bars, and wizards. Cells of the pivot table may be accessed by specifying the applicable page, row and column pages, and various results may be obtained by aggregating table values across different dimensions. However, using existing report writers to organize and display tabular information using pivot tables tends to require programming skills not possessed by many users. In addition, many existing approaches require that the code implementing a pivot table be rewritten to appropriately reflect changes to the data each time changes are made to the underlying data records. Moreover, different tabular layout formats generally require separate coding of corresponding pivot tables, thereby increasing system complexity and expense.

### SUMMARY OF THE INVENTION

In summary, the present invention relates to a report generation method which involves creating a report file defining a report structure. The report structure is based upon at least one report group comprised of one or more page definitions. The report file will typically contain information identifying one or more data sources associated with the at least one report group and field descriptive information relating to a plurality of fields included within the one or more page definitions. Once the report file has been created, data source information is retrieved from the one or more data sources in accordance with the field content information. The method further includes rendering an output report document based upon the report file and the data source information. The output report document includes one or more output report pages formatted consistently with each of the one or more page definitions. In particular implementations invocation of a “smartpaging” feature permits the output document to be rendered by automatically generating additional pages as necessary to incorporate the entirety of the data source information into the output report document.

In another aspect, the present invention relates to a method of designing a report file used for automatic report generation. The method includes specifying a structure of the report file by defining a first group comprised of one or more page definitions, the first group being of a first group type selected from among a plurality of predefined group types. The method further includes associating a first data source with the first group. One or more fields are identified for inclusion within each of the one or more page definitions. An association is also specified between content from the first data source and each of the one or more fields.

### BRIEF DESCRIPTION OF THE DRAWINGS

For a better understanding of the nature of the features of the invention, reference should be made to the following detailed description taken in conjunction with the accompanying drawings, in which:

FIG. 1 illustrates a computer network which includes a client/server implementation of the automatic report building system of the present invention.

FIG. 2 provides an illustrative representation of an arrangement of client components within memory of a client unit in accordance with the present invention.

FIG. 3 depicts an exemplary configuration of various server-side components stored within memory of a server unit.

FIG. 4 is a flowchart representing a simplified process of automatically building a report in a desired format in accordance with the invention.

FIG. 5 is a process flow diagram illustrating actions performed by way of a web browser, a web services application and a business logic component in automatically building a report in a desired format in accordance with the invention.

FIG. 6 is a screen shot of a logon window which may be presented to the user via a display upon invocation of the ReportExplorer application.

FIG. 7 is a screen shot of a tool window generated by the ReportExplorer application and upon successful system logon of a user.

FIG. 8 illustratively represents a simplified user logon process which may be conducted prior to enabling substantive interaction between a WEB services application and a selected client component.

FIG. 9 illustratively represents messaging flow occurring when requests generated by a client component are asynchronously submitted and concurrently handled by separate processing threads.

FIG. 10 provides a representation of a simplified sequence of pages presented to a user in connection with generation of an output file in the PDF format in accordance with the present invention.

FIGS. 11-19 are screen shots illustratively representing use of a ReportDesigner application consistent with various aspects of the present invention.

FIG. 20 is a flowchart of a process for generating elements of a ReportGroup.

FIG. 21 is a flowchart representative of a process of group generation in accordance with the invention.

FIG. 22 illustrates a row enumeration procedure relied upon by the group generation process of FIG. 21.

FIGS. 23-30 are screen shots depicting various ways of defining the various groups forming the structure of a report within the context of the ReportDesigner application.

FIG. 31 provides an illustrative representation of certain object-oriented classes of the WEB services and business logic components used in the report generating process of the present invention.

FIGS. 32-36 are screen shots representing various Order By and Filter windows through which various parameters relating to the Order By and Filter output format control expressions may be selected.

FIGS. 37-95 are a series of screen shots illustratively representing a process for defining report files generally of the type PivotTable in a manner consistent with the present invention.

FIG. 96 is a screen shot to which reference is made in describing a smartpaging feature of the present invention.

FIG. 97 is a screen shot of an Expressions Properties window through which arithmetic or logical expressions may be edited.

FIG. 98 is a screen shot of a context menu through which a logical expression may be entered.

FIG. 99 is a screen shot of a context menu through which a mathematical expression may be entered.

FIGS. 100-107 are a series of screen shots to which reference is made in describing an exemplary process of entering and editing logical and mathematical expressions.

FIGS. 108-109 are screen shots illustratively representing one manner in which row/column totals may be defined within report files of the type PivotTable.

### DETAILED DESCRIPTION OF THE INVENTION

### Overview of System Environment

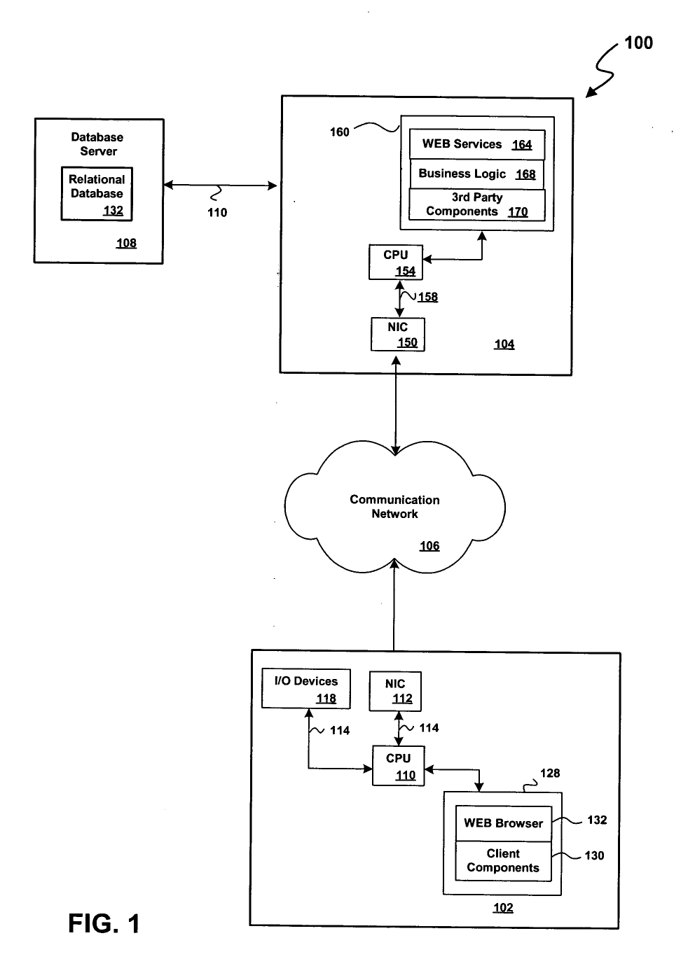

FIG. 1 illustrates a computer network 100 which includes a client/server implementation of the automatic report building system of the present invention. The network 100 includes a client computer 102 that communicates with a server computer 104 via a communication network 106. As shown, the server computer 104 is in communication with a database server 108 via a high-speed connection 110. The network 100 may include a large number of client computers 102 and more than a single server computer 104. Generally, the computer network 100 provides an integrated environment in which the present invention may function to automatically provide electronic reports in a desired format.

Each client computer 102 includes a CPU 110 and network interface circuit 112, which communicate over a system bus 114. The CPU 110 also communicates with a set of input/output devices 118 over the system bus 114. Input/output devices 118 may include a keyboard, mouse, video monitor, printer, etc. The CPU 110 is also connected to memory 122 (primary and/or secondary) via the system bus 114. The mode of interaction between the CPU 110, input/output devices 118, system buses 114, and memory 122 is known in the art. Various client components 130 stored in memory 122 are executed by the CPU 110 in accordance with the invention. In particular, execution of these client components 130 in conjunction with execution by the server 104 of various server-side components (described below) collectively build and render reports in a predefined format based upon the contents of the database server 108. The memory 122 also stores a conventional web browser 132 through which a user may interact with the client components 130.

As is described hereinafter, the present invention enables the automated creation of reports in the Portable Document File (i.e., “PDF”) format based upon the contents of database 132. The inventive automated report building process obviates the need for tedious, time-consuming manual coding of customized report writer routines and thereby facilitates efficient, cost-effective report production.

The server 104 includes a network interface circuit 150 and a CPU 154 that communicate over a system bus 158. The server 104 also includes a memory 160 in which are stored various server-side components used in the inventive report building process. Specifically, memory 160 is seen to store a WEB services application 164, a business logic module 168 and various third party components 170 (described below). When executed by the CPU 154, the program instructions forming the WEB services application 164 and business logic module 168 operate in cooperation with the client components 130 and third party components 170 to effect the automated report building process of the present invention.

In the exemplary embodiment the WEB services application 164 comprises a IIS Application which executes within the Microsoft Net Framework 302. The WEB services application 14 is preferably stateless, and may be activated via a singlecall or singleton. In response to each request received from a client component 130, the WEB services application 164 creates its own SQL Connection and uses it for retrieving or updating data in database 108 (generally by way of business logic module 168).

The database server 108 may store a relational database 132 in which the data is organized according to a number of tables and relationships. Commercially available relational database software includes SQL Server™ and Microsoft Access™ provided by Microsoft Corporation, Oracle™ provided by Oracle™ Corporation of Redwood Shores, Calif., and dBase IV.

A general architecture in which the report building system of the present invention may be implemented has now been described. However, it should be understood that the report building system of the present invention may be implemented in a number of operational environments, including exclusively within the context of a server computer and exclusively within the domain of a client computer.

Attention presently turns to a more detailed discussion of the structure and operation of the client components 130 and the server-side WEB services module 164 and business logic module 168 of the present invention. In the exemplary embodiment these elements of the present invention cooperate to facilitate the automated creation of PDF output reports based upon the contents of database 132.

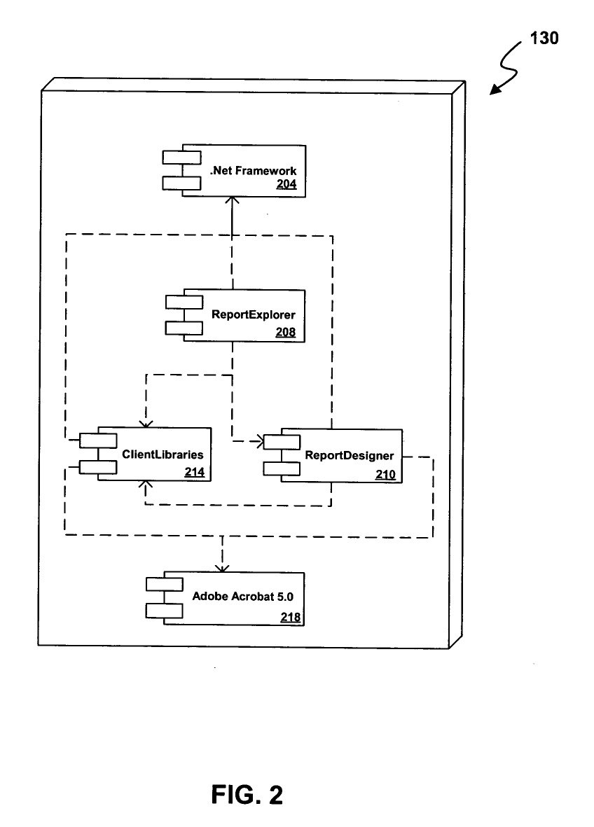

FIG. 2 provides an illustrative representation of an arrangement of client components 130 within memory 122 in accordance with the present invention. In the exemplary embodiment the client components 130 comprise several modules, each of which is composed in Microsoft Net assembly and governed by a .Net environment 204. The client components 130 include a ReportExplorer application 208, a ReportDesigner application 210, and a ClientLibraries module 214. Since in the exemplary embodiment reports are generated in the PDF format, an Adobe Acrobat module 218 is provided for creating and manipulating various PDF files in accordance with the invention. The ReportDesigner application 210 is provided with PDF drawing functionality through the Adobe Acrobat module 218.

The client components 130 are preferably configured to interact with the WEB services application 164, although web-based services need not be invoked in other embodiments of the present invention. This interaction will generally be effected using method calls placed in accordance with the known Simple Object Access Protocol (SOAP). Upon invoking a client component 130, the user specifies the address of server 104 in order to cause SOAP requests to be appropriately routed to the WEB services application 164. When a user selects a “Login” button generated by a client component 130, the client component 130 sends a SOAP request to the WEB services application and awaits a reply. If a response is not received during a specified timeout period or if an error condition arises, an error message is displayed to the user. Otherwise, the user is permitted to continue to interact with the selected client component 130 (e.g., the ReportExplorer application 208).

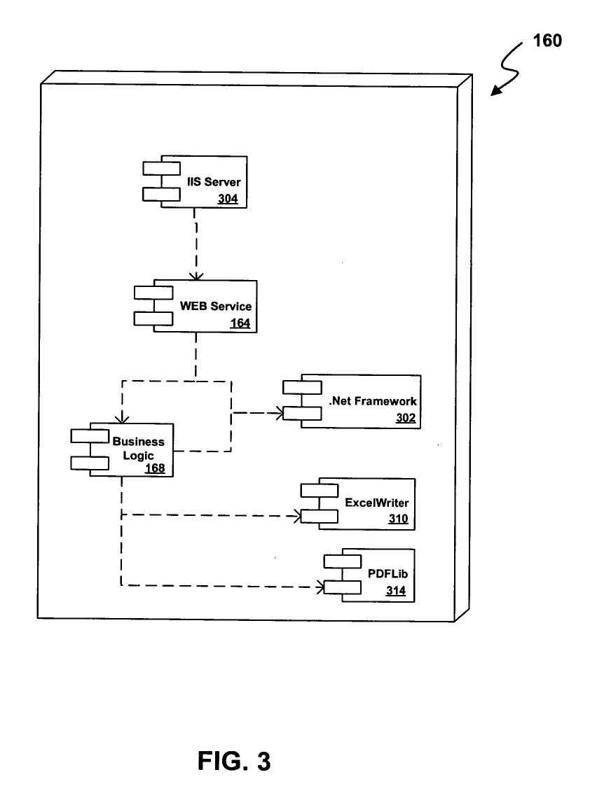

Turning now to FIG. 3, an exemplary configuration of the various server-side components stored within memory 160 are depicted in greater detail. In the exemplary embodiment the server-side components comprise the modules depicted in FIG. 3, each of which is composed in Microsoft .Net assembly and executed within a .Net environment 302. The WEB services component 164 is preferably a stateless object and is called by client components 130 via a IIS server module 304, which functions as a Web server. In response to requests received from the client components, the WEB services module 164 establishes a pooled SQL connection and, in cooperation with the business logic module 168, uses the connection for retrieving or updating information within the database 132. In the exemplary embodiment the 3^{rd} party components may include, for example, an ExcelWriter module 310 and a PDFLib module 314. The PDFLib module 314 functions to programmatically generate PDF content in response to instructions received through its API. In the embodiment of FIG. 3 the PDFLib module 314 comprises a PDFlib software component which is commercially available from PDFlib GmbH of Munich, Germany.

### Operational Overview

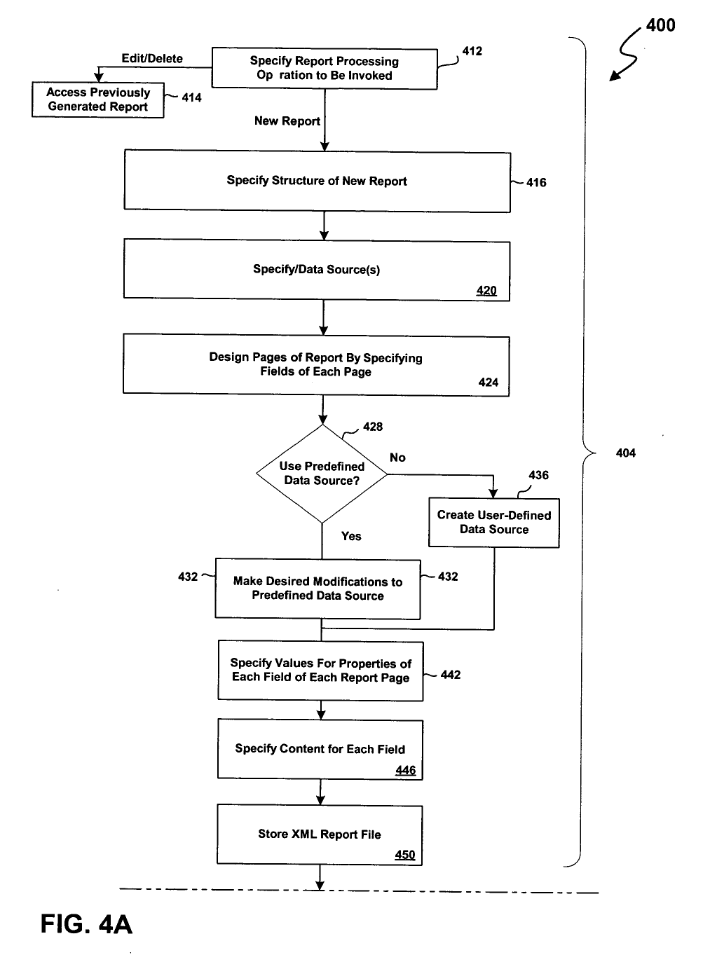

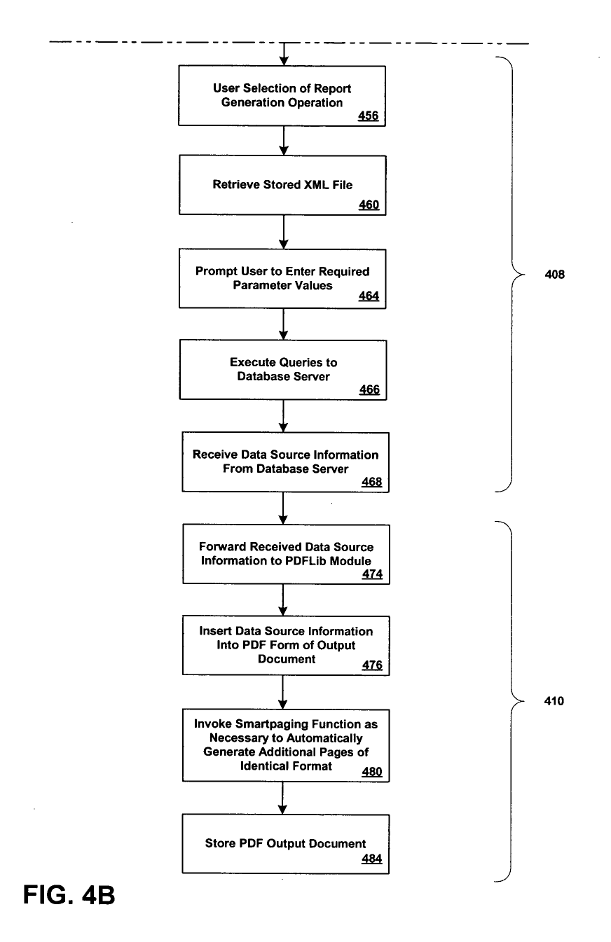

FIG. 4 is a flowchart representing a simplified process 400 of automatically building a report in a desired format in accordance with the invention. For purposes of illustration, the simplified process 400 is depicted as being trifurcated into a report building phase 404, a report generation phase 408, and an output document rendering phase 410. During the report building phase 404 an XML report file is synthesized based upon a desired report format and user-supplied parameters. Once this XML report file has been created, it is used to automatically generate the desired output report during the report generation phase 408. This output report may then be rendered in a desired format (e.g., PDF) during the output document rendering phase 410.

During the report building phase 404, a user initiates execution of the ReportExplorer application 208 and either requests creation of a new report, or deletion or editing of an existing report (step 412). As is described below, a request can also be made to “run” or build a previously defined report (step 414), or to view the PDF file corresponding to a report that had been previously generated. Considering the case in which the user requests creation of a new report, the ReportExplorer application invokes the ReportDesigner application 210. The ReportDesigner application 210 presents the user with a ReportManager page, through which the user may specify a desired report structure (step 416). In the exemplary embodiment the report structure is specified using a tree-like representation comprised of groups, page definitions (“pages”) and fields. Each group may be responsible for defining a number of pages and other groups, and is associated with a particular data source (e.g., a query to a database 132 within the database server 108) specified by the user (step 420). Each group is comprised of a plurality of pages, preferably of one of three types: Form, Grid, or PivotTable. Use of the Form construct implies that each row of a data source or “datasource” is output to one or more pages. Pages are generated using the Grid construct by placing predefined numbers of rows upon each of one or more pages in succession. When a PivotTable format is selected, a table having a variable number of rows and columns is created. Pages structured consistently with the PivotTable group may be constructed using data from one or more data sources within the database server 108 (e.g., data from a first source being used to create rows of the table and data from a second source being used to create columns of the table).

In the exemplary embodiment a report is comprised of a series of pages, each of which is associated with a particular group. During the process of designing a report, a user specifies the fields to be included within each page using a “drag and drop” interface (step 424). The group of a page determines which fields are accessible for placement in the page. Upon receiving the field selections from a user, the ReportDesigner application 210 enables creation of a suitable database query string for capturing the appropriate data from the database server (i.e., a data source). The ReportDesigner application 210 provides the user with the opportunity to create a user-defined data source for a given group, or to utilize a predefined data source associated with the group (step 428). In the latter case the ReportDesigner may present the predefined database query string to the user in order to allow the user to effect any desired modifications (step 432). When the user chooses to specify a user-defined data source, the ReportDesigner will preferably return previously-created user-defined data sources for potential selection by the user (step 436). The user may then select one of the previously-created user-defined data sources or specify a new user-defined data source.

The user then provides the ReportDesigner application 210 with values for various properties (e.g., location on page layout, font, alignment) associated with each of the fields of each report page (step 442). In addition, the user then specifies the content to be associated with each field (step 446). The content associated with a field may be specified relatively simply (e.g., a single item or data source), or may comprise a more complex combination of items. The user preferably selects content items for a field from a displayed “fields tree”. Specifically, an element of the fields tree is dragged by the user to a field position in the layout of a given page layout, thereby creating a new field (when no content item previously existed at the specified field position) or adding a new content to an existing field. Next, the user may be prompted for any additional required parameter values needed in association with the report structure information for the XML report file (step 448). Once the content and properties associated with each field have been specified, information relating to the structure of the XML report file and any associated parameter values are stored for later retrieval during the report generation phase 408 (step 450). In the exemplary embodiment the stored information relating to the XML report file is comprised of arrays containing values of the properties, content items and other items described above.

Turning again to FIG. 4, the report generation phase 408 begins upon selection by the user of a report generation operation (step 456). In response, the information relating to the XML report file is retrieved from the ReportDesigner application 210 (step 460). Based upon this information, the XML report file is created (step 462). Next, queries to the database sever 108 are executed based upon the data sources (i.e., previously defined SQL queries) contained within the XML report file (step 466). In response, data source information is received from the database server (step 468).

As was mentioned above, in the exemplary embodiment the present invention is utilized to create documents in the PDF format on the basis of designated data sources and user-supplied parameters. Accordingly, in the exemplary embodiment the output document rendering phase 410 is commenced by forwarding the received data source information to the PDFLib module 314 (step 474). This data source information is associated with the set of x,y locations included within an output document, and causes the PDFLib module 314 to insert the data source information into corresponding locations of a PDF form which is filled in order to create such output document (step 476). As is described below, a “smartpaging” feature of the present invention automatically generates additional pages of identical format to the extent necessary to accommodate placement of the data source information in the output document (step 480). Once all of the data source information has been read into the PDF form of the output document, the output document is stored in the PDF format and may be viewed by the user (step 484).

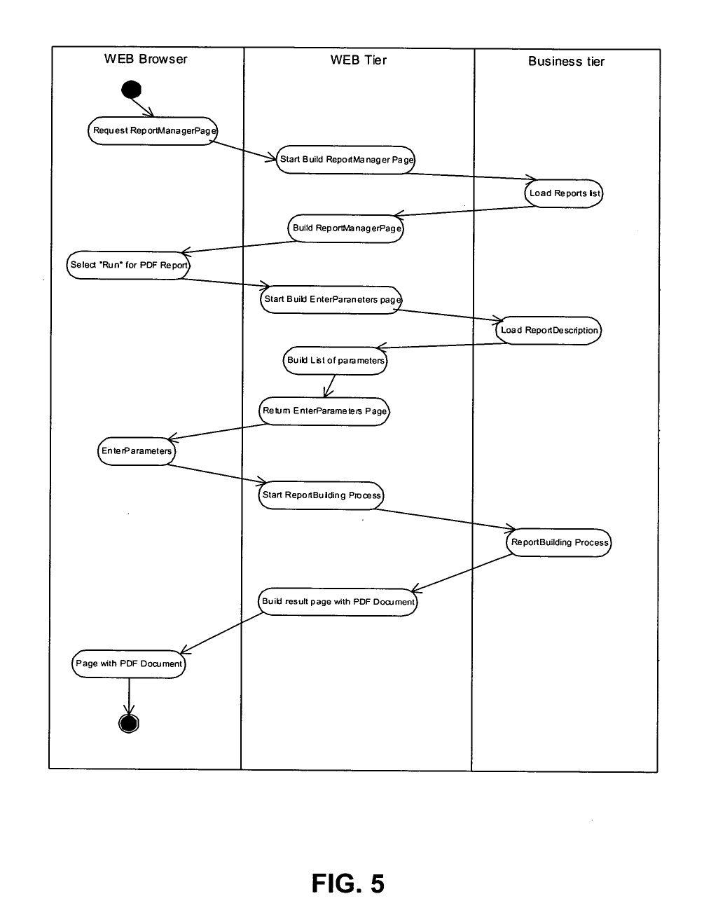

FIG. 5 is a process flow diagram illustrating actions performed by way of the web browser 132, web services application 164 and business logic 168 in automatically building a report in the desired format in accordance with the invention.

Client Components

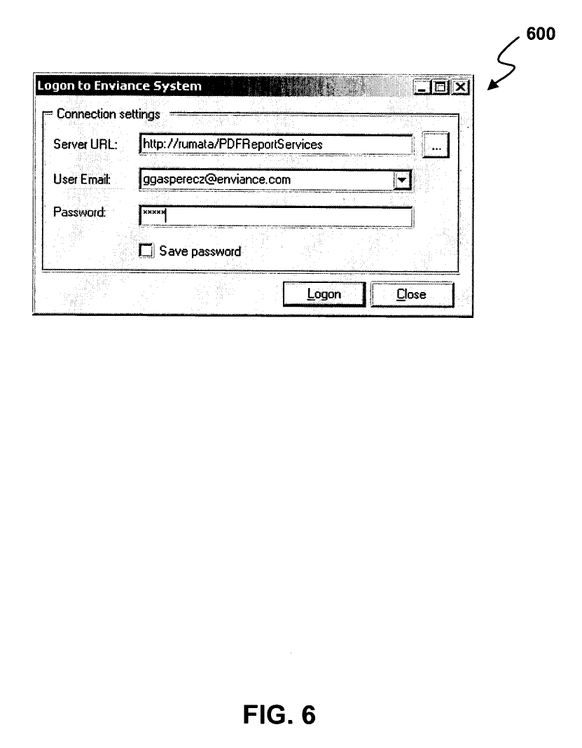

Attention will now be directed to a more detailed description of the manner in which various client components 130 may be utilized in connection with operation of an exemplary implementation of the inventive report building system. For example, upon invocation of the ReportExplorer application 208, a screen shot of a logon window 600 (FIG. 6) may be presented to the user via a display (not shown) of the I/O devices 118. In order to proceed with the logon process, the user would fill out the following fields of the logon window 600:

Server URL (This is the address of the WEB Service, and is of the following format: http://<host_name>/<virtual_directory_name>)

User Email (login of the user);

Password (user password)

Save Password check box

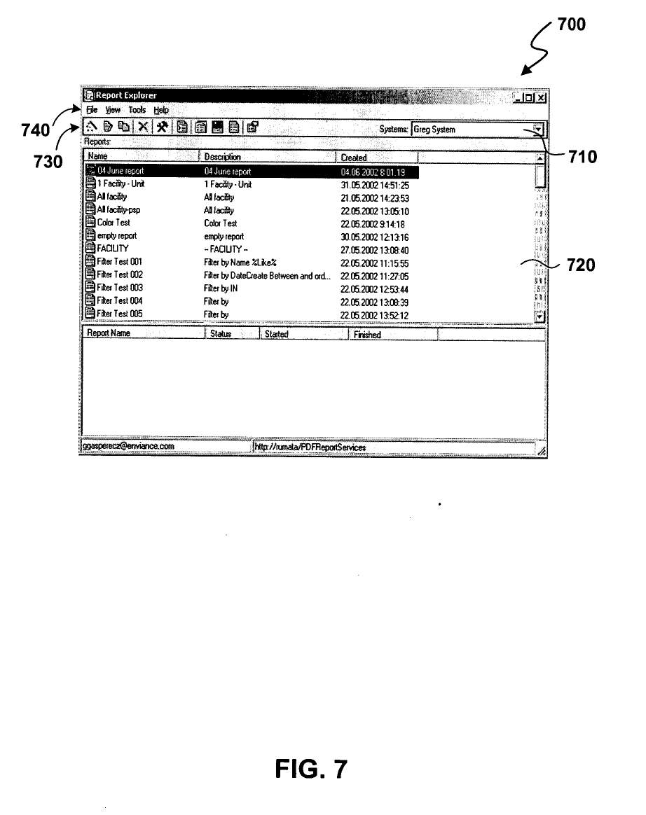

Upon successful logon of the user, a tool window 700 will be generated by the ReportExplorer application 208 and presented to the user (see screen shot of FIG. 7). The box 710 within the tool window 700 allows filtering of the reports displayed. A ListView window 720 contains entries for selected reports and depicts the names, descriptions and creation dates associated with such reports. Using the toolbar 730, menus 740, popup menu (not shown) and keyboard shortcuts a user may perform a number of operations using the ReportExplorer application 208. These operations include creation of a new report, deletion of an existing report, calling of ReportDesigner in connection with editing of an existing report, running an existing report, and viewing of a PDF file of a generated report or/and log of the generation process.

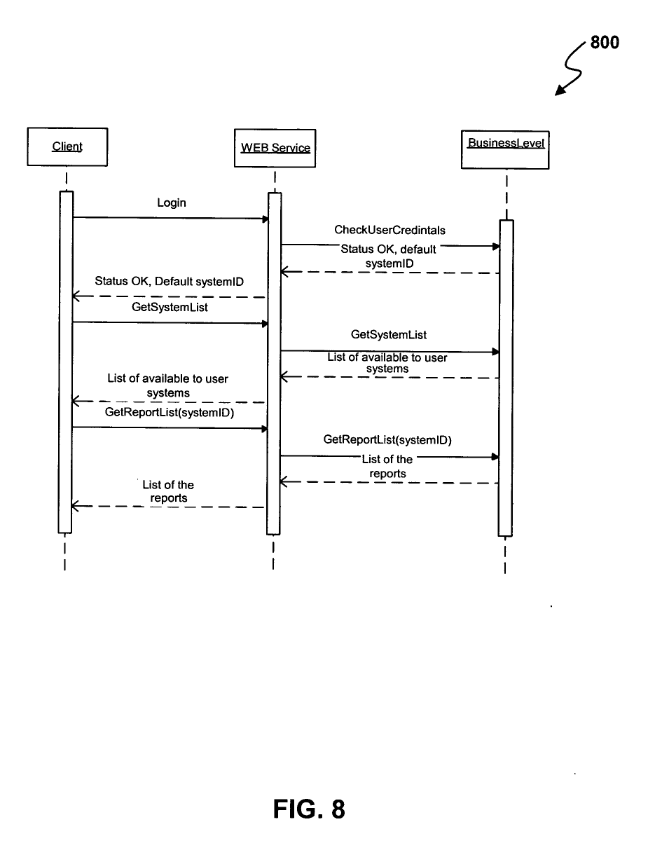

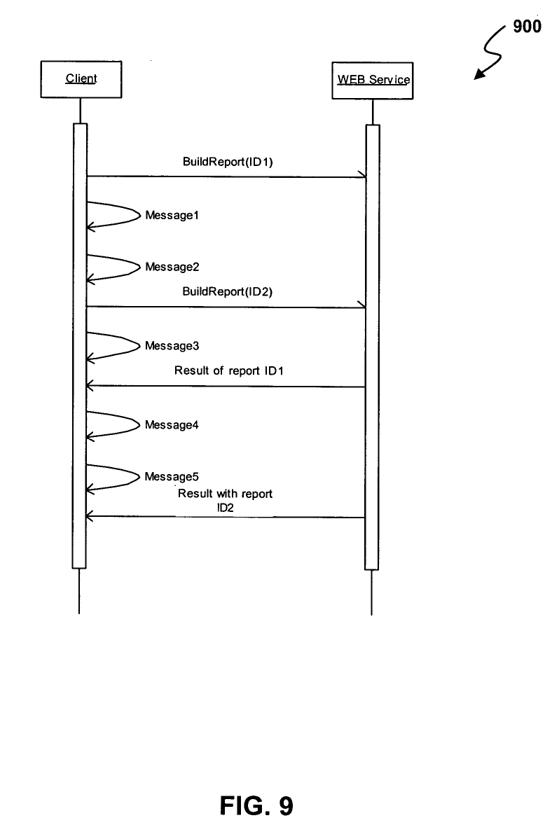

FIG. 8 illustratively represents a simplified user login process 800 which may be conducted prior to enabling substantive interaction between the WEB services application 164 and a selected client component 130. In the exemplary implementation of FIG. 8, each request generated by a client component 130 is handled in a separate processing thread, which permits numerous requests to be handled concurrently. As is illustrated by the messaging flow 900 depicted in FIG. 9, such requests will generally be submitted asynchronously. This occurs because although the report generating process is typically substantially continuous, the user may continue to interact with a client component (e.g., ReportExplorer 208 or ReportDesigner 210) during the report generation process. When generation of a particular report has been completed, a callback function is called on the client side to indicate the result of report generation process. This results in provision of a PDF field and/or an error log relating to the report generation process.

### Report Building

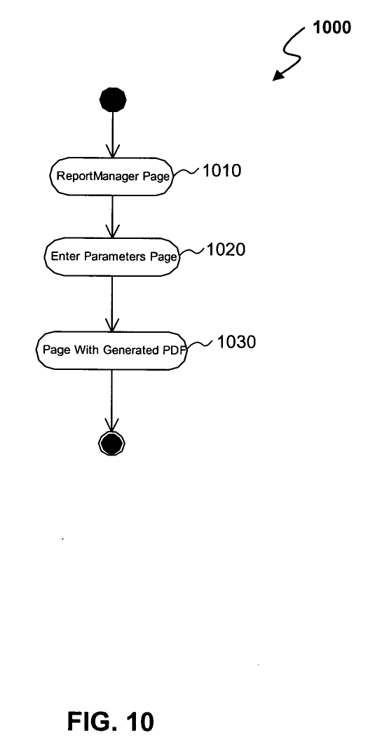

FIG. 10 provides a representation of a simplified sequence of pages 1000 presented to a user in connection with generation of an output file in the PDF format in accordance with the present invention. As shown, the user is initially presented with a ReportManager Page 1010 upon initiating the report building phase. During this phase, the user will generally be prompted to enter a number of parameters through various Enter Parameters Pages 1020. Finally, the user is presented with one or more pages of a corresponding PDF output document 1030 upon conclusion of the report generation process. Additional description of the report building process of the present invention is provided below.

Report Structure

A number of report structures may be specified using the ReportDesigner application 210. For example, various “form” report structures containing blank fields to be filled in with information provided by a user may be utilized. Tabular or grid-like report structures having multiple rows of data may also be specified. When such tabular structures are utilized, the bottom row often includes totals of the values of the various columns of the table. In addition, a pivot table or “cross-tab” structure may also be used. As is known, pivot tables are tabular structures comprised of a variable number of rows and columns. Pivot table structures often include a “totals” row and column positioned along one or more boundaries of the structure. In addition, reports comprised of a combination of the above types may also be specified. Similarly, tables may comprise a complex linking of multiple subsidiary tables; that is, with several source tables linked as master-detail data sources.

In a preferred implementation the report builder of the present invention is configured to construct reports based upon various forms. This results in creation of repots containing a fixed number of page types; that is, each page of a report will generally not be based upon a unique form. When a report is generated using data sources containing large amounts of data, many pages may be generated based upon one or a small number of forms during the process of reading in all of the data into the report structure. This advantageously avoids the necessity of “customizing” each page of the report, which can be tedious and time-consuming.

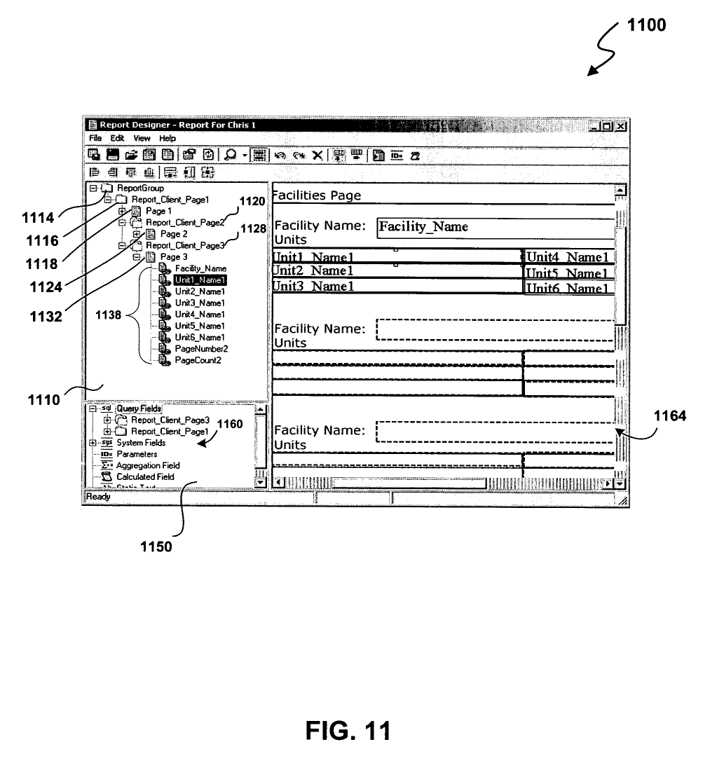

Turning now to FIG. 11, a screen shot 1100 generated by the ReportDesigner application 210 illustrates the tree-like, hierarchical structure of a report structured in accordance with the present invention. As shown, the window 1110 indicates that the exemplary report includes groups, pages and fields arranged in a tree-like structure. More specifically, the tree structure within window 1110 may be characterized as follows:

Top-level group—“ReportGroup” 1114

Subgroup “Report_Client_Page1” 1116

“Page1” 1118, owned by “Report_Client_Page1” 1116

Group “Report_Client_Page2” 1120—detail of “Report_Client_Page1” 1130

“Page2” 1124, owned by “Report_Client_Page2” 1120

Group “Report_Client_Page3” 1128—detail of “Report_Client _Page3” 1128

“Page3” 1132, owned by “Report_Client_Page3” 1128

Fields 1138 linked to “Page3” 1132

Report Groups

In the exemplary embodiment the “group” comprises the fundamental element of a report structure in accordance with the invention. Each group of a report structure may be independently generated or may be a component of another group. Accordingly, each group may contain pages, other groups, and is associated with at least one data source (except the “top-level group” or “ReportGroup” described herein).

In cases where a first group “owns” a second group (i.e., the second group is a component of the first group), there exists a “master-detail” relation between the first or “owning” group and the second or “owned” group. Three general types of groups preferably exist within the automatic report building system of the present invention:

Form—Each row of a data source is output to one or more pages.

Grid—Pages of a report containing a fixed number of rows are sequentially generated. When a page becomes “full” (i.e., after being populated with data), the next page of the report is generated using the same fixed number of rows.

PivotTable—Rows are transformed to a table having a variable number of rows and columns. A PivotTable can be built based upon a single data source, as well as upon on two master-detail data sources (e.g., the master data source could output to the rows and the detail data source to the columns).

Different icons within a ReportStructure tree (see, e.g., FIG. 11) are used to represent different group types.

Report Pages

As was mentioned above, the automatic report generation system of the present invention is premised upon building reports based upon groups (i.e., Forms, Grids and PivotTables). Since each group is comprised of an integral number of pages (i.e., fractional or “partial” pages are not permitted in the exemplary embodiment), a page comprises the “smallest” unit of a report in accordance with the invention. Each page of a report is owned by one or more groups.

When the ReportDesigner application 210 is invoked to design a report, the user places fields on each page of the report. The group associated with each such page determines which fields are to be accessible for output to the page. For example, in window 1150 of FIG. 11 it is seen that “Page3” is owned by “Report_Client_Page3” group. Accordingly, a user can link the fields of the “Report_Client_Page3” group and the fields of “Report_Client_Page1” group, because the “Report_Client Page1” is a master of the “Report_Client_Page3” group.

Report Data Sources

Each group except the top-level group (i.e., the “ReportGroup”) has an associated data source from which data is retrieved for output to instantiations of the group. As mentioned above, in the exemplary embodiment a data source comprises either a user-defined or a predefined query to a database 132 within the database server 108. Use of predefined data sources simplifies the report building process by avoiding the need for potentially repetitive writing of SQL queries for certain common types of data (e.g., facilities list, units, POIs, requirements and data points).

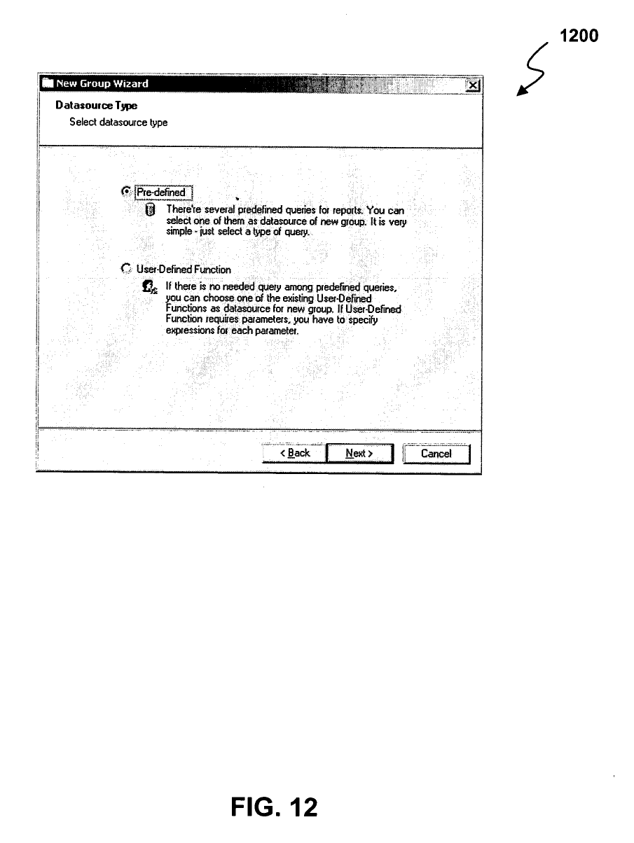

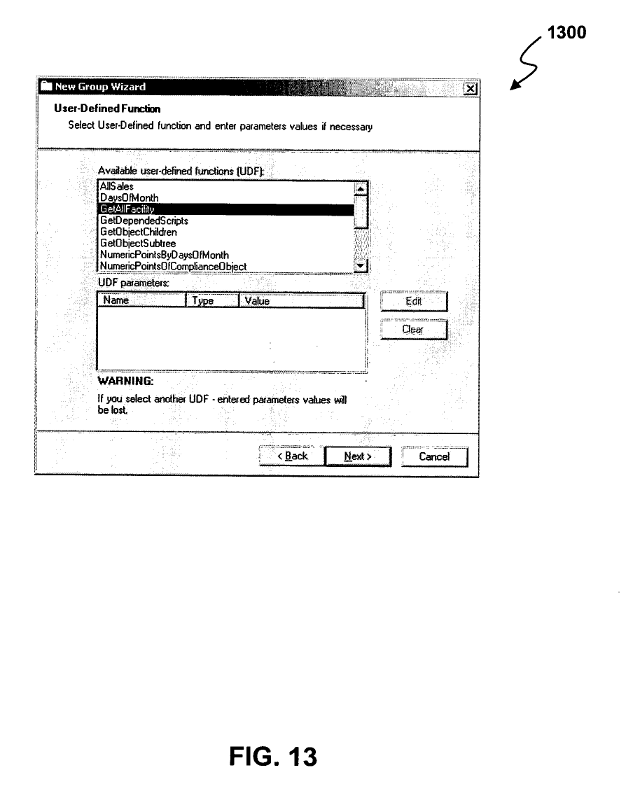

FIG. 12 is a screen shot illustrating a window enabling a user to select either a predefined or a user-defined data source. In the case where the available predefined data sources are not suitable, the ReportDesigner retrieves a list of previously-created user-defined data sources and displays these to the user. This is illustrated by the screen shot of the window 1300 of FIG. 13, which presents such a list of previously-created user-defined data sources (or, equivalently, user-defined functions or “UDFs”) and prompts the user to make a selection.

Several differences generally exist between predefined data sources and UDFs. First, the database query corresponding to a predefined data source is executed only once and at the beginning of the report generation process. In contrast, a UDF is executed once per each row of the pages of a master group. For example, this means that if a given detail group is characterized by a UDF-type and the associated master includes five rows, the UDF for the detail group executes five times (i.e., once per each master row). A UDF may also use pre-selected fields of a master group to define parameter values associated therewith. In addition, a group associated with a UDF cannot own a group associated with predefined data sources, but groups associated with predefined data sources can own groups associated with UDF data sources.

Report Fields

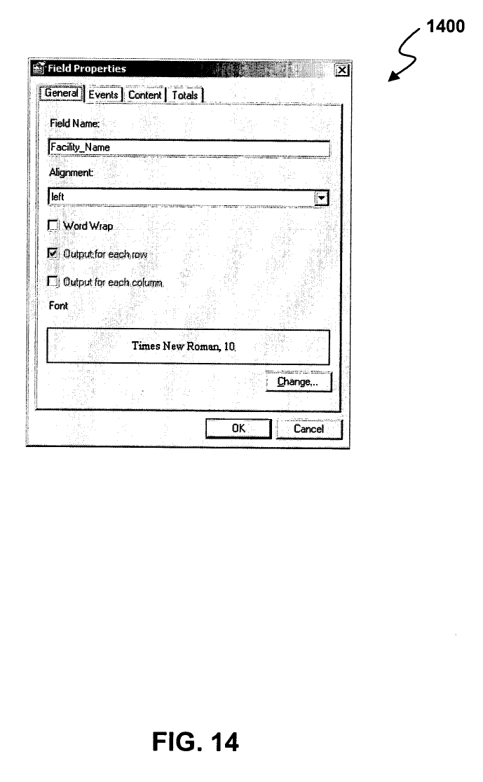

Report fields are elements owned by a page of a report. As is illustrated by the screen shot of the window 1400 of FIG. 14, each field is preferably characterized by a number of properties (e.g., location on page, font, alignment). As was mentioned above, simple or more complex content may also be associated with each field. In the exemplary embodiment, the ReportDesigner application 210 provides a “field tree” used in generating field content (see, e.g., the field tree 1160 within window 1150 of FIG. 11). Elements of field tree 1160 may be “dragged” into the active page layout area (window 1164 of FIG. 11) during the process of either creating a new field or of adding additional content to an existing field. Specifically, when a new content item is dragged from the field tree 1160 and “dropped” into an existing field within page layout window 1164, the content item is added to the existing field. If the new content item is instead dropped in an empty area of the page layout window 1164, a new field is created. During the subsequent report generation process (described below), all of the content items associated with a given field are concatenated and output to the applicable page layout entity.

The following types of content items may generally be specified by the user: query field, aggregation, calculated field, static text and system field. A query field consists of the value of the data source associated with the field; an aggregation is composed of an aggregation of the values of the data sources associated with specified fields; a calculated field corresponds to a result returned by script and a system field may contain a page number, page count, report name and the like.

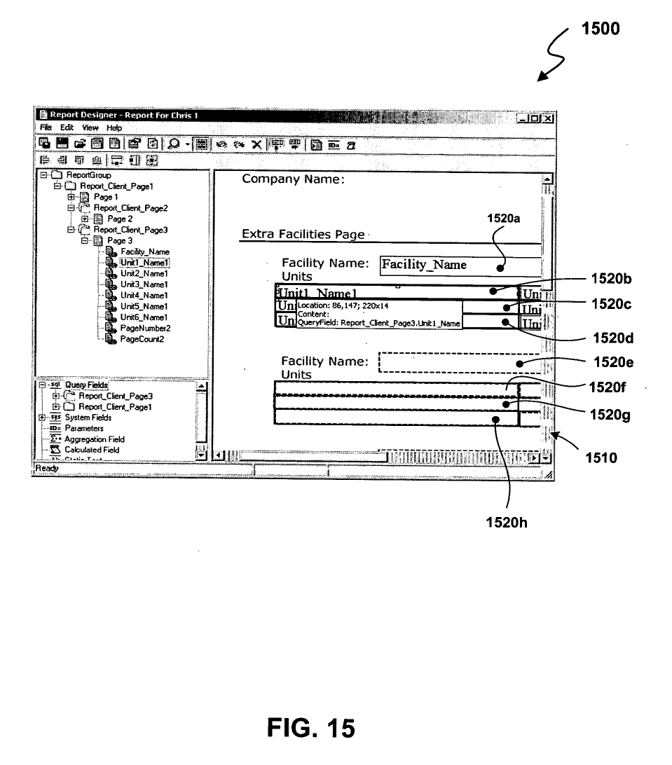

Turning now to FIG. 15, a screen shot 1500 generated by the ReportDesigner application 210 is seen to include a page layout window 1510 in which multiple fields 1520 have been created. Through the page layout window 1510, the content associated with each field 1520 can be viewed and modified. Moreover, hint information 1530 relating to a selected field 1520b is also provided by the ReportDesigner application 210. As shown, such hint information 1530 includes information relating to both the content and location of the field 1520b.

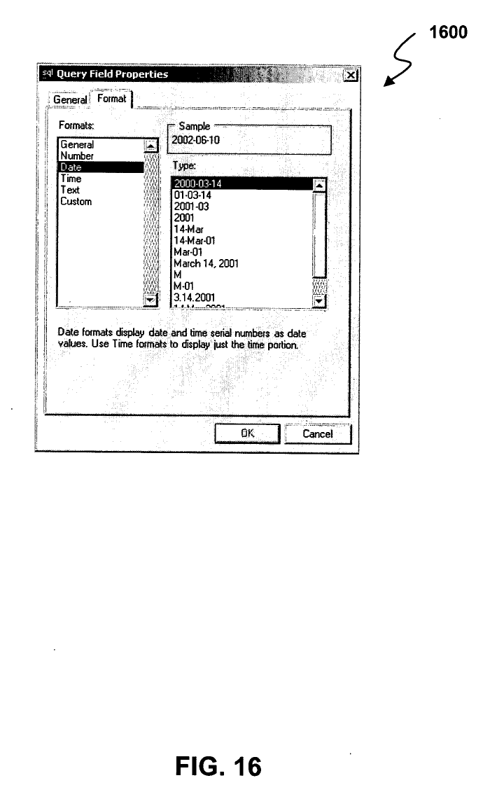

FIG. 16 depicts a window 1600 generated by the ReportDesigner application 210 which may be sued to specify a format for each of the content items associated with a particular field. Such formatting may be used to format content items corresponding to dates, numbers and strings in different ways.

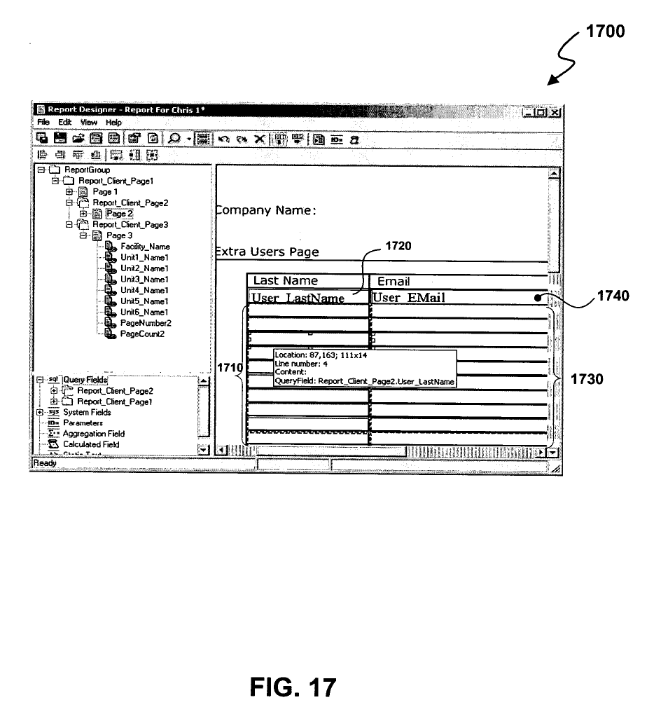

FIG. 17 is a screen shot 1700 illustrating the result of generating clones of fields owned by the pages of various types of groups. In particular, if a field is owned by a page of a group of type Grid or PivotTable, then such field can be automatically placed within each row and/or each column of the page. That is, the field is “cloned” and placed within each row and column as desired. In FIG. 17, there is shown both a selected set of fields 1710 cloned from original field 1720 and a set of non-selected fields 1730 cloned from original field 1740.

Report Events System

Events are scripts that are executed at predefined times during the report generation process. The exact time at which a particular script is executed will depend upon the type of the script and the element of the applicable report with which the script is associated. As is discussed below, scripts of type Page and scripts of type Field are executed at different points in the report generation process.

Top-Level Group Type

As is described in the preceding section, the automatic report building system of the present invention preferably generates a report file comprised of a structured document (e.g., an XML file) which is utilized during a subsequent report generation process to create an output report document. The elements of this structured document are preferably arranged in a tree-like configuration having a “root” corresponding to a top-level group identified herein as a ReportGroup. Once the ReportGroup has been created, pages and other groups may be added as desired. In addition, the following fields may be added to pages included within the ReportGroup: report parameters, system fields, calculation fields, and aggregation fields (assuming at least one subgroup exists).

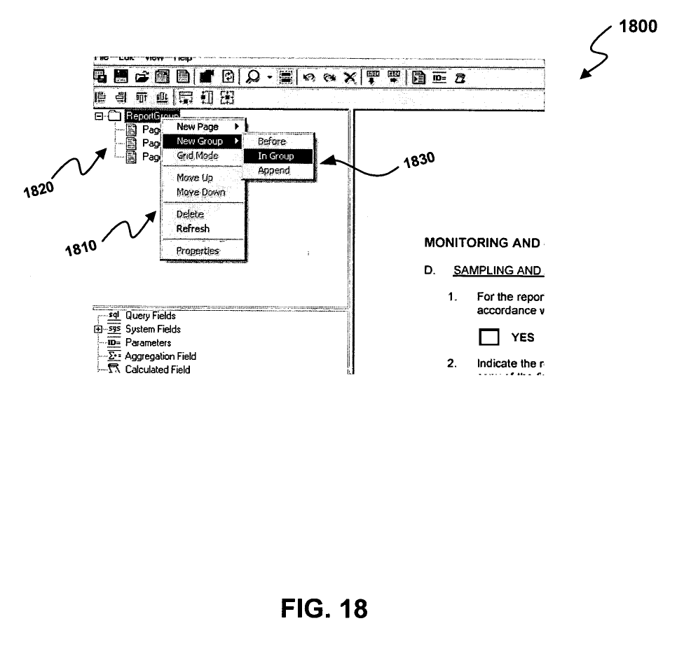

In the exemplary embodiment pages may be added to any group, including the ReportGroup, by accessing a particular pop-up menu created by the ReportDesigner application 210 upon request. For example, the screen shot 1800 of FIG. 18 depicts a pop-up menu 1810 generated by clicking on the right button of a mouse (included within the I/O devices 118) placed upon the report structure tree 1820. From the pop-up menu 1810, the “New Page” item may be selected to reveal a sub-menu 1830 having the following items:

Before—add page before selected tree node

In Group—add page into group (as last page of group)

After—add page after selected node of ReportStructure tree

Depending upon the context from which the “New Page” item is selected, certain items of the sub-menu 1830 may be disabled (i.e., “grayed out”). For example, when the sub-menu 1830 is selected during the viewing of a page, the “In-Group” option is intentionally grayed out.

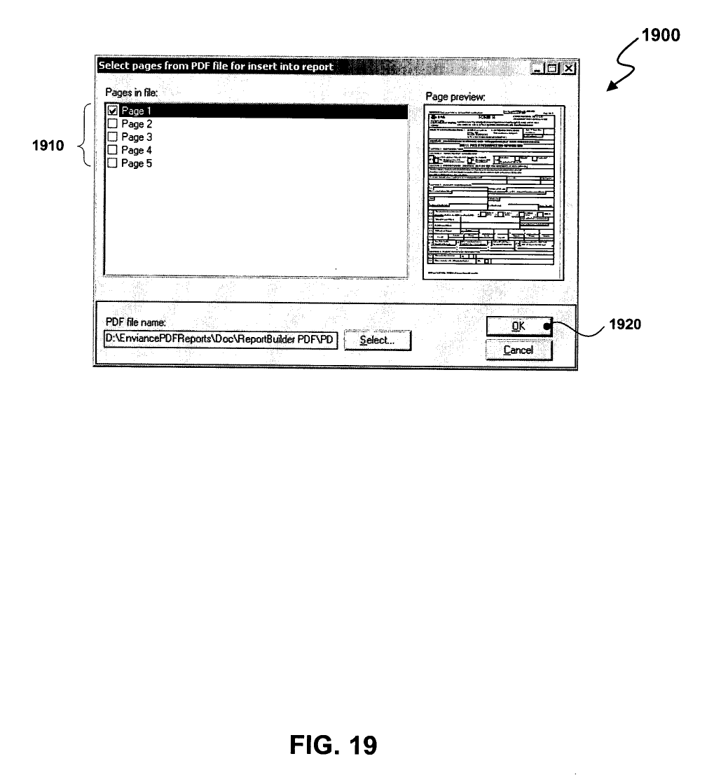

FIG. 19 illustrates a screen shot of an “Add Page” window 1900 that is presented upon selection of an item from the sub-menu 1830. Once the window 1900 is displayed, the necessary pages 1910 are selected and the “OK” button 1920 is clicked. After a page 1910 is added to the group, the page may be deleted or moved up/down relative to its current position using a pop-up menu (not shown) accessible from the window 1900.

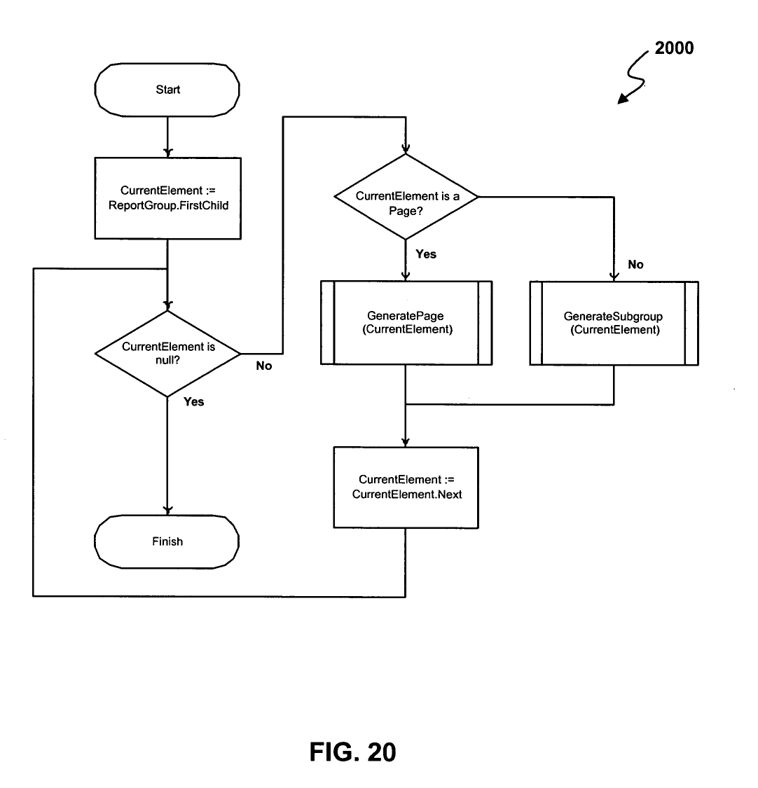

Turning now to FIG. 20, a flowchart is provided of a process 2000 for generating the elements of the ReportGroup. As shown, the process 2000 contemplates generation of subgroups of the ReportGroup and, with respect to each subgroup, the pages comprising each such subgroup. As is discussed below, various “events” associated with each such page (and with any fields of the applicable page) are generally executed upon generation of the applicable page.

Form Group Type

The Form, or “Multi Page” group is designed to facilitate creation of simple reports. For example, the Form group may be appropriate for situations in which it is intended that a single data source be accessed for output to all pages of the group (and to all rows of each page). Each instance of the Form group may include from zero to numerous pages, and data rows of identical format are incorporated into each such page. An instance of a Form group may be created directly as a subgroup of ReportGroup, or may be created so as to exist in a master-detail relationship with another instance of the Form group. Each instance of a Form group can be a “parent” to “child” groups of all types.

A set of standard events may be included within the pages and fields of instances of the Form group. In particular, the following are exemplary “Page” events:

BeforePageGenerate—event is fired before page inserted into resultant output (e.g., PDF) file during report generation process

AfterPageGenerate—event is fired after page inserted into resultant output file during report generation process

The following “Fields” events may also be used in connection with the Form group:

OnFieldGenerate—event is fired when placing field on page during report design process (i.e., prior to the report generation process)

A “Group Wizard” of the ReportDesigner application 210 is typically provided to facilitate generation of instances of a Form group.

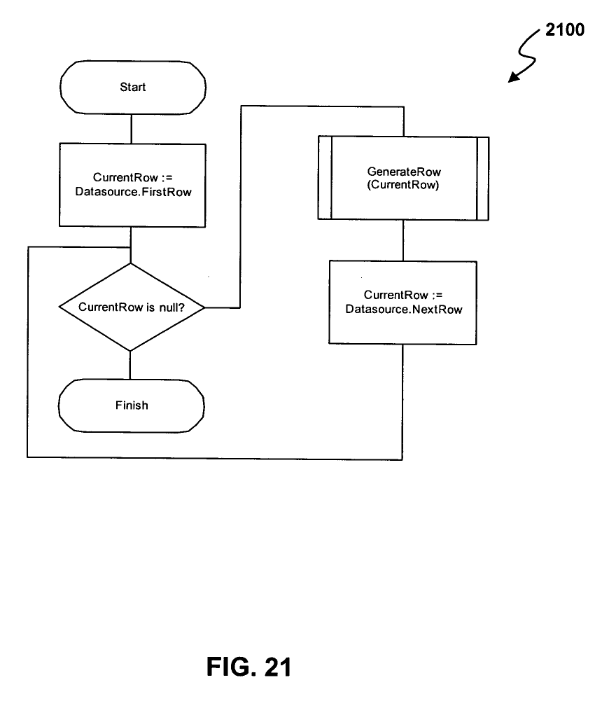

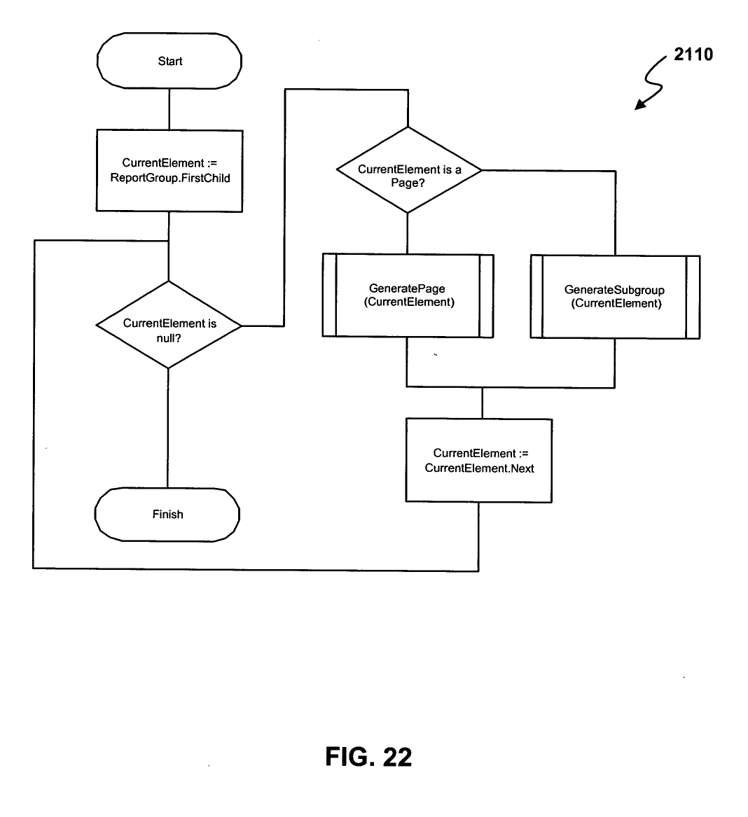

FIG. 21 is a flowchart representative of a process 2100 of group generation in accordance with the invention. As may be appreciated with reference to FIG. 21, the group generation process 2100 relies upon a row enumeration procedure 2110 (FIG. 22) in which the rows of each element of the group (e.g., pages and/or detail groups) are output to the XML report file in sequence as present within the group. Any events associated with a page, or a field therein, are executed at the latest during the process of generating a FDF output report described below. During this process, events associated with fields will be executed and the corresponding field values of the resultant FDF output document modified in accordance with the results of such events.

Grid Group Type

The Grid group is designed to facilitate the representation of source data in tabular form. In particular, each row of each table created using the Grid construct includes an identical set of fields, with an equal space existing between each row. Consistent with a preferred structure of the Form group, data sources for instances of this group and for “parents” of such instances can be defined or modified by manipulating the applicable query fields. Similarly, aggregations can be constructed using any parent dataset (i.e., a set of data which has already been read into an instance of a parent group), any child dataset, and/or any combination of parent and child datasets. For example, an aggregation can be created from the data source of a given line up to including the data source associated with a root of a report).

Instances of the Grid group may be created directly within the context of the ReportGroup or the Form group. Only one page for several dataset records (i.e., a record of a particular data source) can be used in this group. In the exemplary embodiment an association is not permitted between instances of the Grid group and any child groups.

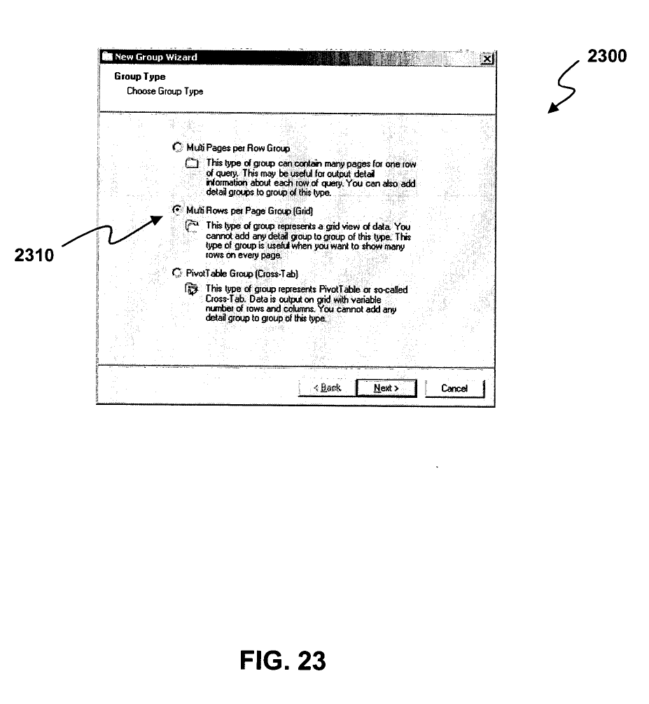

FIG. 23 depicts a screen shot of a window 2300 corresponding to an initial screen of a New Group Wizard generated by the ReportDesigner application 210. The New Group Wizard facilitates creation of instances of the Grid group. Within window 2300, the “Multi rows per Page Group (Grid)” radio button 2310 is selected by the user. Upon advancing from window 2300, a type of data source and name to be associated with the new instance of the Grip group can be specified in similar fashion. Once these steps have been completed, the new instance of the Grid group is displayed on the page. The look and features of the grid may then be modified by changing the grid properties in the manner described below.

Once an instance of the Grid group has been created, pages may be added as desired. This may be effected through, for example, a suitable popup menu invoked by right-clicking upon the Grid group in the ReportStructure tree (see, e.g., FIG. 1) and selecting the New Page/In Group. In the exemplary embodiment, duplicates of each field of a page of the Grid group that is associated with a data source are automatically created and displayed at the time of creation of such field. The one or more duplicate fields associated with each newly-created field of a page owned by the Grid group are generally distinguishable by being presented in a different color from the fields originally created. The number of such duplicate fields created, and their position relative to the originally-created field, depend upon default settings associated with the Grid group. In the exemplary embodiment one such default setting causes the query field to be duplicated and serve as the next dataset value for the active column. In general, duplicate fields are not created for fields within pages owned by the Grid group that are not associated with data sources. However, an “Output for Each Row” flag may be set for certain such fields in order that a desired number of duplicates be generated and displayed upon initial creation of such certain fields.

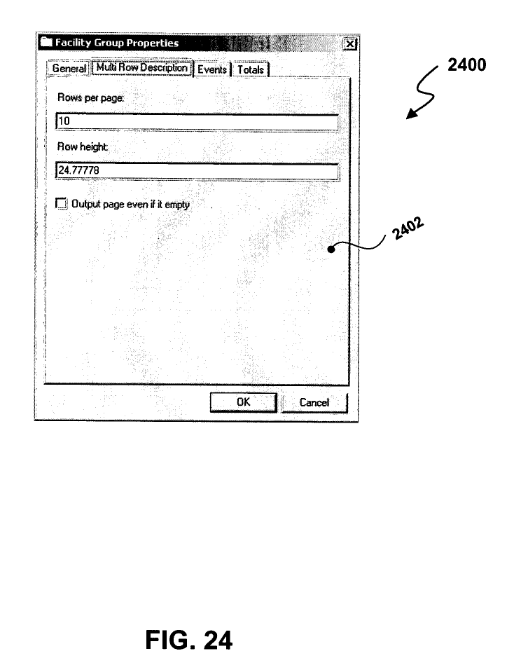

FIG. 24 illustrates a MultiRow description page 2402 of a group properties window 2400 through which other parameters associated with a new instance of the Grid group may be modified. The group properties window 2400 may be selected from a ReportStructure view (tree-like structure) generated by the ReportDesigner application 210. Specifically, the group properties window 2400 is accessed from the ReportStructure view by selecting the “Properties” menu item from the context menu for the MultiRow group. The following parameters may be adjusted via the group properties window 2400:

“Rows perpage”—Sets the number of rows to be included within the applicable page of the Grid group. If this number is set such that the selected number of rows exceeds the maximum number of rows which may be displayed upon the page, the ReportDesigner application 210 generates an appropriate warning message. Typically, this value is set equal to the number of rows in a page of a template PDF document loaded into the ReportDesigner application 210.

“Row height”—Sets the distance between two rows of a page owned by a Grid group. In order to calculate the location at which the next row will generated, this value is added to the vertical position of the previous row. This value may be set in the group properties window 2400 or in the AcrobatDocument View accessible through the ReportDesigner application 210. In the latter case the duplicated field is simply dragged to a desired position, and the ReportDesigner application 210 automatically recalculates Row height based upon the desired position in which the dragged duplicate field is dropped.

“Output page even if it is empty”—Results in the applicable page being inserted into the XML report file even if there exist no records within the data source associated with the applicable Grid group or with such page. For example, in the exemplary case of FIG. 11 there exists a master group (i.e., “Facility”) and an associated detail group (i.e., a MultiRow group of “Units”. On each “detail” page owned by the detail group, information is provided about a particular Unit. However, if there exist no Units in the master group Facility, then by default such a detail page would not be included within the XML report file. However, when the “Output page even if it is empty” option is selected, an empty page will instead be added to the XML report.

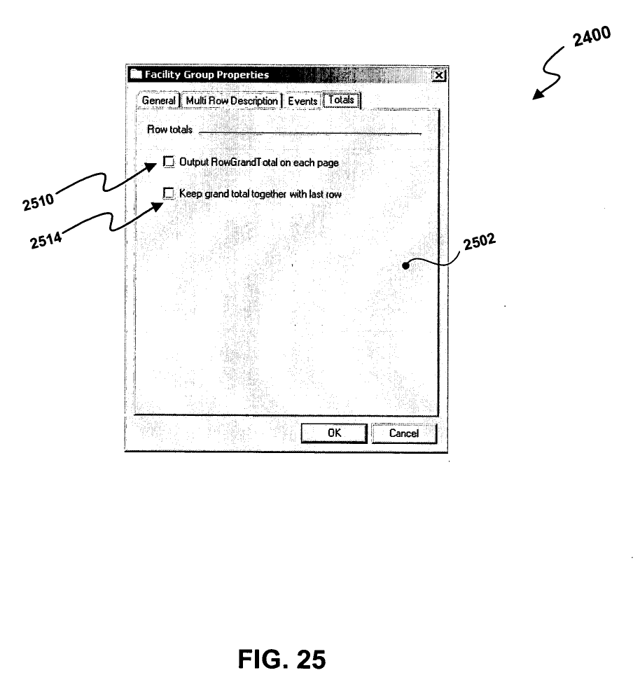

FIG. 25 illustrates a screen shot of a Totals page 2502 of the group properties window 2400. Pages included within instances of the Grid group are configured to calculate aggregate total values for the fields of each row. At least two types of totals may be computed and displayed: Grand Totals and Page Totals. A Grand Total is computed with respect to all records of a dataset, while a Page Total is computed based upon the records for a given page. Page Totals in properties form allows user to customize totals output. Referring to FIG. 25, when the Output RowGrandTotal on each page box 2510 is selected, each page will include a row with grand total data. If a given page is also characterized by a RowPageTotal, then the page will have two rows containing totals data, i.e., a row for RowPageTotal a row for RowGrandTotal. When the Keep grand total together with the last row box 2514 is selected, then the page is organized such that the last data row and the grand total row are located on the same page (i.e., the grand total row is prevented from occupying a separate page in isolation).

At least one event, OnRowGenerate, is associated with instances of the Grid group. The event handler for the OnRowGenerate event is capable of modifying fields in row, adding fields, and inserting page breaks and rows. An exemplary sequence of processing steps resulting from execution of the OnRowGenerate event of the Grid group is set forth below:

Calculates Grand Total if needed

Adds page to report

Adds fields not from row

Calculates fields for row

If event handler present—calls it

Parses result of event (add rows, page breaks and fields)

Calculates next row position

If present Page Total—calculates it

If needed—outputs Page Total and Grand Total

Repeats from 4 until not row count

If data rows present in dataset (data rows more then rows per page) then repeats from 2

PivotTable Group Type

Reports of the PivotTable group type may be used when it is desired to analyze related totals, especially when it is desired to determine the sum of a lengthy list of figures and to compare facts concerning each figure. Instances of the PivotTable group can be created directly in the ReportGroup or as details for the Form group. In addition, instances of the PivotTable group may contain as few as one page, and in this all data is output to this single page. The PivotTable group is not configured to own child groups. Three categories of fields are associated with the PivotTable group:

Column fields—These are fields that can be output as column headers. In the exemplary case of Table I below, “Requirement Name” is a column field. The values of the fields of each column are constants within the bounds applicable to the column.

Row fields—Each row fields is capable of being output as a row header. In the exemplary case of Table I, “Date” is a column field. The values of the fields of each row are constants within applicable bounds.

Cell fields—These are fields that will be output to the cells of the table. In general, it is not permitted place simple fields within a cell. Instead, an aggregation to the cell must be placed within it, because more that one record per row and column may be present in the associated data source. The value within each cell is comprised of an aggregation of the values of all of the fields associated with the cell.

Instances of the PivotTable group are operative to transform a single data source, or a pair of data sources related by a master-detail relationship, into a pivot table. When using one datasource, the fields comprising the vertical headings (or “column keys”) and horizontal headings (or “row keys”) are selected. The field(s) that will populate the center of the PivotTable are then also selected.

Turning now to Table I, an example is provided of a single data source which may be transformed into a report based upon the PivotTable group type.

TABLE I

| Date | Requirement Name | Value |
|---|---|---|
| Jan. 1, 2001 | Requirement1 | 250 |
| Jan. 1, 2001 | Requirement1 | 250 |
| Jan. 2, 2001 | Requirement1 | 10 |
| Jan. 2, 2001 | Requirement2 | 200 |
| Jan. 3, 2001 | Requirement3 | 300 |

After transforming Table I in accordance with the processes of the PivotTable group, the pivot table of Table II may be generated:

TABLE II

| | Requirement1 | Requirement2 | Requirement3 |
|---|---|---|---|
| Jan. 1, 2001 | 500 | | |
| Jan. 2, 2001 | 10 | 200 | |
| Jan. 3, 2001 | | | 300 |

When using a pair of data sources during transformation to the PivotTable format, master data source fields are output as row (or column) fields and details output as column (or row) fields. Table III is an exemplary master data source and Table IV an associated detail data source which may be transformed into a report of group type PivotTable as described above with reference to Tables I and II.

TABLE III

| ID | Requirement Name |
|---|---|
| 1 | Requirement1 |
| 2 | Requirement2 |
| 3 | Requirement3 |

TABLE IV

| Requirement ID | Date | Value |
|---|---|---|
| 1 | Jan. 1, 2001 | 250 |
| 1 | Jan. 1, 2001 | 250 |
| 1 | Jan. 2, 2001 | 10 |
| 2 | Jan. 2, 2001 | 200 |
| 3 | Jan. 3, 2001 | 300 |

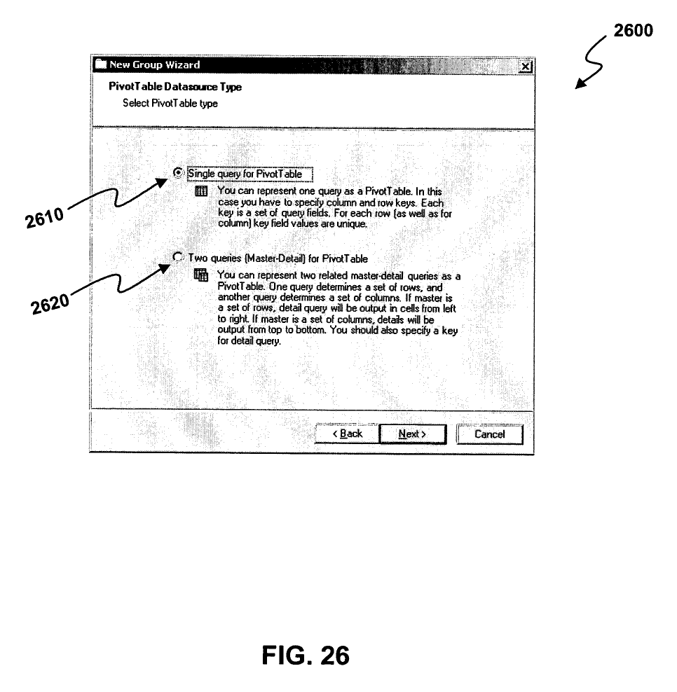

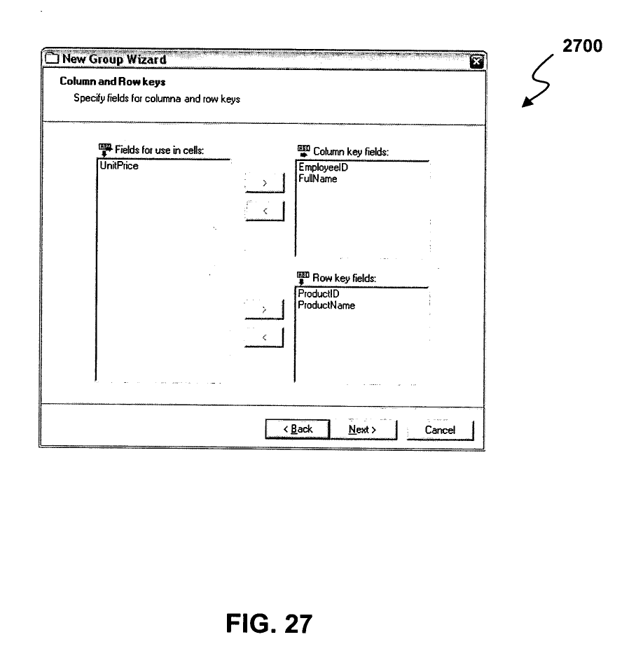

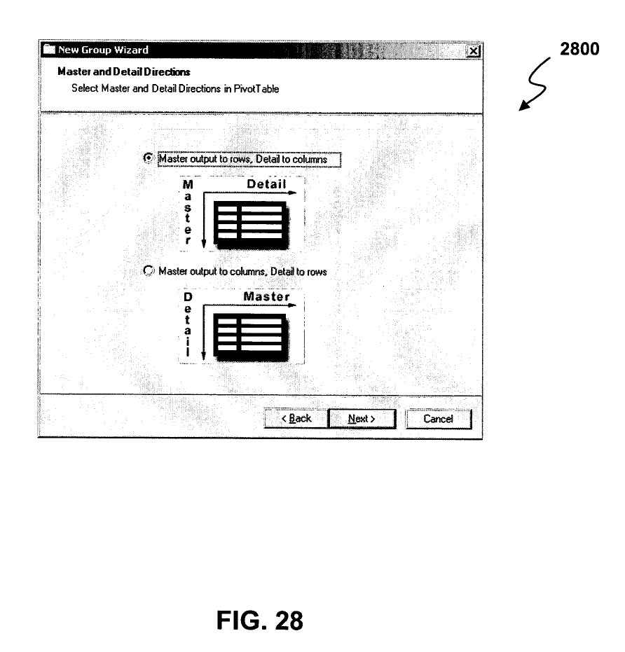

FIG. 26 is a screen shot of a New Group Wizard window 2610 generated by the ReportDesigner application 210 to facilitate creation of a PivotTable group. As shown, a user is prompted to select either a single data source for the PivotTable group via radio button 2610 or a pair of Master-Detail data sources via radio button 2620. In the case where a single data source is selected, the next step is to select column and row keys for the PivotTable group. This selection operation is illustrated by the screen of the New Group Wizard Window 2700 of FIG. 27. If instead a master-detail pair of data sources have been selected for the PivotTable group, an association needs to be specified between the master/detail data source and the rows/columns of the PivotTable group, or vice-versa. This selection operation is illustrated by the screen shot of the New Group Wizard Window 2800 of FIG. 28.

Once a PivotTable group has been successfully created, it is incorporated into a FDF template page in order to enable it be viewed and formatted. An exemplary approach to this process is demonstrated further below.

Totals may also be appended to reports based upon the PivotTable group. In the exemplary embodiment the ReportDesigner application 210 permits totals to be calculated with respect to various different portions of a report:

Cell totals. This type of total contains cell fields, which may include row and column totals values. A cell total may also contain aggregated query fields.

Page Total—Causes totals to be calculated for values on a page (on row or column value)

Grand Total—Results in a total being calculated for an entire report (on row or column value)

Table Page Total—Causes a total to be calculated over the entirety of a page (on rows and columns)

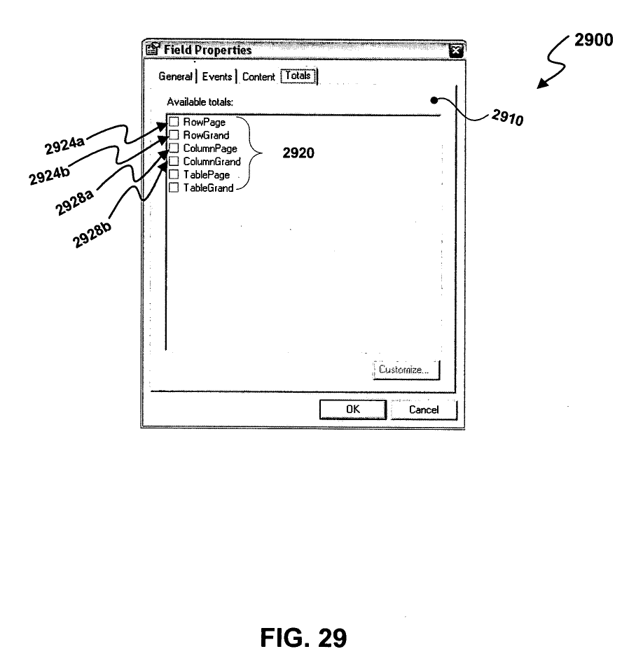

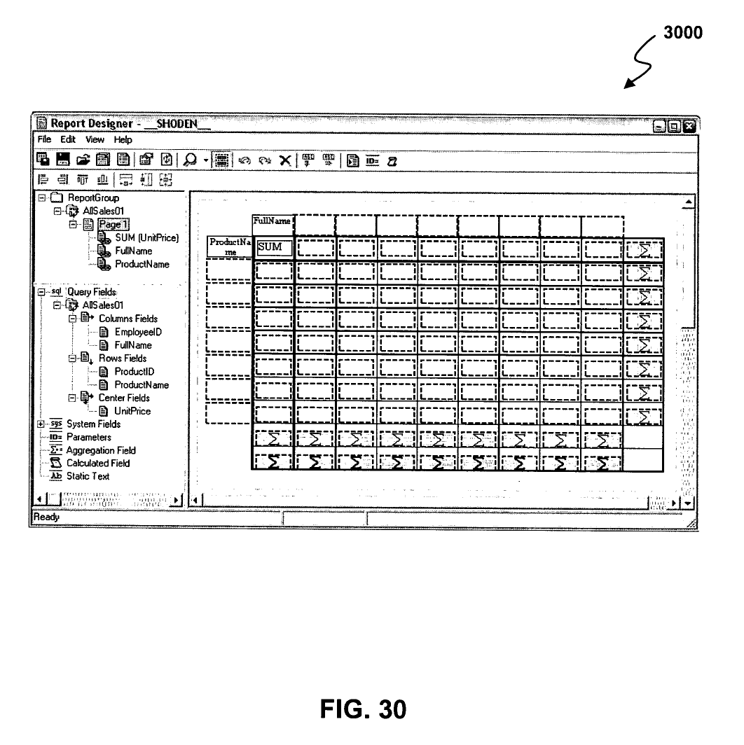

Turning now to FIG. 29, a screen shot is provided of a field properties window 2900 capable of being accessed by “right-clicking” on a selected field and choosing the field contextual menu item “Properties”. Totals may be appended to the selected field by selecting the Totals tab 2910 of the field properties window 2900. As shown, the Totals tab 2910 presents a list of available totals 2920. If a row total 2924 (i.e., RowPage 2924a or RowGrand 2924b) is selected, then the last row on a report page becomes a totals row. If two totals are selected, then the last two rows of a page become totals rows. A similar situation arises when a columns total 2928 (i.e., ColumnPage 2928a or ColumnGrand 2929b) is selected. For example, if a field is defined with RowPage 2924a, RowGrand 2924b and ColumnPage 2928a totals selected and group parameters of 10 rows and columns per page are also specified, the resultant report will have the structure generally depicted in the screen shot 3000 of FIG. 30. That is, all pages will have 9 columns and 9 rows for data output, and a 10th row and column will contain totals values. The last page of the report will also have row grand total. Continuing with this example, if the group property Output RowGrandTotal on each page 2510 (FIG. 25) is selected, all report pages will have 9 columns and 8 rows for data output. In addition, the last column of each page will contain a column page total, the penultimate row will contain a row page total, and the final row will contain row grand total.

In the exemplary embodiment the PivotTable group is configured to be capable of executing a number of standard events also executable by the other group types: Page events (Before and AfterPageGenerate) and Field events (OnFieldGenerate). Different events may be associated with a field of a page and with its totals. For example, references to several different query fields may be appended to a selected field: references to other row key fields may be appended to row headers, references to other column key fields may be appended to column headers, and references in center fields (cells) may be appended to row and column key fields.

Summary of Group Generation

In accordance with one aspect of the present invention, the process of generating the groups forming an XML report file may be summarized as follows:

1) Allocate fields by groups: rows and columns headers fields, static fields and cells fields.

2) Compute how many rows and columns are to be output on one page.

3) Append new page to report and output all static fields to the new page.

4) Compute and output header field values to the page, beginning with column header fields followed by row header fields. During this process information relating to events processing is automatically appended as references to other query fields.

5) Next, cells fields are computed from left to right and from top to bottom.

6) Compute page totals for headers (if needed), beginning first with columns and then followed by rows.

7) Compute page totals for cells (if needed), such page totals corresponding to an aggregation of all cell fields over a given page.

8) Calculate and output table page totals (if needed).

9) Finally, compute grand totals (if needed) and output these to the given page.

The above steps result in creation of a new page containing a set of static fields. However, if the applicable data source(s) require creation of a number of rows or columns exceeding the parameters of the group (i.e., “columns per page” and “rows per page”), then additional appended pages are created as necessary in the following order by way of a “smartpaging” feature of the present invention. In particular, the smartpaging utility operates to: (i) append pages until the last column (row does not change), and (ii) change the value of the “rows per page” parameter and repeat step (i).

### Structure of XML Report File

The XML report file created by the ReportDesigner application 210 contains all of the information necessary to construct an associated PDF file and to build the corresponding PDF-based output report document during run-time execution. For example, to build a PDF-based output report document containing the phrase “Hello World”, it would be necessary for the XML report file to include information relating to font size, style and color as a function of X and Y position. This descriptive information is stored in the XML report file along with the actual text “Hello World”.

In the exemplary embodiment the principal components of the XML report file created by the ReportDesigner application 210 are as follows:

```
  1)  Binary Representation of PDF
  In the XML, this is this looks like pages of random characters,
“JVBERi0xLjQNJeLjz9MNCjEgMCBvYmoNPDwgDS9UeXB1IC9DYXRhbG9nIA0vUGFnZX
MgMiAwIFI”
  2)  Input Parameters
  These are the values entered into the report at run time. E.g.:
  <Parameter Name=“start_date” Type=“date” DefaultValue=“1/1/2003 10:58:23 AM” />
  3)  Database Query
  In the following example, the data source identified as “Requirement” is fully described
and implemented within the PDF Tool.
<DataSource Type=“Requirement” AllDescendants=“false”>
  4)  Descriptive Information
  This following example shows a specific set of instructions for the formatting of text.
Coordinates and all other physical descriptors are also stored.
  <Font Name=“Courier New” Size=“10” Color=“−16777216” Bold=“false” Italic=“false”
Underline=“false” Strikeout=“false” />
  5)  Data Filters and Sort Order
  After the data is returned from the database it is ordered or filtered:
  <TreeFilter>
    <Object Name=“Calc - BOD5 Loading” Path=“NCRA\Refinery Water
Programs\Wastewater Program\Outfall 001 - Permit\Calc - BOD5 Loading”
Type=“Requirement” ID=“f0bb3080-d44b-41c3-8ab5-78f3ba95911e” />
</TreeFilter>
  6)  Custom Scripts
  Users are able to customize the presentation of the data based on simple text scripts:
<Event Type=“OnFieldGenerate”>
    <Script ScriptType=“JScript”>
    <ScriptText>if (CurrentField.Text != ‘NaN’) {
CurrentField.Text = ”
}</ScriptText>
</Event>
  7)  Data
  Any text or value that is either presented on the page or used in calculations is stored in
the XML
  <Constant Type=“integer”>1</Constant>
```

### Report Generation Process

As has been described above, the ReportDesigner application 210 is invoked in order to facilitate creation of an XML report file used during the report generation process to create a FDF output report. Prior to the report generation process, the ReportDesigner application 210 preferably transmits the data forming the basis of this XML report file and any associated parameter values to the server computer 104. Next, the XML report file is created and queries to the database sever 108 are executed based upon the data sources (i.e., previously defined SQL queries) contained within the XML report file. In response, data source information is received from the database server 108. This data source information is then inserted into corresponding locations of a PDF form which is filled in order to create the FDF output report.

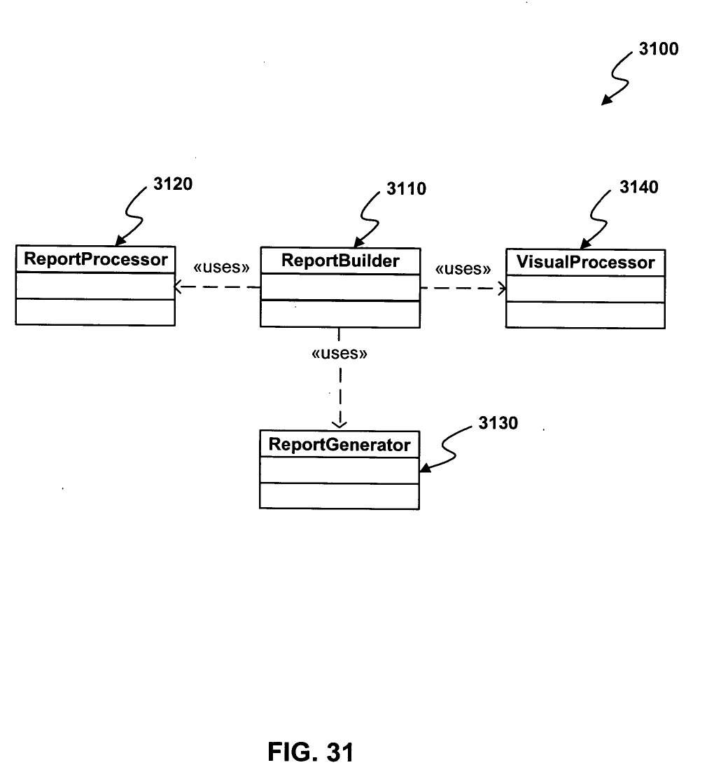

Referring now to FIG. 31, an illustrative representation is provided of certain object-oriented classes 3100 of the WEB services 164 and business logic 168 used in the report generating process of the present invention. These principal classes 3100 include a ReportBuilder class 3110, a ReportProcessor class 3120, a ReportGenerator class 3130 and a VisualProcessor class 3140.

The ReportBuilder class 3110 is the class primarily responsible for managing the report building process. The ReportBuilder class 3110 creates instances of the ReportProcessor class 3120, ReportGenerator class 3130 and VisualProcessor class 3140 and runs appropriate methods for data mining, data processing and PDF document generation.

The ReportProcessor class 3120 functions to build queries for predefined and UDF data sources and to execute these queries when necessary. This class 3120 also provides master-detail relations between groups by way of a FilterDetails method.

The ReportGenerator class 3130 is configured to calculate aggregations of page and field values, calculate the values of specific fields and execute events associated with fields.

The responsibilities of the VisualProcessor class 3140 include generating PDF representations of report file information created in accordance with the invention.

In operation, an instance of the ReportBuilder class 3110 receives as parameters the report description and report parameters values generated by the ReportDesigner application 210. In response, the ReportBuilder class 3110 creates instances of the ReportProcessor 3120, ReportGenerator class 3130 and VisualProcessor class 3140. The instance of the ReportProcessor class 3120 generates and executes all necessary queries. The instance of the ReportGenerator class 3130 generates the XML report file, calculates field values (including aggregations), and calls all existing events. The instance of the VisualProcessor class 3140 then transforms the resultant XML report file into a PDF report file.

Order By and Filter Expressions

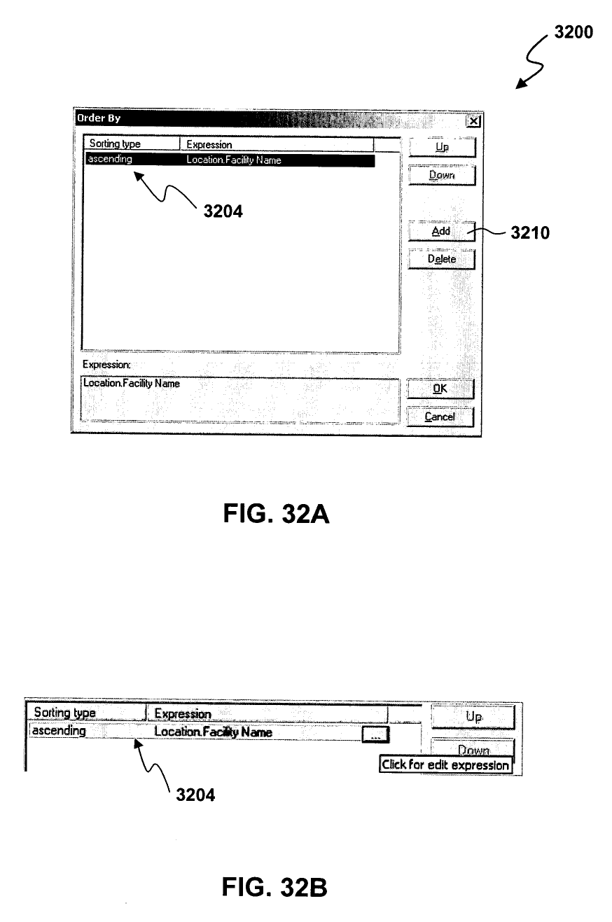

FIG. 32A is a screen shot of an Order By window 3200 through which various parameters relating to an Order By expression may be selected. The Order By expression is designed to facilitate the output of ordered records to the PDF report file. The Order By expression is preferably translated to a SQL query when the request is generated. The Order By window 3200 may be opened from the group properties window. For groups of type PivotTable, the Order By expression is used for setting the order of row and column output. In this case the expression is processed via business logic 168.

The Order By expression is generally complex and consists of several mathematic expressions and information pertaining to a selected type of sorting. After adding an Order By expression (Add button 3210) to the list of such expressions, the record corresponding to the expression 3204 is displayed in window 3200 and may be edited as shown in FIG. 32B. To edit a record in an Order By expression, the text in the necessary row and column is selected. A Combobox control for sort type or Button control for expression will also generally be provided.

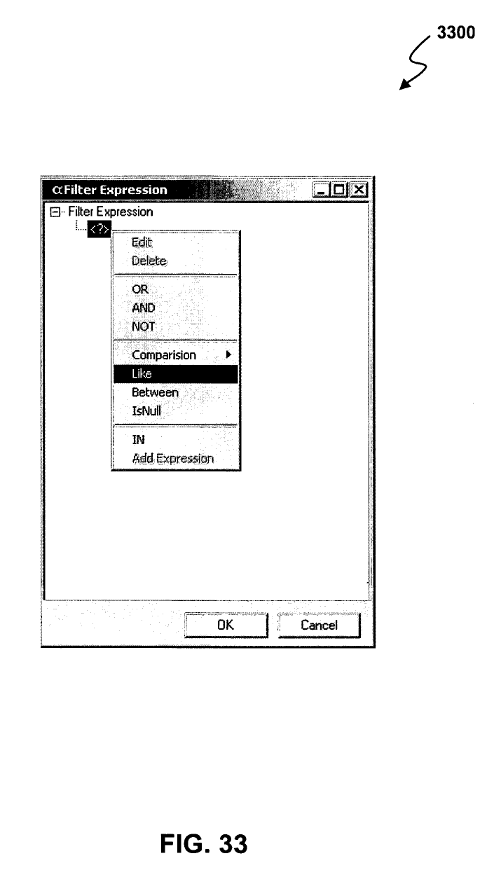

FIG. 33 is a screen shot of a Filter Expression window 3300 through which various filtering expressions may be specified. The filter expression is a logical expression used to select records in accordance with a specified condition. The Filter Expression window 3300 is generated upon appropriate selection from the applicable group properties window. Tables V and VI below respectively provide listings of various Boolean and mathematical filter expressions selectable from the Filter Expression window 3300.

TABLE V
BOOLEAN FILTER EXPRESSIONS

| | | | Operand 3 |
|---|---|---|---|
| Expression | Operand 1 | Operand 2 | (more operands +/−) |
| OR, AND | Boolean expression | Boolean expression | Boolean expression (+) |
| NOT | Boolean expression | — | — |
| =, <>, >, >=, <, <= | Math expression | Math expression | — |
| Like | Math expression | Math expression | — |
| | (String) | (Mask) | |
| Between | Math expression | Math expression | Math expression |
| | (Value) | (LowLimit) | (HighLimit) |
| IsNull | Math expression | — | — |
| IN | Math expression | Math expression (Set) | Math expression (Set) |
| | (Expression) | | (+) |

TABLE VI
MATHEMATICAL EXPRESSIONS

| | | | Operand 3 |
|---|---|---|---|
| | | | (more |
| Expression | Operand 1 | Operand 2 | operands +/−) |
| Field | Query Field | — | — |
| Constant | Static text | — | — |
| Parameter | Report | — | — |
| | parameter | | |
| −(subtraction) | Math expression | Math expression | — |
| /(division) | Math expression | Math expression | — |
| +(addition) | Math expression | Math expression | Math |
| | | | expression (+) |
| *(multiplication) | Math expression | Math expression | Math |
| | | | expression (+) |
| −(negation) | Math expression | — | — |

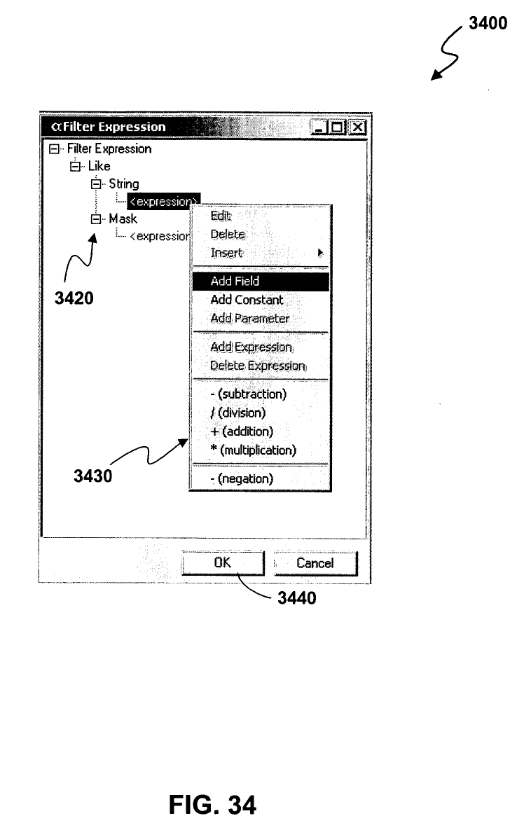

Turning now to FIG. 34, a screen shot is shown of a Filter Expression window 3400 containing a tree 3420 of filter expressions. The tree 3420 may be edited and potentially includes both logical and mathematical filter expressions. In the exemplary embodiment a user may left-click on the tree 3420 in order to display a contextual menu 3430 containing either mathematical or logical elements which may be selected to specify a Filter Expression. That is, the contextual menu 3430 includes mathematical elements when it is selected from the context of a mathematical expression and logical elements when it is selected from the context of a logical expression. Selection of an element from the contextual menu 3430 results in addition of a branch to the expression tree 3420 or launches various forms for adding controls to the tree 3420.

In the exemplary embodiment if the tree expression 3420 includes symbols of the type included within the left-hand column of Table VI, the applicable filter expression has not yet been fully defined and the window 3400 may not be closed simply by clicking the OK Button 3440. To add the required element, the contextual menu 3430 is opened from the displayed symbol and the required element is selected.

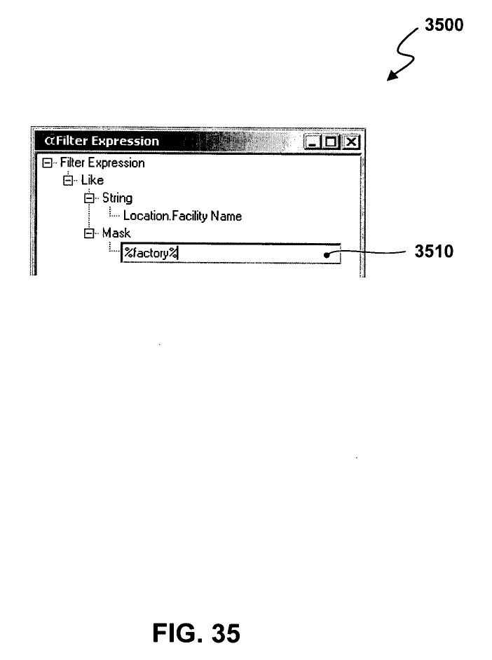

FIG. 35 is a screen shot of a portion of the Filter Expression window 3400 in which an edit box 3510 has been opened. The edit box 3510 permits constants or other information associated with an element of the expression tree 3420 to be added as necessary. In the event the applicable Filter Expression requires no parameters or the context does not permit addition of a particular type of element at the position in the event tree specified by the user, the relevant portions of the contextual menu 3430 will be “grayed out” or otherwise be made inaccessible.

Expression Editing

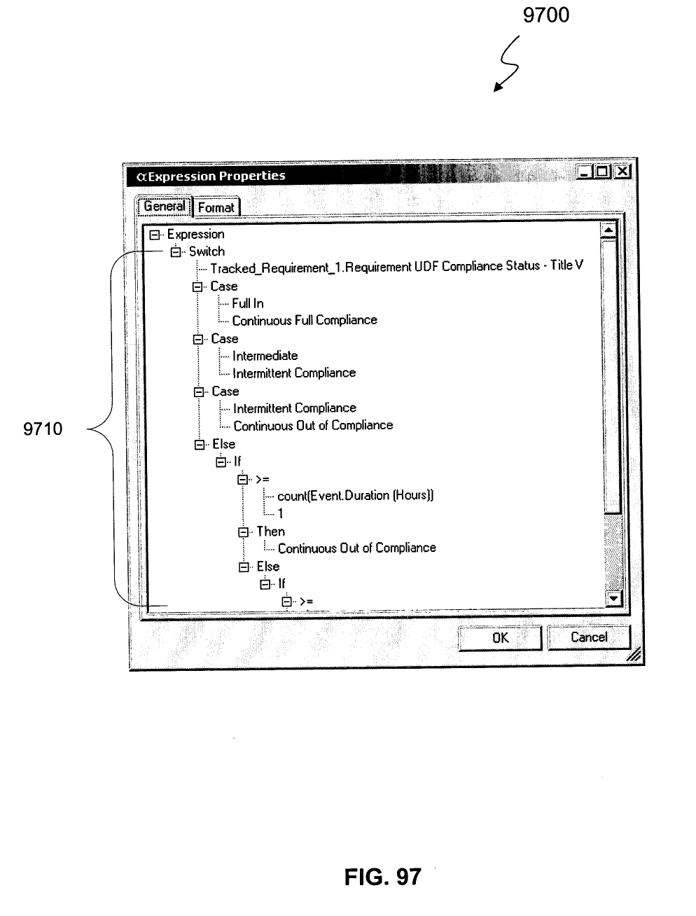

FIG. 97 is a screen shot of a particular Expressions Properties window 9700 through which arithmetic or logical expressions may be edited. In the exemplary embodiment logical expressions may be used to determine the visibility of a given field or define the filtering of aggregations or data sources. Arithmetic expressions may be employed to define various fields and to sort data source information. Expressions are entered as well as edited using an expressions editor, which generates windows such as the Expressions Properties window 9700.

Referring to FIG. 97, both logical and mathematical expressions are displayed within the window 9700 as a tree 9710. Left-clicking on the tree 9710 yields a context menu, which will vary depending upon whether a mathematical or logical expression is being selected for editing. Selecting an item from the context menu adds branches to the expression tree 9710 or launches forms for adding controls to the tree 9710.

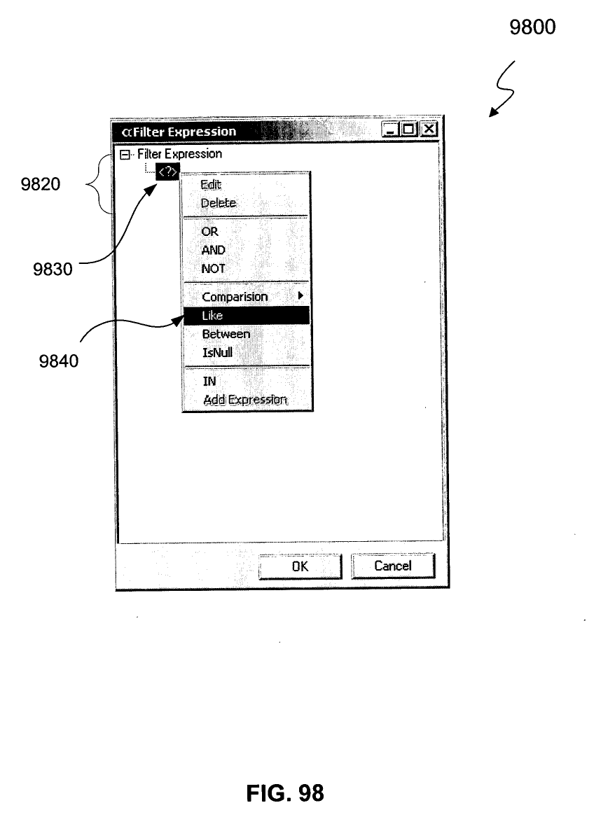

FIG. 98 is a screen shot of a context menu 9800 through which a logical expression 9820 may be entered for subsequent display at highlighted area 9830. As shown in FIG. 98, a LIKE operator 9840 is in the process of being added to the expression 9820.

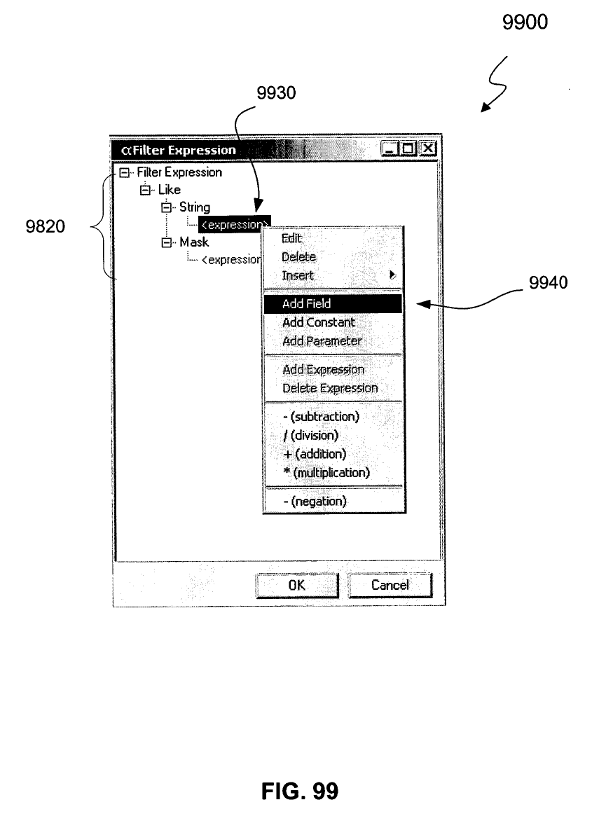

FIG. 99 is a screen shot of a context menu 9900 through which a mathematical expression 9920 may be entered for subsequent display at highlighted area 9930. As shown in FIG. 99, an Add Field menu item 9940 is in the process of being selected in order to add a field to the expression 9920.

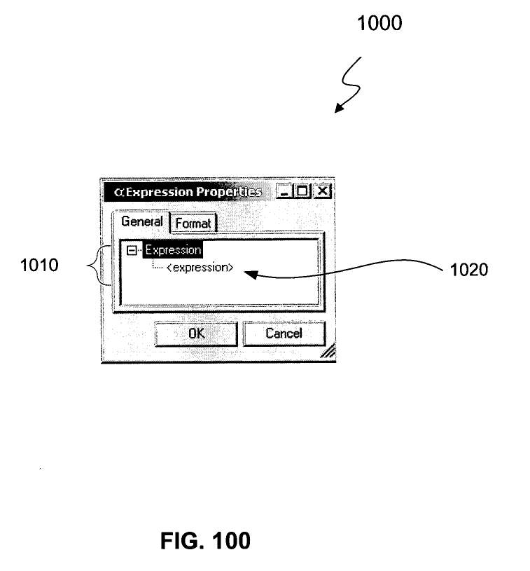

As is described in further detail with reference to FIGS. 100-107, in the exemplary embodiment the process of entering an expression consists of selecting a highlighted node of a displayed expression and selecting an appropriate item from the displayed context menu. A sub-expression within an expression may be deleted by selecting the node and clicking upon the “Delete” command appearing in the menu. In certain implementations a logical or mathematical operation appearing within the expression may be changed (e.g., changing “+” to “−”) by selecting the node and clicking “edit” in the menu. A user will preferably not be deemed to have finished entering an expression (and will be prevented from exiting the applicable editing window) until the expression has been validly defined and values have been specified for all nodes of the expression. An expression will generally be considered to be valid if all operands have coordinated types. For example, it would be impermissible to sum a string and an integer values.

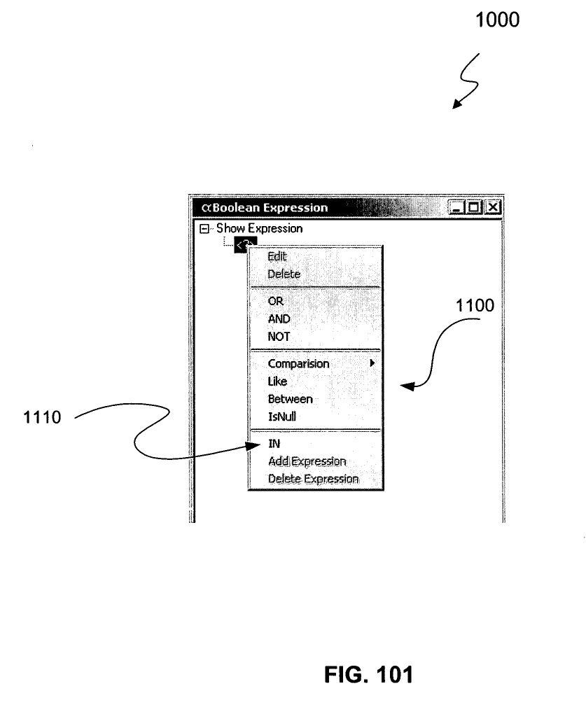

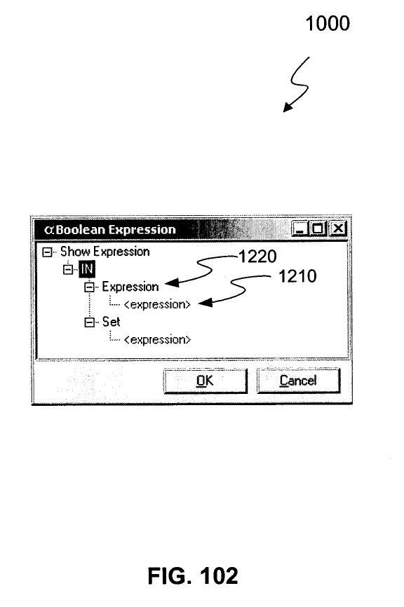

Turning now to FIG. 100, a screen shot is provided of an Expressions Properties window 1000 containing an “empty” expression 1010. Assuming it is desired to enter an expression such as “(Tracked_Requirement_{—}1.Facility Longitude Minutes IN (2, (3)*(4)))”, then the “<expression”>item 1020 is clicked and “IN” 1110 is selected from the resulting menu 1100 (FIG. 101). Following these operations the window 1000 appears as illustrated in FIG. 102.

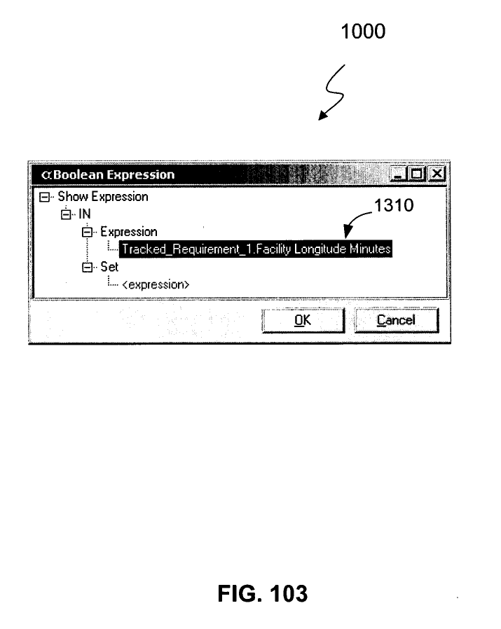

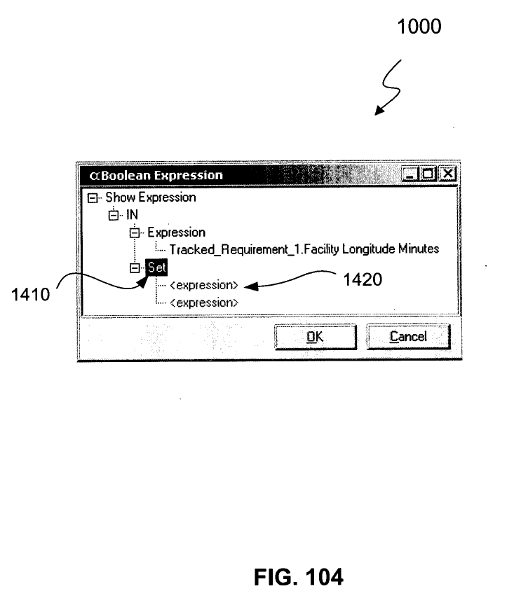

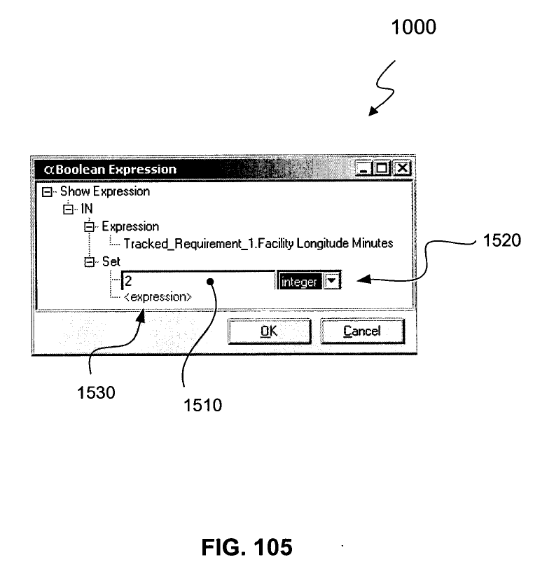

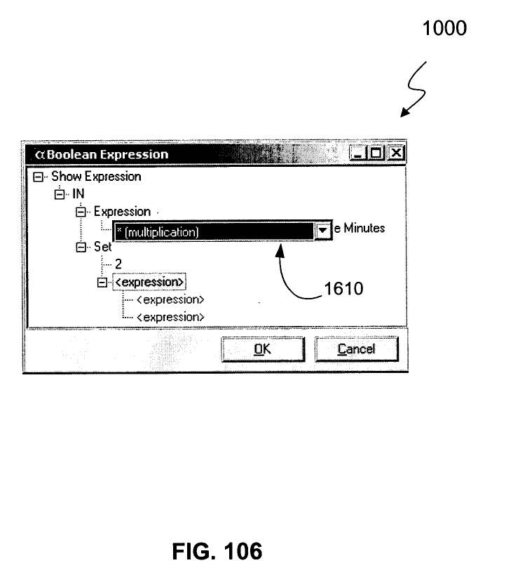

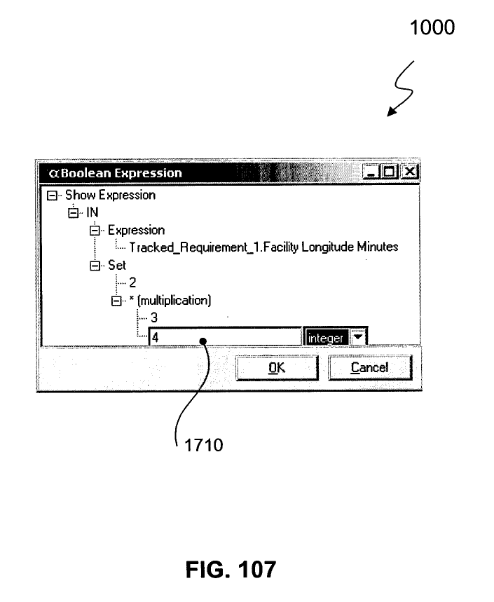

Referring to FIG. 102, the “<expression>” item 1210 under the Expression node 1220 is clicked, and from the resulting menu (not shown) the “Add Field” item is selected. The desired field (i.e., “Tracked_Requirement_{—}1.Facility Longitude Minutes”) is then selected from the dialog and appears as item 1310 (FIG. 103). The “Set” node 1410 (FIG. 104) is then clicked and “Add expression” is selected from the resulting menu (not shown). The “<expression>” node 1420 under the Set node 1410 is clicked and “Add constant” is selected from the resulting menu (not shown). A value is then entered into window area 1510 (FIG. 105) and an appropriate type selected from pull-down menu 1520. Next, the remaining “<expression>” node 1530 is clicked and “* (multiplication)” is selected from the pull-down menu 1610 (FIG. 106). The expression nodes 1620, 1630 are then filled with appropriate constants. For example, FIG. 107 depicts the integer constant “4” being entered into window area 1710.

Output Formatting

The formatting of all fields of a PDF output report may be adjusted during the report generation process through use of an intelligence format class. In accordance with the invention, this class may change various field values on the basis of the format of the applicable string (generally indicated within an associated field specification form). That is, the contents of a field may be formatted dynamically on the basis of such string format. In the exemplary embodiment, the intelligence format class uses the following atomic expression:

Digit:

0—if there are no digits left—insignificant zeroes

#—if there are no digits left—nothing

?—if there are no digits left—space

.—decimal symbol

Date:

m—month by one or two digits

mm—month by two digits

mmm—month by three letters

mmmm—full month name

mmmmm—month by first letter

d—day by one or two letters

dd—day by two letters

ddd—day by three letters

dddd—full day name

yy—year by two digits

yyyy—year by four digits

Time:

h—hours by one or two digits

hh—hours by two digits

m—minutes by one or two digits

mm—minutes by two digits

s—seconds by one or two digits

ss—seconds by two digits

AM/PM—daytime, time changes from 24 hour to 12 hour

A/P—daytime, time changes from 24 hour to 12 hour

[h]—time left in hours

[m]—time left in minutes

[s]—time left in seconds

s.00—time left in seconds with one hundreds

String:

@—string value

Special Symbols:

″—for marking strings

å—for single symbol

:—time separator

.—date separator

,—triad separation mark

TABLE VIII

| Group | Field value | Format string | Formatting result |
|---|---|---|---|
| Digit | 12345.678 | #.00 | 12345.67 |
| | 12345.67 | #.000 | 12345.670 |
| Date | Jun. 11, 2002 | dddd, mmmm | Tuesday, Jun. 11, |
| | 4:41:18 PM | d, yyyy | 2002 |
| | Jun. 11, 2002 | “The” dd “‘th” | The 11‘th of Jun, 02 |
| | 4:41:18 PM | “of” mmm, yy | |
| Time | Jun. 11, 2002 | hh:mm:ss | 16:41:18 |
| | 4:41:18 PM | | |
| | Jun. 11, 2002 | am/pm h | PM 4 hours, 41 |
| | 4:41:18 PM | “hours,” m “minutes | minutes and 18 |
| | | and” ss “seconds” | seconds |
| Custom | 123,5 | [>0]“positive=” | positive = 123,5 |
| | | #.##;[<0]“negative=” | |
| | | #.##;“zero” | |
| | 0,00 | [>0]“positive=” | zero |
| | | #.##;[<0]“negative=” | |
| | | #.##;“zero” | |
| | −123,5 | [>0]“positive=” | negative = −123,5 |
| | | #.##;[<0]“negative=” | |
| | | #.##;“zero” | |

Events Firing

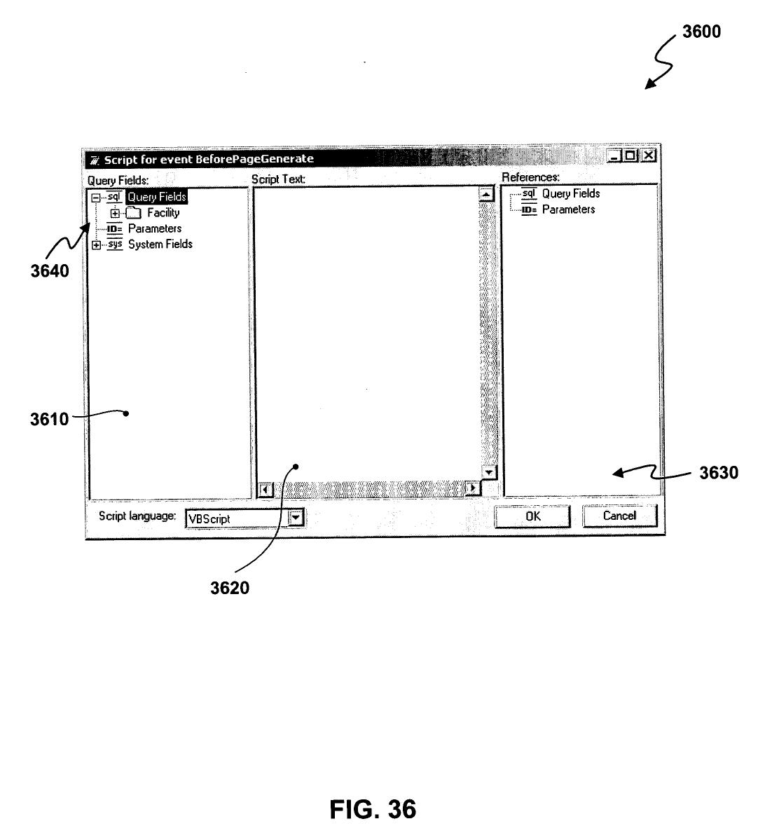

FIG. 36 is a screen shot of a script editor window 3600 through which event scripts may be assigned to various elements of a report. As shown, the script editor window is partitioned into three areas: a Query Fields area 3610, a Script Text area 3620 and a References area 3630. The Query Fields area 3610 includes a Query Fields tree 3640 which lists the fields potentially available to be used within the script of interest. A user may specify a field for inclusion in the applicable script by simply dragging the selected field from the Query Fields tree 3640 and dropping it within the a Script Text area 3620. The References area 3630 includes a list of fields used and parameters associated with the script of interest. The script editor window 3600 also includes a script selection combobox 3650, through which either VBScript or Jscript may be specified.

In the exemplary embodiment different elements of a report are capable of calling events during the report generation process. Table IX provides a list of report elements and certain associated events which may be caused to execute by such elements.

TABLE IX

| Element name | Event name | Applicable | Availability |
|---|---|---|---|
| Field | OnFieldGenerate | After generation of | Field Properties |
| | | text field by joining | Events tab |
| | | all its elements. The | |
| | | field hasn't been | |
| | | added to the report | |
| | | page. | |
| Row (set of | OnRowGenerate | After generation of all | MultiRow group |
| fields in | | fields in a row. This | Properties Events tab |
| MultiRow | | event is available for | |
| group) | | groups | |
| | | ofMultiRowsPerPage | |
| | | type. | |
| Page | OnBeforePageGenerate | Before the report page | Page Properties |
| | | is generated. The | Events tab |
| | | fields haven't been | |
| | | generated on the | |
| | | page. | |
| Page | OnAfterPageGenerate | After page generation. | Page Properties |
| | | The fields are present | Events tab |
| | | but they are not rows. | |

In addition, Table X provides a listing of available actions associated with various event handlers. In the exemplary embodiment, code for event handlers is executed using Microsoft Script. Accordingly, event handlers may be written using, for example, VBScript or Jscript.

TABLE X

| Event | Actions |
|---|---|
| OnFieldGenerate | Change field properties (text, color, location) |
| | and disable field output |
| OnRowGenerate | Change fields in row, insert new fields in row, |
| | insert new rows before/after current row, |
| | insert page breaks before/after |
| | current row |
| OnBeforePageGenerate | Add fields on page, change fields |
| OnAfterPageGenerate | Add fields on page, change fields |

Table XI provides a listing of various top-level objects available in association with various events executed during the report generation process. In this regard CurrentField, CurrentRow or CurrentPage correspond to a field, row or page with respect to which a given event is generated. In addition, scripts may have access to other report objects as a result of calls to top-level element methods. The top-level objects Parameters, Variables, SystemFields and Color are available in any event handler and maintain the relevant data during the report generation process.

TABLE XI

| Event Name | Top level objects available |
|---|---|
| OnFieldGenerate | CurrentField (type of ReportField) |
| | Parameters |
| | Variables |
| | SystemFields |
| | Color |
| OnRowGenerate | CurrentRow (type of ReportRow) |
| | Parameters |
| | Variables |
| | SystemFields |
| | Color |
| OnBeforePageGenerate | CurrentPage (type of ReportPage) |
| | Parameters |
| | Variables |
| | SystemFields |
| | Color |
| OnAfterPageGenerate | CurrentPage (type of ReportPage) |
| | Parameters |
| | Variables |
| | SystemFields |
| | Color |

In addition to the top-level objects identified in Table XI, SQL request field values may also be obtained with respect to the group of the event handler. Preferred syntax for calls to the desired SQL request field is as follows:

[<Group ID>.<Field name>].Value

As an example, consider the following:

CurrentField.Text=CurrentField.Text & “ ”& CStr([Unit.ActivateDate].Value)

Object Descriptions

ReportField

Table XII contains a listing of various methods and properties of a ReportField object. During the report generation process, the results of execution of the contents and component of a given ReportField object correspond to an actual field in the FDF output report. The ReportField object is available in the OnFieldGenerate event handler as the top-level object CurrentField, and is returned by the ReportRow and ReportPage object methods.

TABLE XII
ReportField

| | | |
|---|---|---|
| String | ID {get} | Return field ID |
| String | Alignment {get/set} | Text alignment |
| Bool | WordWrap {get/set} | Text word wrap |
| string | Text {get/set} | Text |
| Int | Left {get/set} | Left position |
| Int | Top {get/set} | Top position |
| Int | Width {get/set} | Width of field |
| int | Height {get/set} | Height of field |
| string | FontName {get/set} | Font name |
| float | FontSize {get/set} | Font size |
| Color | FontColor {get/set} | Font color |
| bool | FontBold {get/set} | Font is bold |
| Bool | FontItalic {get/set} | Font is italic |
| Bool | FontUnderline {get/set} | Font is underline |
| bool | FontStrikeout {get/set} | Font is strikeout |
| bool | Output {get/set} | Output or not field |
| bool | IsEmpty {get} | If field is empty. If method |
| | | can't return field it returns fields with |
| | | IsEmpty = true. User can't call |
| | | methods and properties of empty field |
| void | SetAttribute(string name, | Set custom attribute in field |
| | string val) | |
| string | GetAttribute(string | Get custom attribute |
| | name) | |

Consider the following examples:

```
1.
  if not CStr([Facility.Company].Value)=“” and not CStr([Facility.Email].Value)=“” then
    CurrentField.Text = [Facility.Company].Value & “ ” & [Facility.Email].Value
    CurrentField.FontColor = Color.Blue
  else
    CurrentField.Text = “Can't construct CompanyID!!!”
    CurrentField.FontColor = Color.Red
    CurrentField.FontUnderline = true
  end if
2.
  If CurrentField.ID = “ID” or CurrentField.ID = “ParentID” then
    CurrentField.Output = false
  CurrentField.SetAttribute “type”, “id”
  Else
    CurrentField.SetAttribute “desc”, “This is normal field”
  CurrentField.SetAttribute “type”, “normal”
  End if
```

ReportRow

Table XIII provides a listing of various methods and properties associated with a ReportField object. A ReportField object corresponds to a row in a report of type MultiRow, which contains report fields having contents created prior to the report generation process. A ReportField object is available in the OnRowGenerate event handler as the top-level object CurrentRow, and is also returned by the ReportRow object methods.

TABLE XIII
ReportRow

| | | |
|---|---|---|
| int | FieldCount {get} | Field count in row |
| ReportField | Fields(string ID) | Collection of fields by ID |
| ReportField | FieldByNum(int num) | Collection of fields by position |
| | | in list |
| ReportField | AddField(string ID) | Create new field in this row |
| bool | PageBreakBefore | Make page break before this row |
| | {get/set} | |
| bool | PageBreakAfter | Make page break after this row |
| | {get/set} | |
| ReportRow | InsertRowBefore( ) | Insert empty row before this |
| | | row. User can add field in this row. |
| ReportRow | InsertRowAfter( ) | Insert empty row after this row. |
| | | User can add field in this row. |

Consider the following example:

set r1 = CurrentRow.InsertRowBefore
set r1after = r1.InsertRowAfter
set newF0 = r1after.AddField( “NEW0” )
newF0.Text = “Row 2 field”
newF0.Top = 120
newF0.Width = 200
r1.PageBreakBefore = true
set newF = CurrentRow.AddField( “NEW” )
newF.Text = “New field”
newF.Top = 120
newF.FontColor = Color.Yellow
set r2 = CurrentRow.InsertRowAfter
r2.PageBreakAfter = true
set newF2 = r2.AddField( “NEW2” )
newF2.Text = “New field in after row”
newF2.Top = 120
newF2.Width = 200
set r3 = CurrentRow.InsertRowAfter
r3.PageBreakAfter = true
set newF3 = r3.AddField( “NEW3” )
newF3.Text = “New field in after row (***********)”
newF3.Top = 120
newF3.Width = 200

ReportPage

Table XIV provides a listing of a method and property associated with a ReportPage object. When in the OnBeforePageGenerate event handler, the ReportPage object represents an empty page but is available to be used for adding new fields. The OnAfterPageGenerate event handler contains all fields and generated contents of a page represented by a ReportPage object.

Objects of the type ReportPage are available in the OnBeforePageGenerate and OnAfterPageGenerate event handlers as the top level object CurrentPage.

TABLE XIV
ReportPage

| | | |
|---|---|---|
| ReportField | Fields(string ID) | Collection of fields by ID |
| ReportField | AddField(string ID) | Create new field in page |

An example is provided below:

set newF = CurrentPage.AddField( “NEW” )
newF.Left = 50
newf.Top = 50
newF.Text = “First new field (BeforePage event)”
newF.Width = 220
newF.FontColor = Color.Red
set fx = CurrentPage.Fields(“x”)
if not fx.IsEmpty then
fx.Text = “???”
end if

Parameters

Table XV provides a listing of an object element associated with a Parameters object. The Parameters object corresponds to a collection of report parameter values. In the exemplary implementation these report parameter values are read-only.

TABLE XV
Parameters

| | | |
|---|---|---|
| object | Get(string name) | Return parameter value by name |

An example is provided below:

If Parameters.Get( “FilterDate” ) = Date then
set newF = CurrentPage.AddField( “MessageField” )
newF.Left = 50
newf.Top = 50
newF.Text = “Build report for today!!!”
newF.Width = 220
newF.FontColor = Color.Red
End if

SystemFields

Table XVI provides a listing of an object element associated with a SystemFields object. The SystemField object corresponds to a collection of report system field values. In the exemplary implementation these report system field values are read-only.

TABLE XVI
SystemFields

| | | |
|---|---|---|
| object | Get(string name) | Return system field value by name |

Consider the following example:

if SystemFields.Get(“PageNumber”) = 1 then
set newf = CurrentPage.AddField(“ff”)
newf.Text = “This is first page”
end if

Color

Table XVII provides a listing of a set of properties associated with a Color object. The Color object corresponds to a set of field colors.

TABLE XVII
Color

| | |
|---|---|
| Int | White {get} |
| Int | Magenta {get} |
| Int | Yellow {get} |
| Int | Red {get} |
| Int | Aqua {get} |
| Int | Blue {get} |
| Int | Green {get} |
| Int | Black {get} |

Variables

Table XVIII provides a listing of a set of methods associated with a Variables object. The Variables object corresponds to a collection of named values available for reading and writing. The values are saved throughout the report generation process.

TABLE XVIII
Variables

| | | |
|---|---|---|
| object | Get(string name) | Return user variable value by |
| | | name |
| void | Set(string name, object value) | Create or change user |
| | | variable |

Consider the example below:

```
‘  OnBeforePageGenerate
pc = Variables.Get(“PageCounts”)
if IsNull(pc) then
  Variables.Set “PageCounts”, 1
else
  Variables.Set “PageCounts”, pc+1
end if
‘  OnAfterPageGenerate
set newF = CurrentPage.AddField( “NEW_” )
newF.Left = 50
newf.Top = 100
newF.Text = “Variables” & CStr(Variables.Get(“PageCounts”))
newF.Width = 220
newF.FontColor = Color.Aqua
```

Various aspects of the invention may be more fully appreciated with reference to the following section, which includes additional description relating to an exemplary process of pivot report creation.

### Example of Creation of Pivot Report

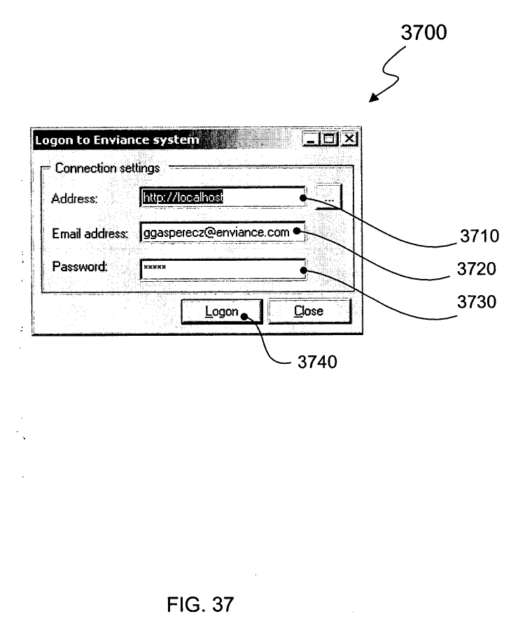

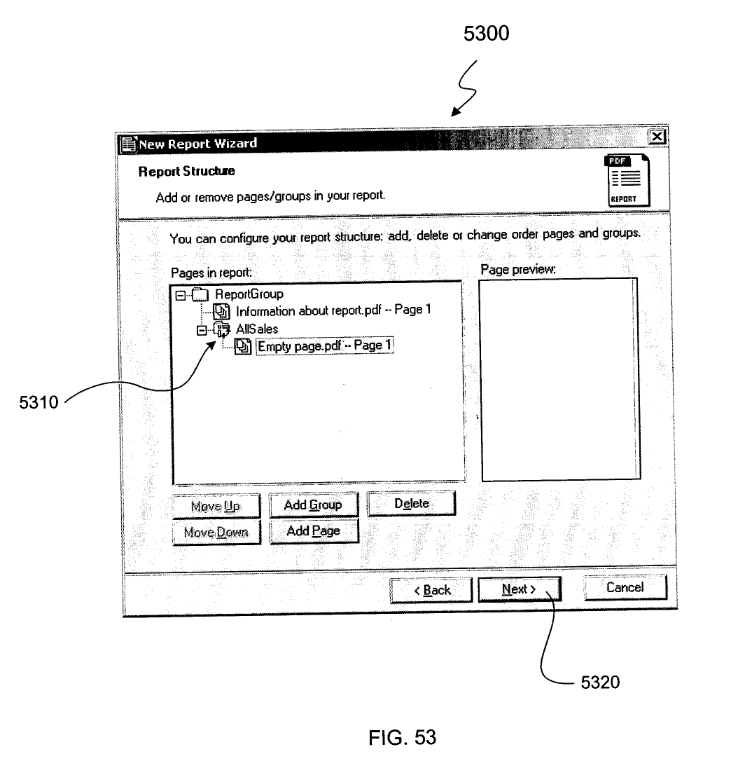

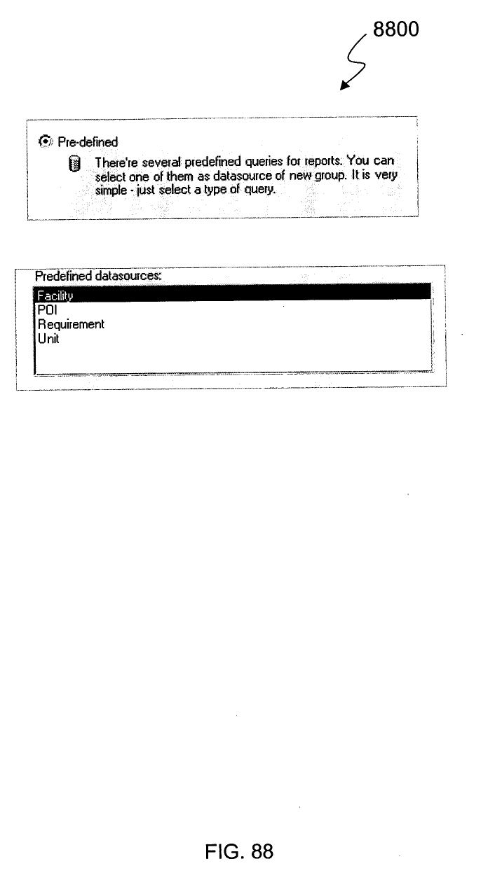

Attention is now directed to FIGS. 37-95, which are a series of screen shots illustratively representing a process for defining a report file of type PivotTable in a manner consistent with the present invention. Unless otherwise indicated below, the windows and dialogs represented by the screenshots of FIGS. 37-95 are sequentially presented to a user upon selection of a “Next>”, “OK” or similar button within each preceding window or dialog.

1. System Logon and Launch of New Report Wizard

Turning first to FIG. 37, in order to logon to the system the user runs the ReportExplorer application 208, which causes a Logon to system dialog 3700 to appear. The address of the server at which are installed the report generation applications of the invention (e.g., server 104 of FIG. 1) is entered into an Address field 3710. In addition, an email address which comprising a valid login name of the system is entered into an Email address field 3720, and a password is entered into a Password field 3730. A Logon button 3740 is then selected in order to enter the system.

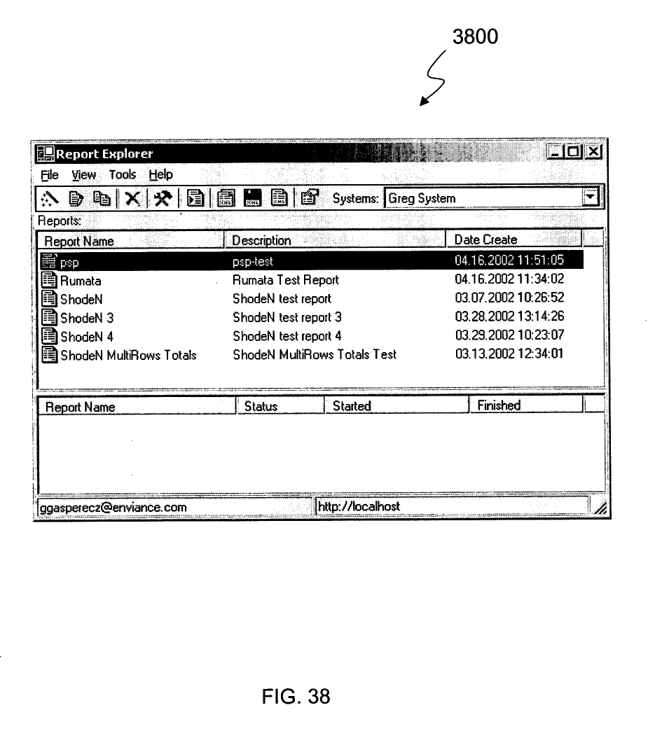

As is indicated by FIG. 38, after successful logon a Report Explorer window 3800 will appear, from which previously-created reports may be selected.

2. Creating New Report using New Report Wizard

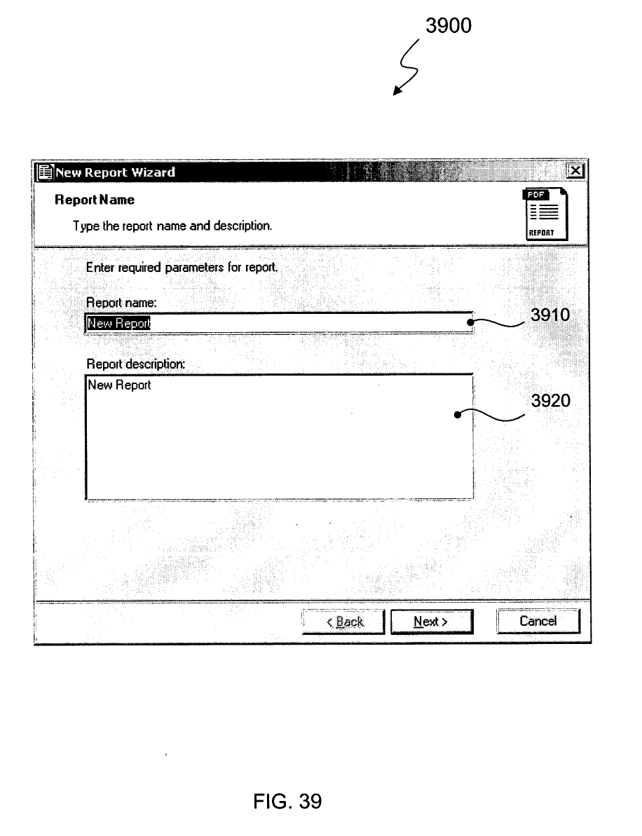

If it is desired to create new report, then a New Report Wizard may be invoked by either clicking on a Wizard icon (not shown) or pressing a predefined combination of keys (e.g., Ctrl+N). FIG. 39 provides a screenshot of an initial window 3900 presented by the New Report Wizard window subsequent to its invocation.

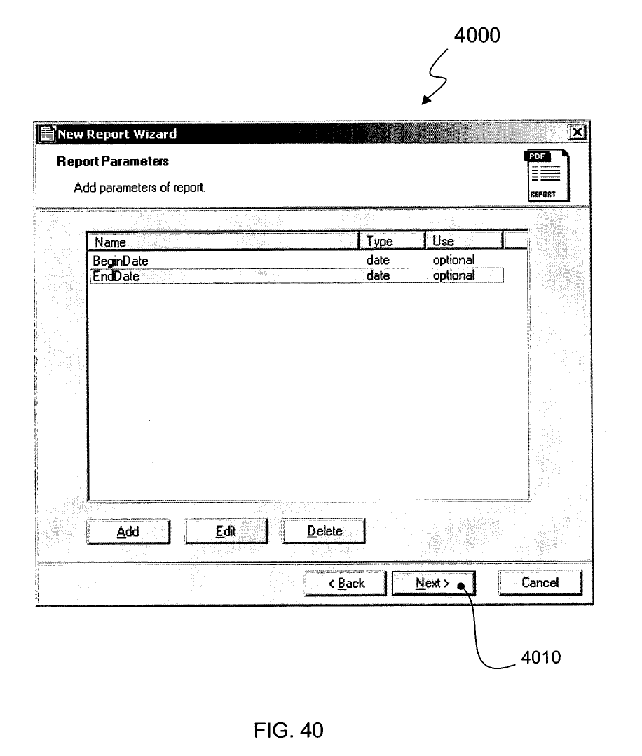

Referring to FIG. 39, the term “New Report” is entered into a Report name field 3910. As shown, the same text is automatically suggested in a Report description field 3920. A Next> button 3930 may be selected in order to advance to the next page (FIG. 40).

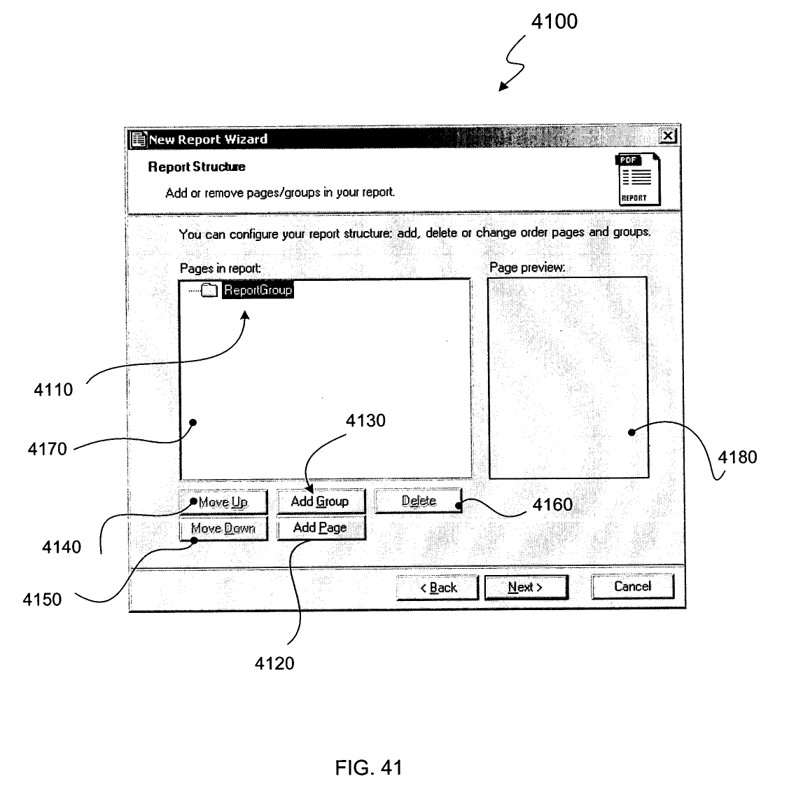

FIG. 40 provides a screenshot of a Report Parameters window 4000, which is displayed upon selection of the Next> button 3930. The window 4000 may generally be left without entering any changes, and a Next> button 4010 is clicked to get to the next page displayed by the New Report Wizard (FIG. 41). As is shown in FIG. 41, the third page presented by the New Report Wizard comprises a Report Structure window 4100. Each report created via the New Report Wizard will generally include root group, identified as the ReportGroup 4110, which may not be removed from the report. A user may enter pages into the root group via an Add Page button 4120, and may also add any number of additional types of groups to it via the Add Group button 4130. The order of groups/pages within any parent group may be changed by moving them up or down using Move Up and Move Down buttons 4140 and 4150. Selection of the Delete button 4160 results in deletion of the selected item (page or group) from the Report Structure tree displayed in pane 4170. When the user selects a page from the Report Structure tree within pane 4170, a preview of the selected page is displayed in Page preview pane 4180.

2.1. Adding a Page to the Report

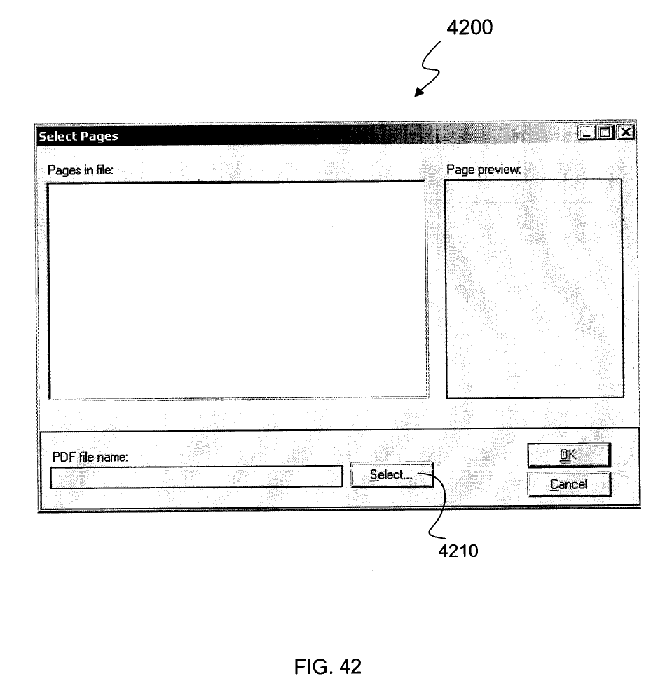

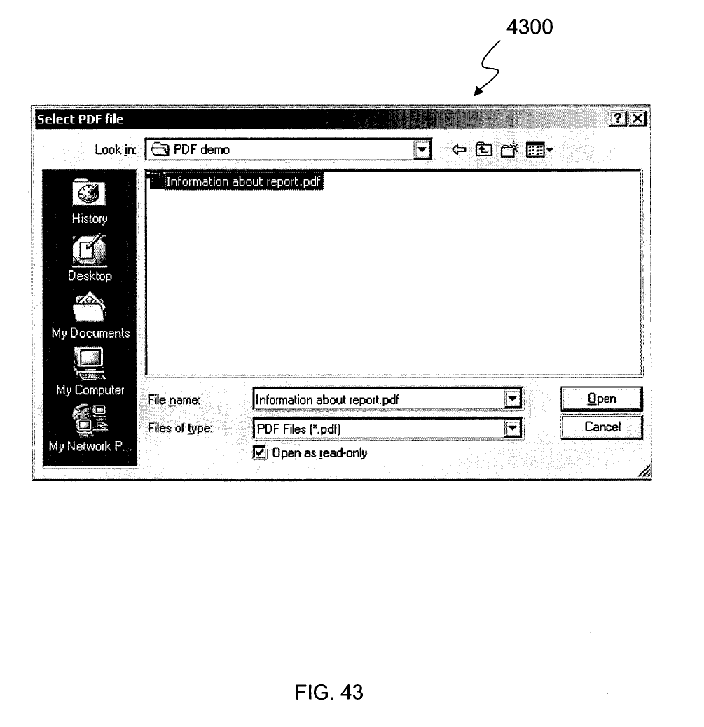

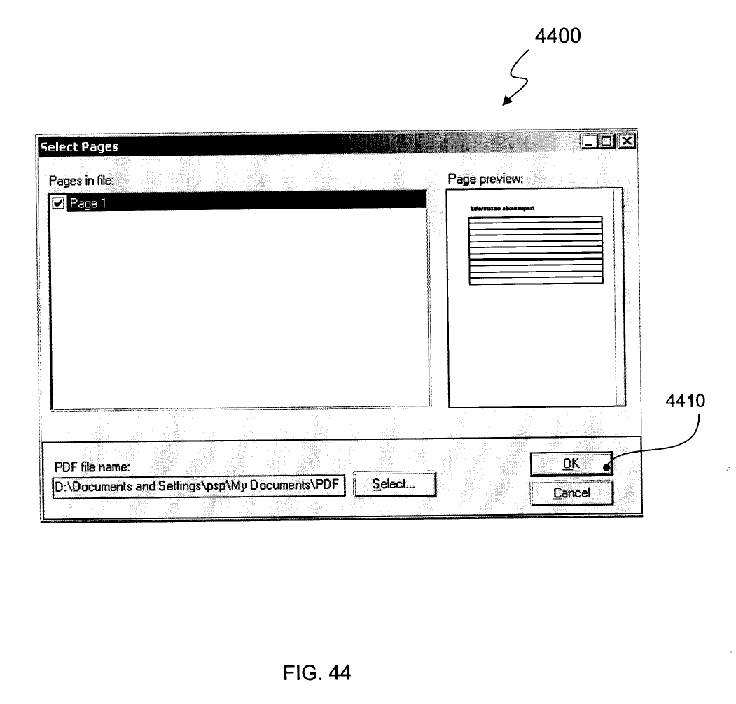

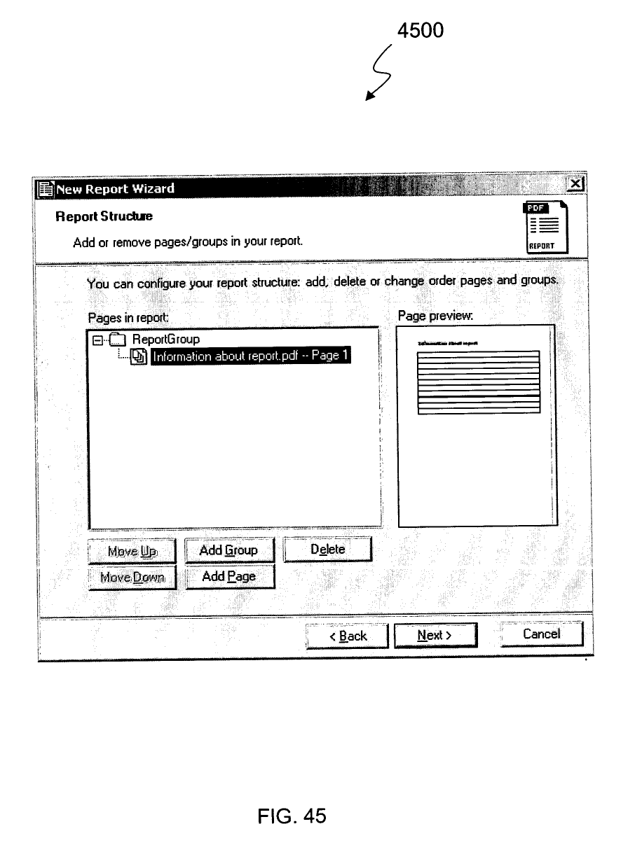

FIG. 42 is a screenshot of a Select Pages window 4200 that is displayed upon selection of the Add Page button 4120. A particular PDF file may then be selected via a Select button 4210, which causes the Select PDF file dialog 4300 to appear (FIG. 43). Following selection of a file via dialog 4300, a new Select Pages window 4400 is displayed (FIG. 44). Clicking the OK button returns the user to the New Report Wizard window 4500 of FIG. 45.

2.2. Adding a Group to the Report using New Group Wizard

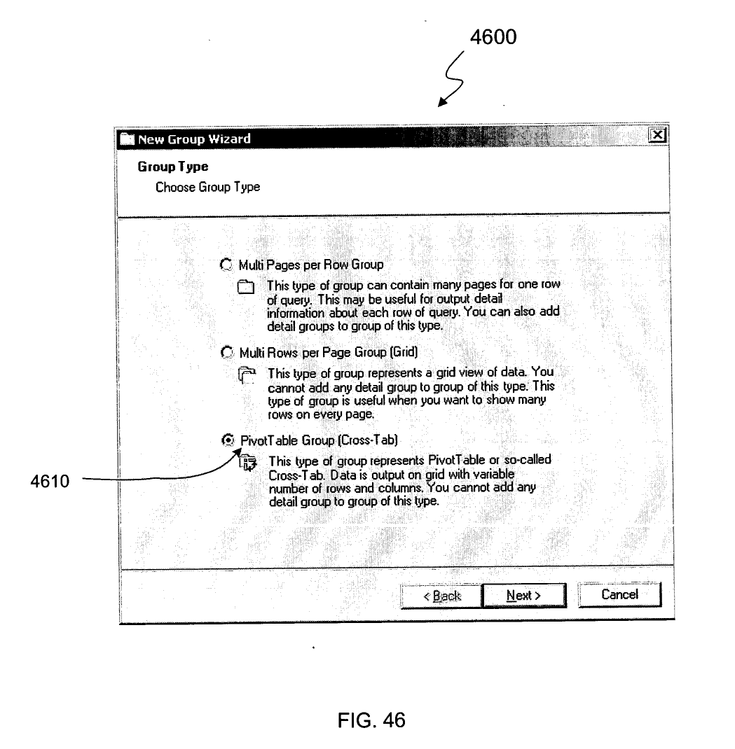

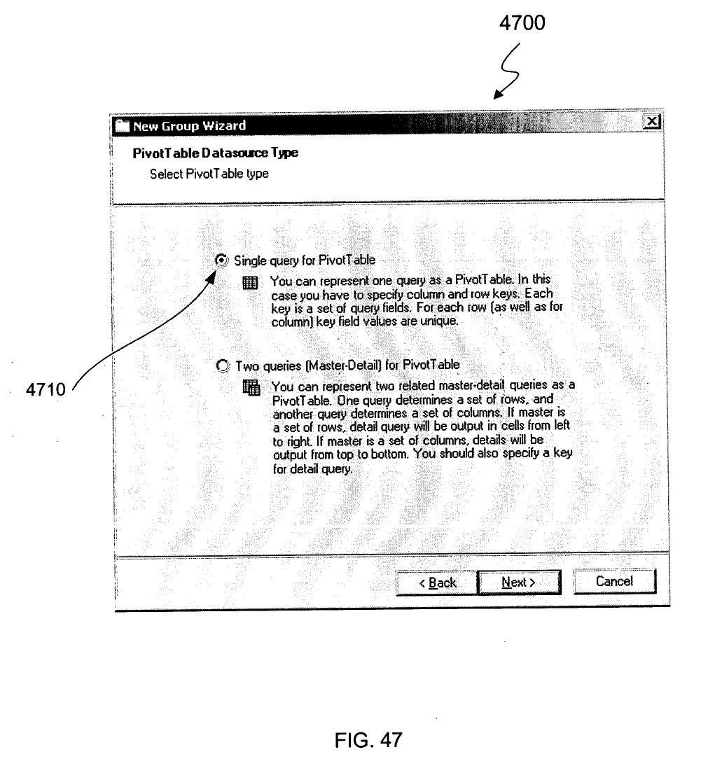

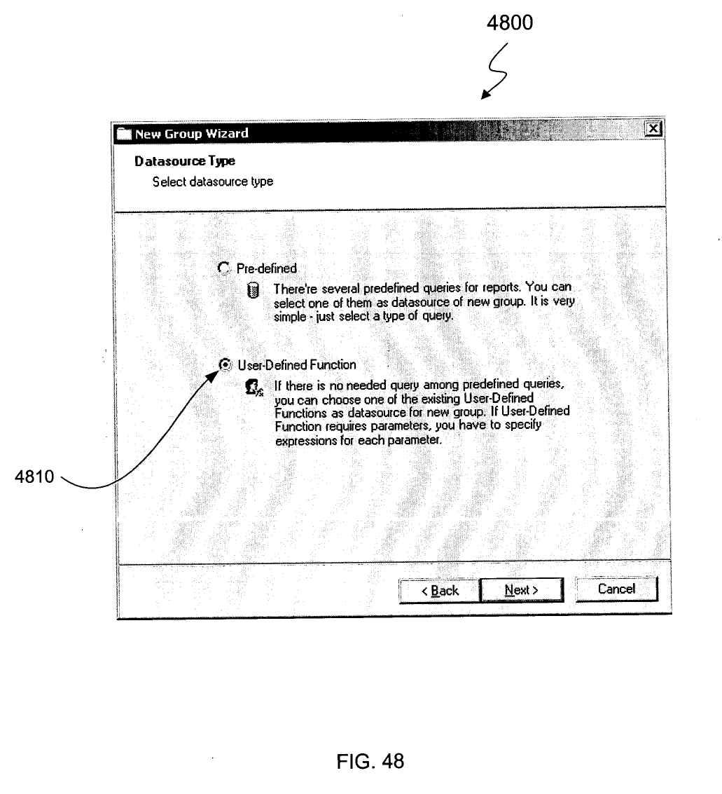

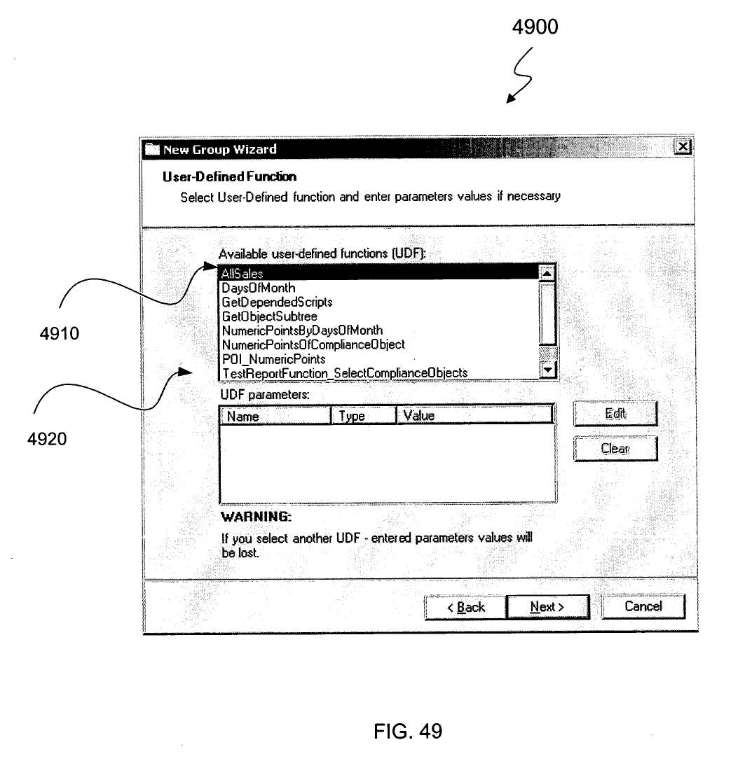

FIG. 46 is a screenshot of a New Group Wizard window 4600 through which a new group type may be added to an existing report. The New Group Wizard window 4600 is accessed by selecting a root group from the Report Structure tree displayed by pane 4170 (FIG. 41) and clicking the Add Group button 4130. This displays the New Group Wizard window 4600, from which the PivotTable Group 4610 may be selected in order to add a new group representing a pivot table to the current report. After clicking the Next> button 4620, a particular type of pivot table may be selected (e.g., a Single query for PivotTable 4710) from window 4700 of FIG. 47. To the extent user-defined functions will serve as a data sources for the current report, User-Defined Function 4810 is selected as the applicable as data source via window 4800 of FIG. 48. On the next page presented by the New Group Wizard, i.e., window 4900 of FIG. 49, one of a plurality of available user-defined functions (i.e., AllSales 4910) is selected from within pane 4920.

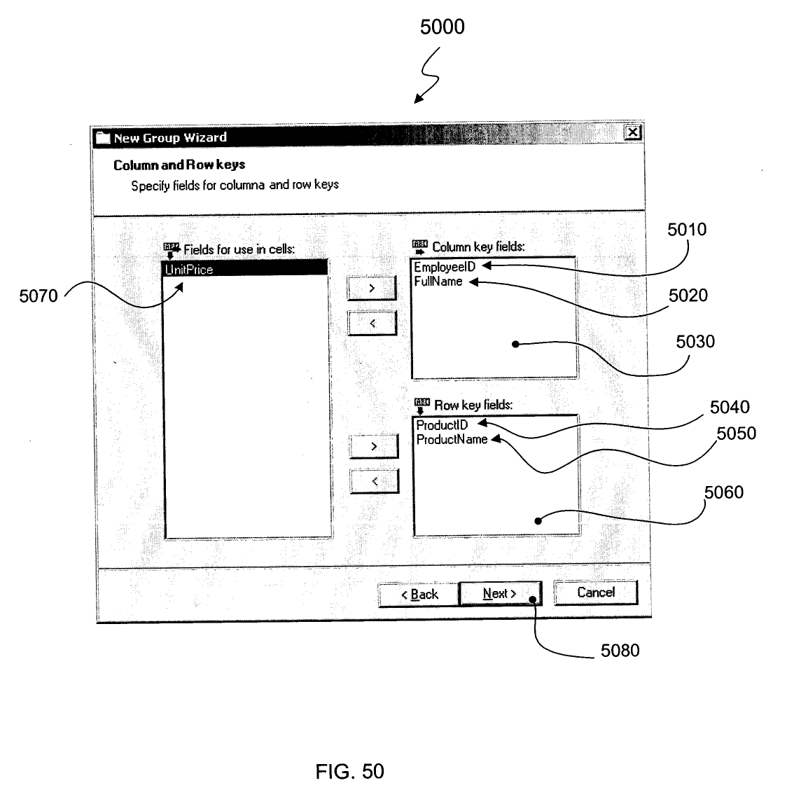

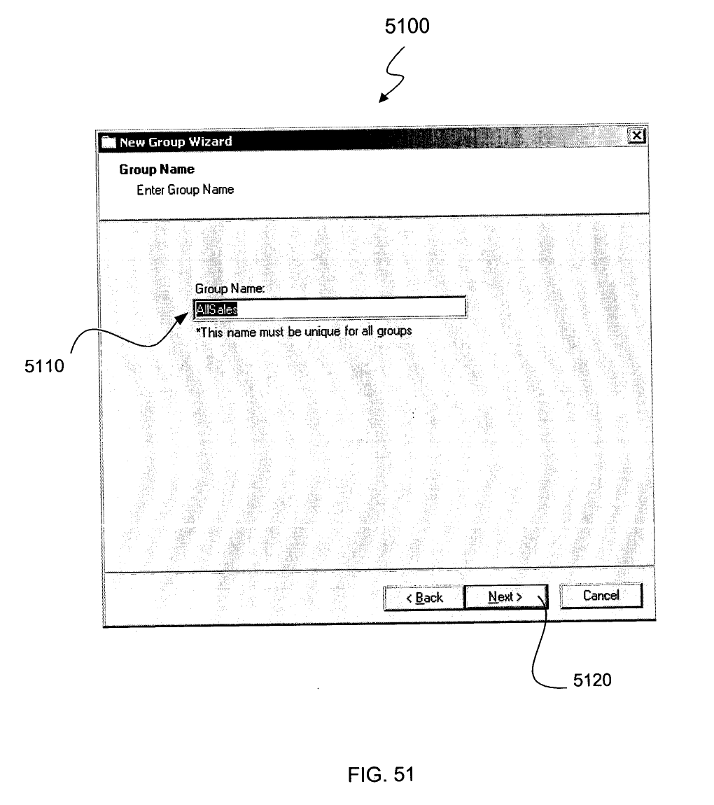

Turning now to FIG. 50, a Key Fields Specification window 5000 enables specification of the key fields associated with the various rows and columns of the pivot table being defined for the current report. In the example of FIG. 50, EmployeeID and FullName fields 5010 and 5020 are selected and moved to a Column keyfields list pane 5030. As a consequence, the fields 5010, 5020 will be shown in columns of the applicable pivot table. Similarly, ProductId and ProductName fields 5040, 5050 are moved to Row key fields list pane 5060 in order that these fields will be shown in rows. A UnitPrice field 5070 is left within pane 5080, which enables it to be used for aggregation. Clicking the Next> button 5080 moves the user to the next page (FIG. 51).

An exemplary process of specifying data source information in connection with defining a group of type PivotTable may be summarized as follows:

1) Select the Group Type “Pivot Table Group”

2) Select “Single Query” or “Two Query”

3) Select Data source “Pre-defined” or “User-Defined Function”

4) If “Two Query”, select second data source

5) If “Two Query”, select how the data is placed on the X and Y axis

6) If “Two Query”, select data fields placed along the Y axis, and in the cells in the body of the pivot table

7) If “Single Query”, select data fields for X and Y axis and cells in the body of the pivot table

8) Select “PDF File” to be used as background

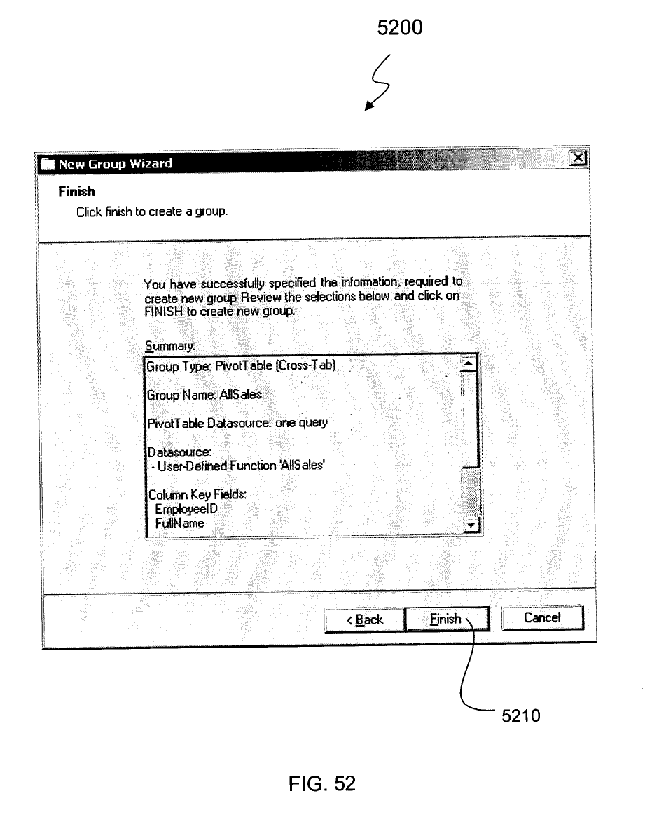

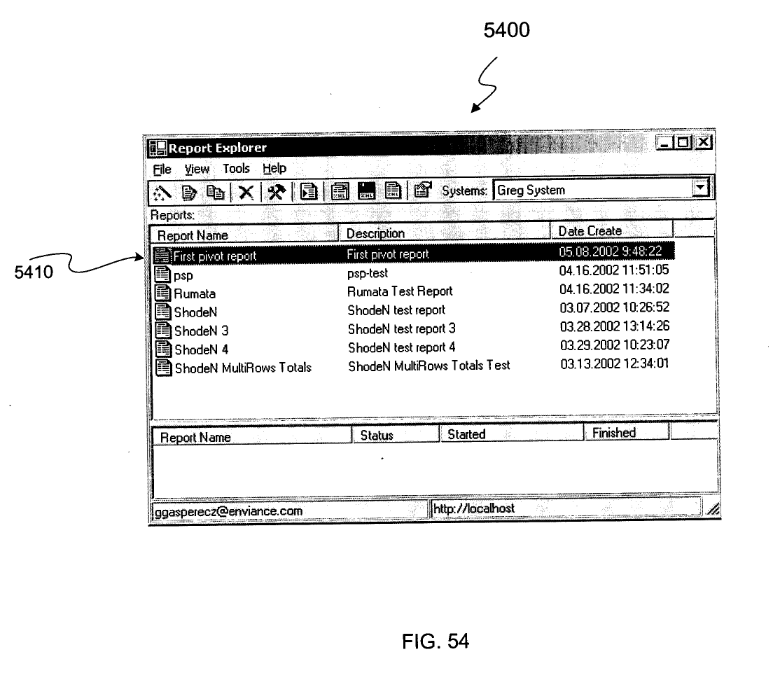

Referring to FIG. 51, a unique name for the group is entered in a Group Name field 5110 of window 5100. As shown, a default group name corresponding to the name of the selected User-Defined function is initially presented in field 5110. If it is desired to use this default name, the Next> button 5120 is selected and the user is advance to the next page (FIG. 52). The window 5200 of FIG. 52 displays summary information. Clicking the Finish button 5210 completes the group creation process. Following completion of this group creation process, the user is advanced to a New Report Wizard window 5300 within which the group 5310 that has been created is displayed. Clicking the Next> button 5320 displays a last page of the Wizard (not shown) and finishes new report creation. The report which has been created 5410 is then included in a list of reports in a Report Explorer window 5400 (FIG. 54).

3. Report Editing

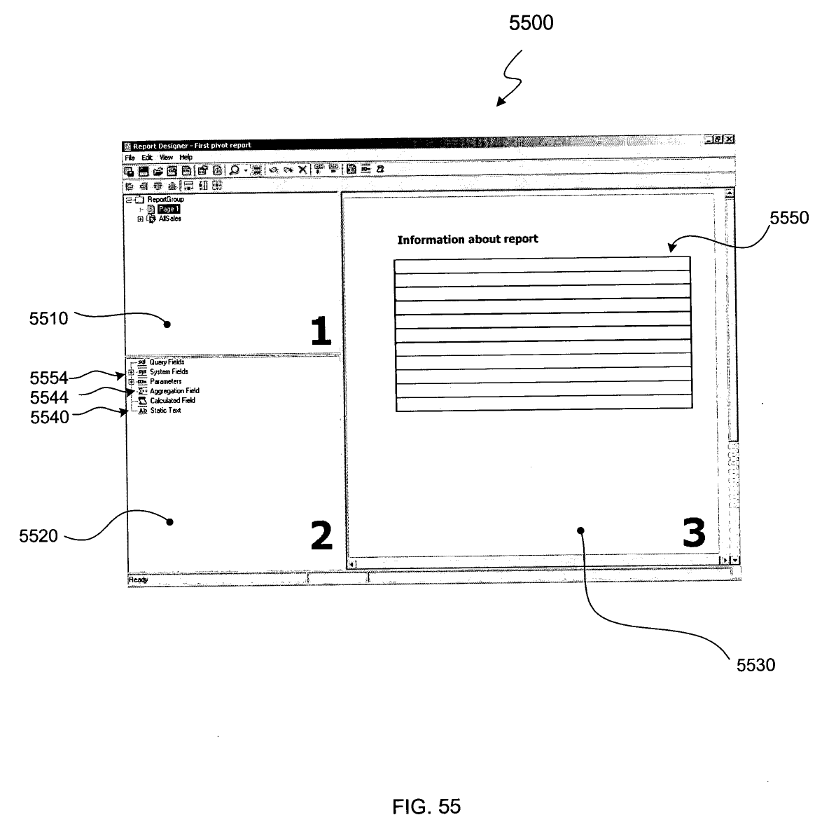

After a report is created it will generally require modification (e.g., adding fields, totals, etc.). To effect such modification a user runs the Report Designer application 210 by double-clicking on the icon of the report to be edited within the Report Explorer window 5400. After the Report Designer application 210 has been loaded, the first page 5500 of the report is made active (FIG. 55). In the exemplary embodiment the page 5500 generated by the Report Designer application 210 is comprised primarily of a Report Structure Tree pane 5510 (groups, pages, fields), an Available Fields Tree pane 5520 (request fields, system fields, parameters, aggregations, etc.), and a Page view pane 5530 with report fields.

3.1. Adding Fields to Report Pages

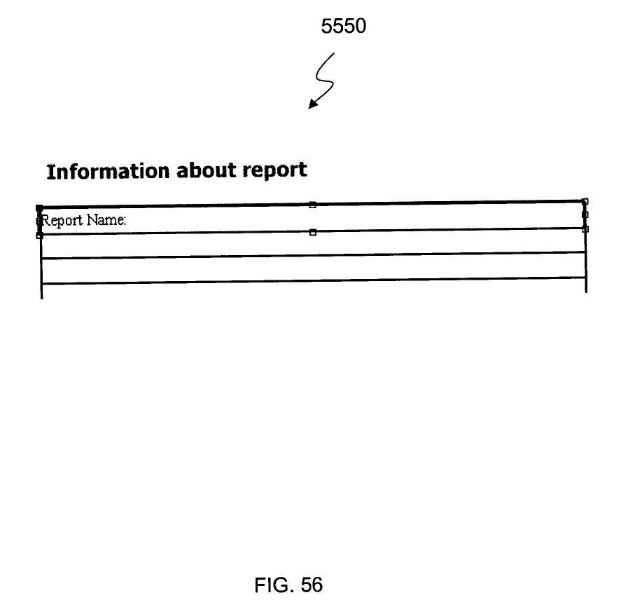

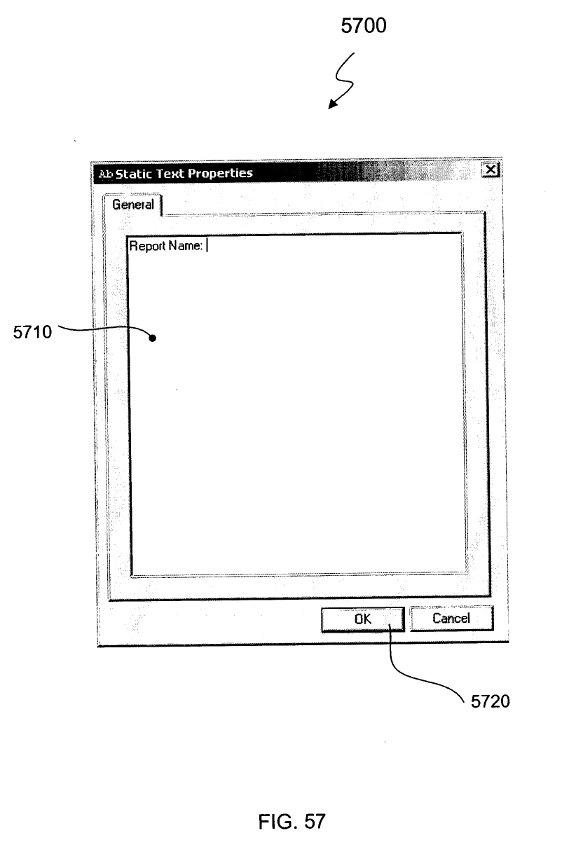

In the exemplary embodiment various fields containing information about the current report are added to the first page 5500 of the Report Designer application 210. For example, in order to add a field containing a name of the current report a Static Text item 5540 is selected from the Available Fields Tree pane 5520 and a dialog 5700 for text entry appears (FIG. 57). After text has been entered in pane 5710 of dialog 5700, the text appears at the beginning of the table 5550 within the Page view pane 5530 (see FIG. 56).

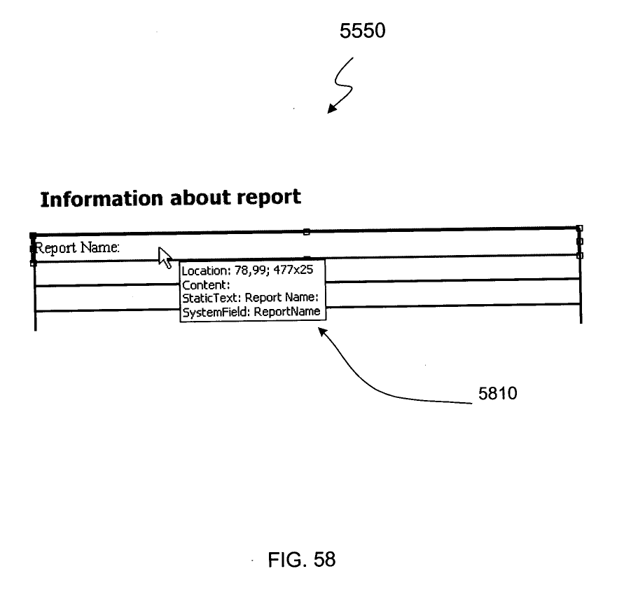

Next, the branch System Fields 5554 from the Available Fields Tree pane 5520 is opened. The ReportName field (not shown) is selected from a displayed list of fields, but no corresponding visual changes appear. However, if the user positions the mouse pointer over the table 5550, comment box 5810 appears (FIG. 58). As shown, the comment box 5810 contains information concerning the field (e.g., Static Text and System Field).

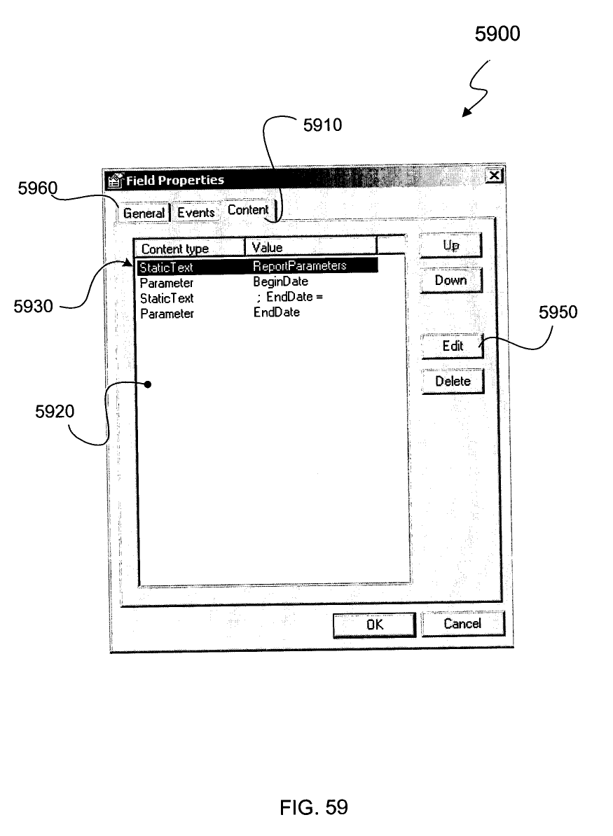

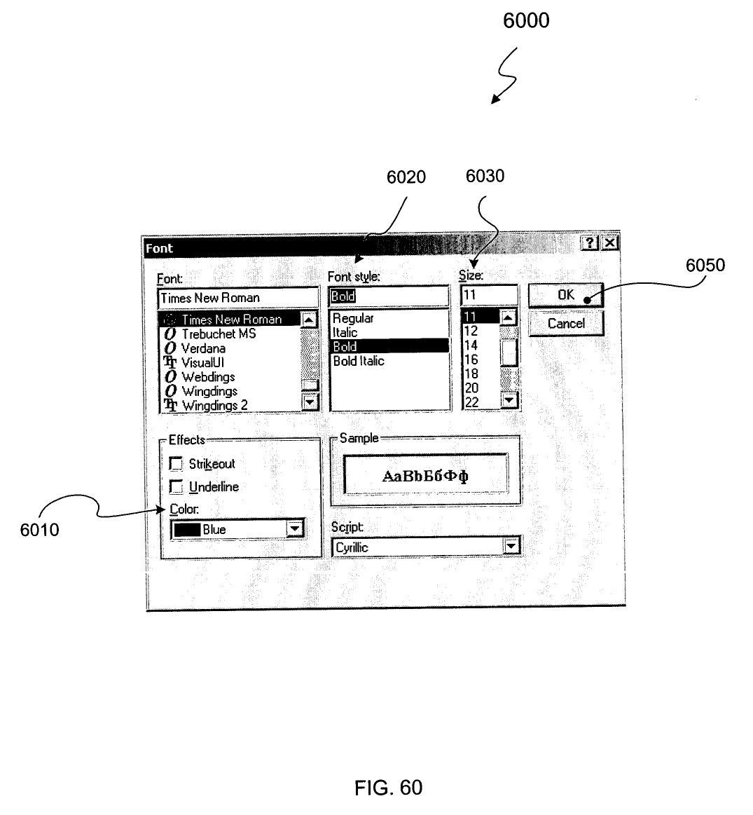

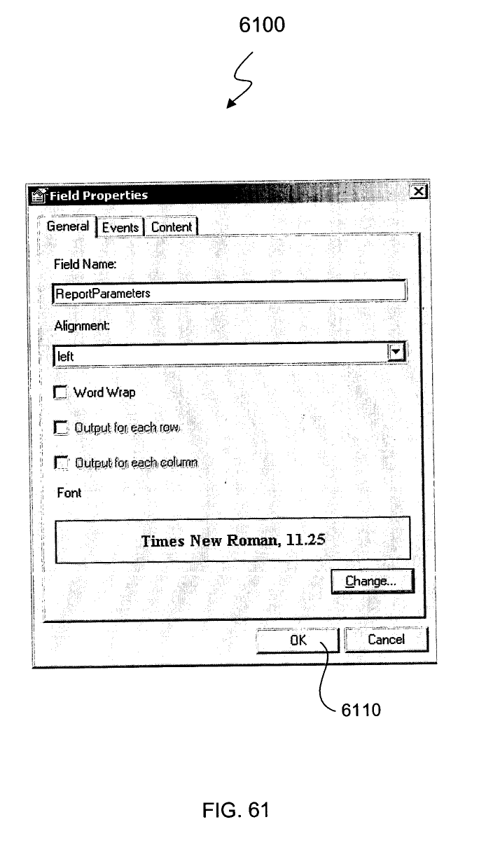

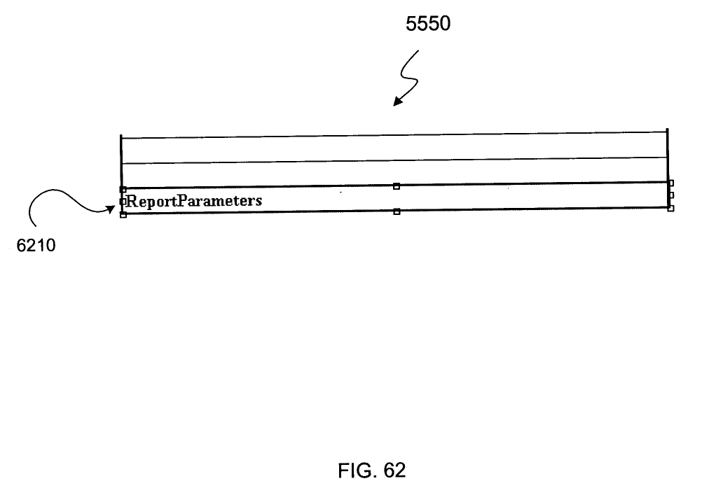

In an analogous manner a field may also be created for displaying the number of pages in the report and inserted into the second row of the table 5550. Specifically, a Static Text item 5540 field with text “ReportParameters” is added to this second row, and two parameters are associated with this field; specifically, the parameter BeginDate is followed by the Static Text “; EndDate=”, which is followed by the parameter EndDate. A Field Properties window 5900 of this complex field may then be opened and a Content tab 5910 selected, which results in pane 5920 being displayed (FIG. 59). The first row 5930 of pane 5920 may be selected and then edited by clicking the Edit button 5950. This causes the text entry dialog 5700 to appear (FIG. 57), within which may be entered the text “Report parameters: BeginDate=”. Clicking the OK button 5720 closes the window 5700. Next, the General tab 5960 is selected from Field Properties window 5900. In order to effect a change of the font of the field, a Change font button (not shown) is selected and a standard font selection dialog 6000 will appear (FIG. 60). In the present example, a Color 6010 of Blue is selected, a Font style 6020 of Bold is selected, and a Size 6030 of 11 is chosen. Once the OK button 6050 has been selected, the specified changes appear in a revised Field Properties window 6100 (FIG. 61). Once the Field Properties window 6100 is closed by clicking the OK button 6110, the changes are displayed in the table 5550 within the Page view pane 5530 (FIG. 62).

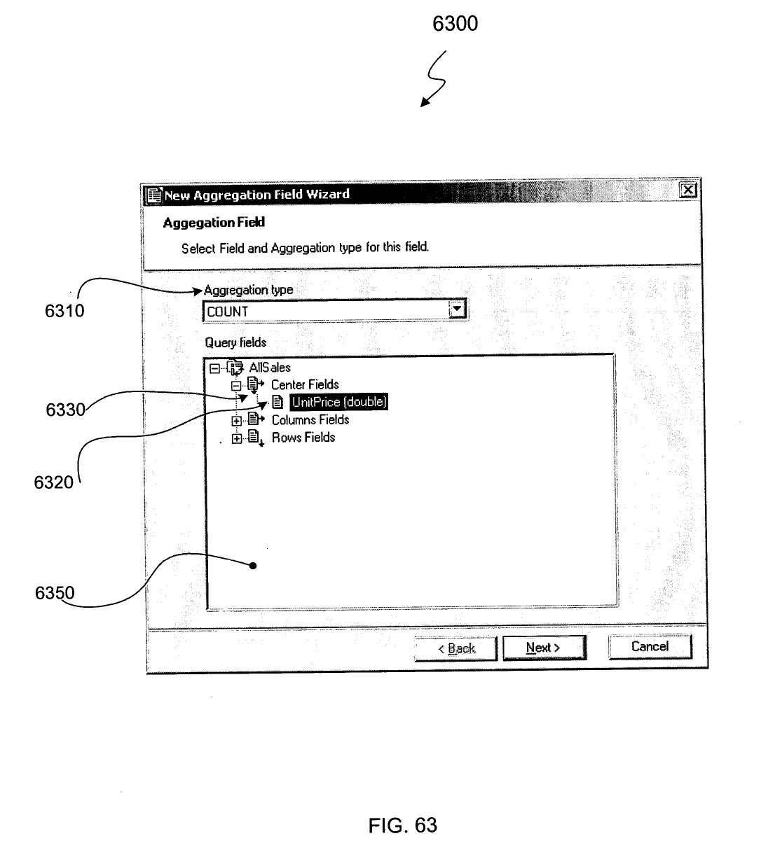

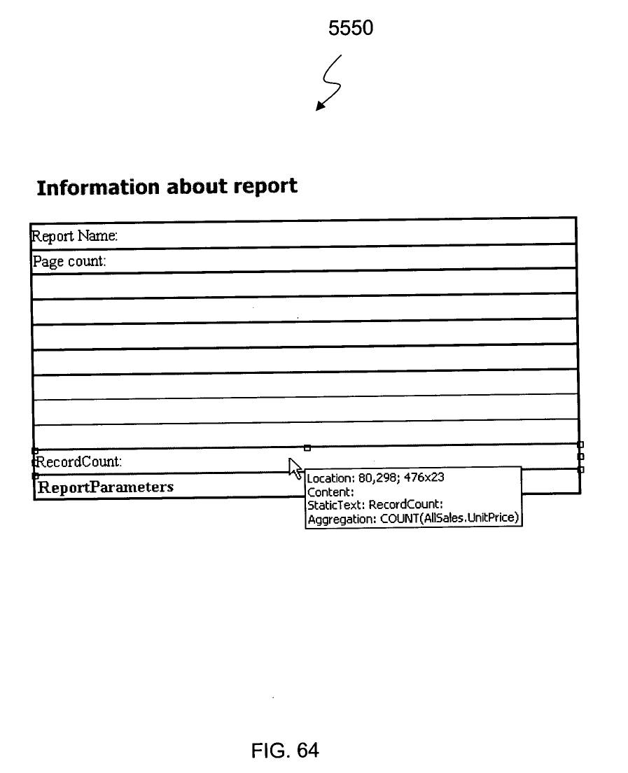

FIG. 63 is a screenshot of a New Aggregation Field Wizard window 6300 through which a field may be added which results in display of the number of records over the Report Parameters row 6210 (FIG. 62). In order for this to be accomplished, a Static Text item 5540 of “RecordCount:” and an Aggregation Field item 5544 of “Aggregation Field” are drawn. Creating such an aggregation results in display of the New Aggregation Field Wizard window 6300. From within this window 6300, an Aggregation Type 6310 of COUNT is selected. In addition, a field UnitPrice 6320 is selected from a Center Fields group 6330 displayed within a Query fields pane 6350. These operations result in the in the table 5550 within the Page view pane 5530 appearing as depicted in FIG. 64.

3.2. Creating Pivot Table Fields

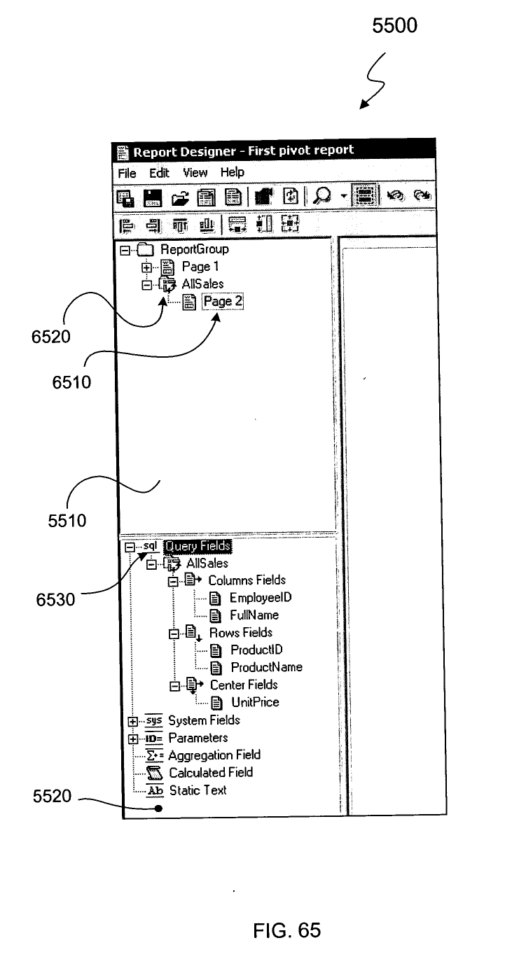

FIG. 65 is a screenshot of a portion of the first window 5500 generated by the Report Designer application 210 in the Page view pane 5530 to which reference will be made in describing the manner in which various fields may be created in a pivot table. As mentioned above, a pivot table is formed on a page within a group of the PivotTable type. Referring to FIG. 65, such a page (i.e., Page 2 6510) exists within the group AllSales 6520 displayed within pane 5510. Note that the various fields of the group AllSales also appear in the Query Fields branch 6530 of the fields tree displayed within pane 5520.

In an exemplary embodiment of the present invention there exist three groups of fields of type PivotTable type:

Column Fields group contains the fields displaying left to right (i.e. table columns).

Row Fields group contains the fields displaying up to down (table rows).

Center Fields group contains fields to be displayed inside the table. These fields will be displayed both left to right and up to down.

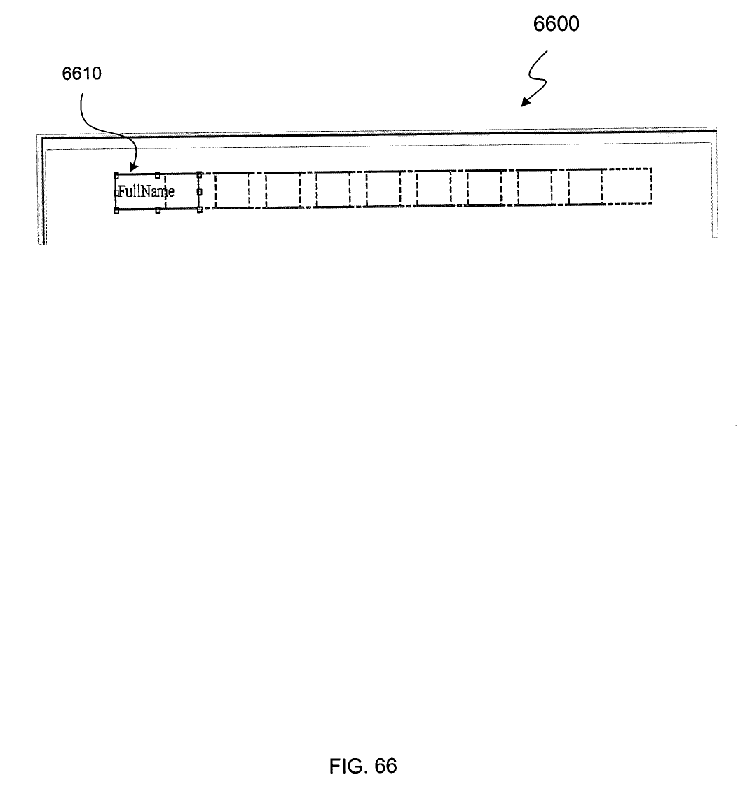

FIG. 66 is a screenshot of a portion of a page 6600 of type PivotTable drawn in the Page view pane 5530 to which reference will be made in describing a pivot table creation process consistent with the invention. In order to begin creating a new table of type PivotTable, a FullName field 6610 is dragged and dropped to the top left corner of the pivot table page 6600. After the FullName field 6610 is dropped, duplicates of the field appear on the page 6600 as dashed rectangles. These field duplicates show the position of fields of the formed report. The intervals between the field duplicates and their number are determined by the properties of the applicable group (i.e., by the Group Properties).

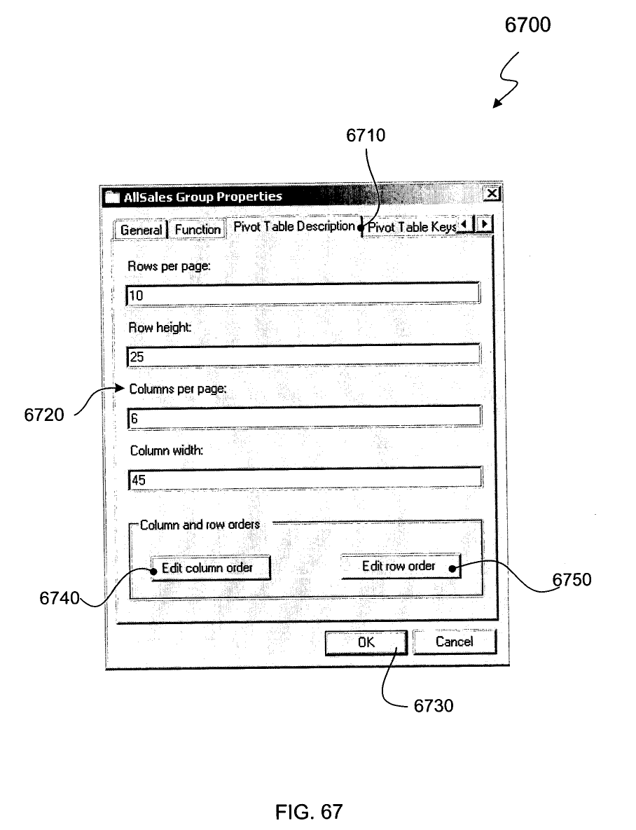

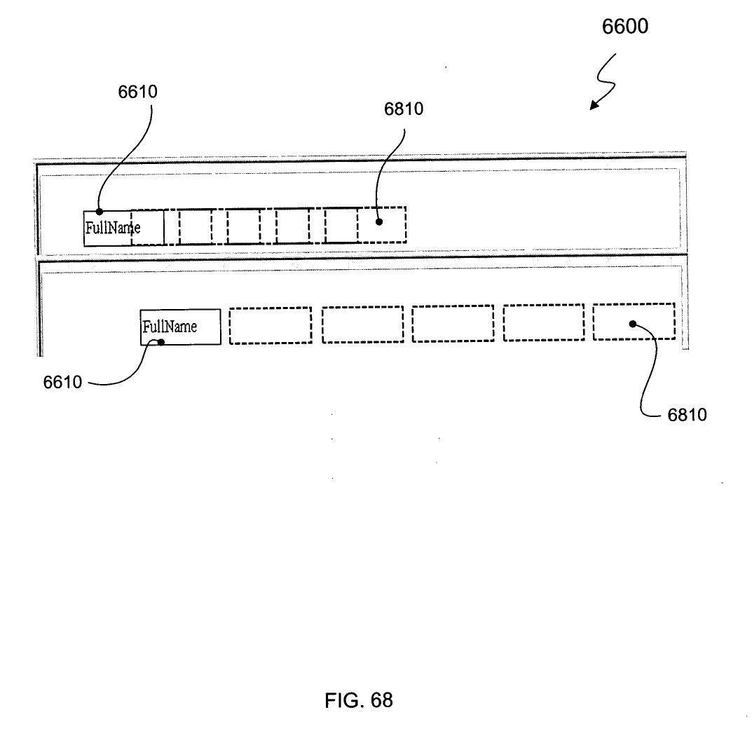

FIG. 67 is a screenshot of a Group Properties window 6700 through which the number of rows within the applicable pivot table may be reduced. In the exemplary embodiment the Group Properties window 6700 may be caused to appear by double-clicking upon any of the duplicates of the FullName field 6610. When invoked in this manner the Group Properties window 6700 appears with a Pivot Table Description tab 6710 active. In the present example the number of Columns per page 6720 has been changed from 10 to 6. Once the window 6700 is closed by clicking the OK button 6730, the number of duplicates of the field 6610 is seen to be decreased (FIG. 68).

As is shown by FIG. 68, if the FullName field 6610 is itself moved to the left and the rightmost of its duplicates 6810 is moved to the fight, the interval between the FullName field 6610 and the leftmost duplicate (as well as between the other duplicates) is increased and the duplicates are seen not to overlap.

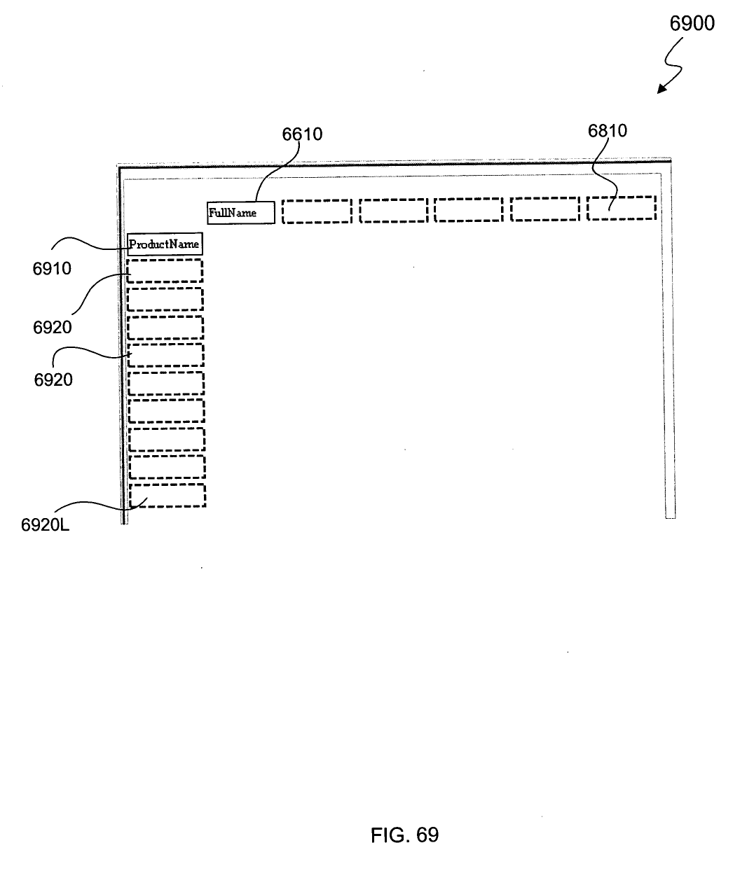

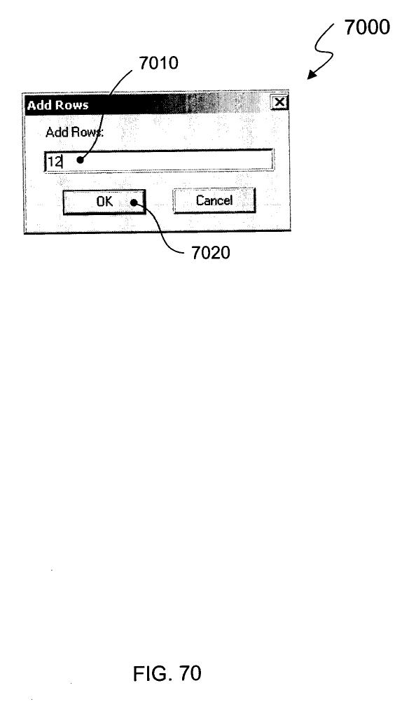

Turning now to the screenshot of the report page 6900 of FIG. 69 (displayed within the Page view pane 5530), the ProductName field 6910 is seen to be dropped from the Row Fields group lower and to the left of the FullName field 6610. Duplicate fields 6920 will also be displayed, but will be arranged vertically downward from the primary field (i.e., the ProductName field 6910). The last duplicate 6920L of the ProductName field 6910 may be moved lower if it is desired to increase the spacing between and among the ProductName field 6910 and its duplicate fields 6920. Given that space appears to exist at the bottom of the page 6900, it may be desired to increase the number of rows on the page. A context menu may be displayed by right-clicking on any part of the Page view pane 5530 and selecting Add Rows, which results in display of the Add Rows dialog 7000 of FIG. 70. The desired number of rows to be added (e.g., 12) are then entered into field 7010 of dialog 7000, and the OK button 7020 is selected.

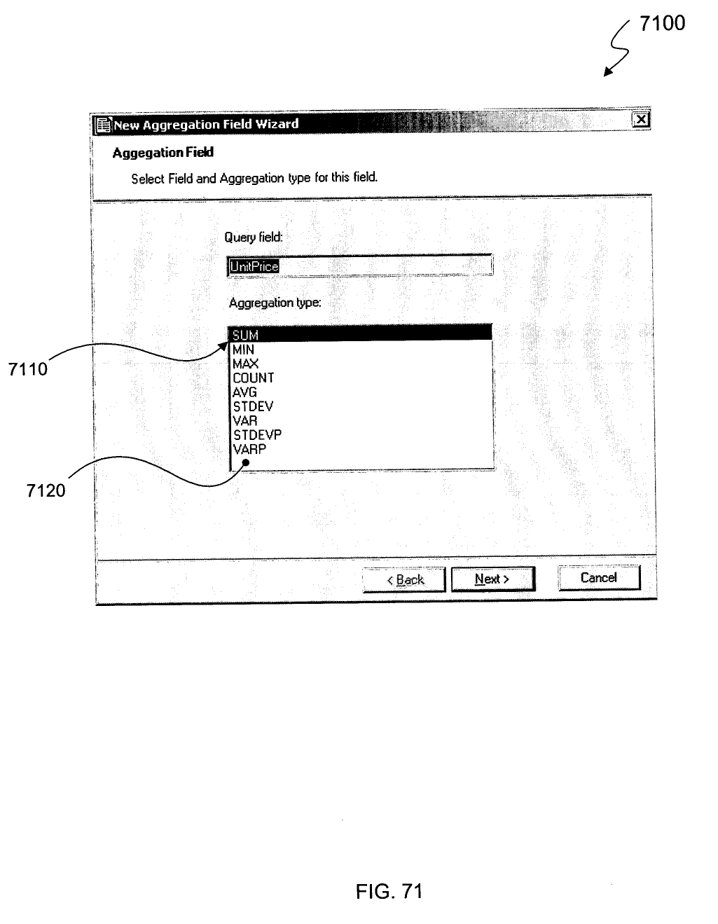

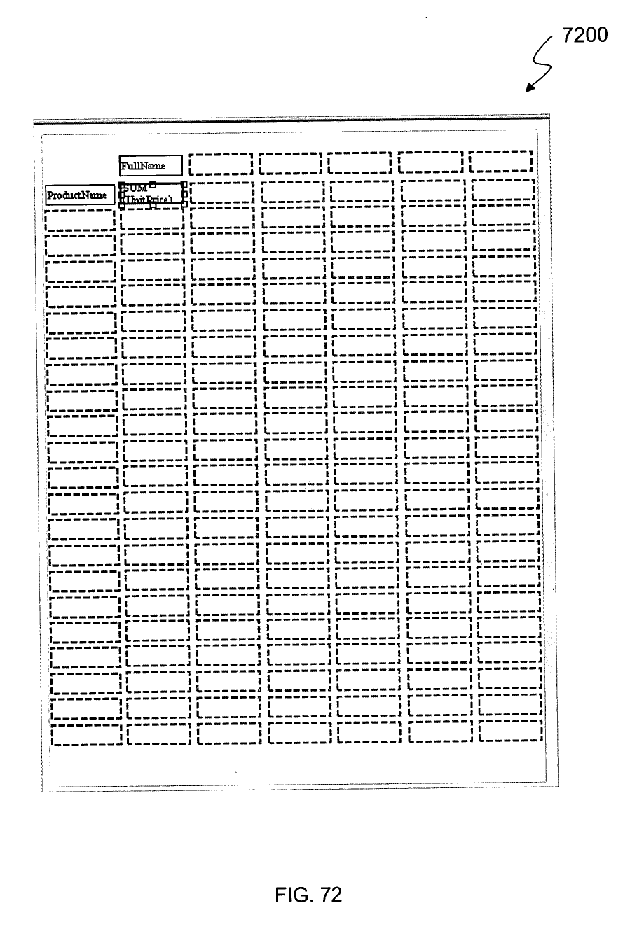

Next, one of the Center Fields 6550 (FIG. 65) are positioned inside the table being designed. Specifically, in the present example the UnitPrice field 6560 is drawn from Center Fields 6550 into the page 6900 under FullName 6610 and to the right of ProductName 6910. After dropping the field 6560 into the page 6900, the New Aggregation Field Wizard runs and permits selection of one of several available aggregation functions for the field. This is illustrated by the screenshot of the New Aggregation Field Wizard window 7100 of FIG. 71. In the present example SUM 7110 is selected from Aggregation Type pane 7120. As a consequence of this creation of a central field type, the page 6900 is transformed within the Page view pane 5530 into the new page 7200 of FIG. 72.

An exemplary process of defining PivotTable fields may be summarized as follows:

1) Drag and drop fields for X axis from the displayed picklist

2) Drag and drop fields for Y axis from the displayed picklist

3) Drag and drop fields for center cells

4) Specify how the center cells will be aggregated (Sum, Average, etc.)

3.3. Adding Sorting for Groups

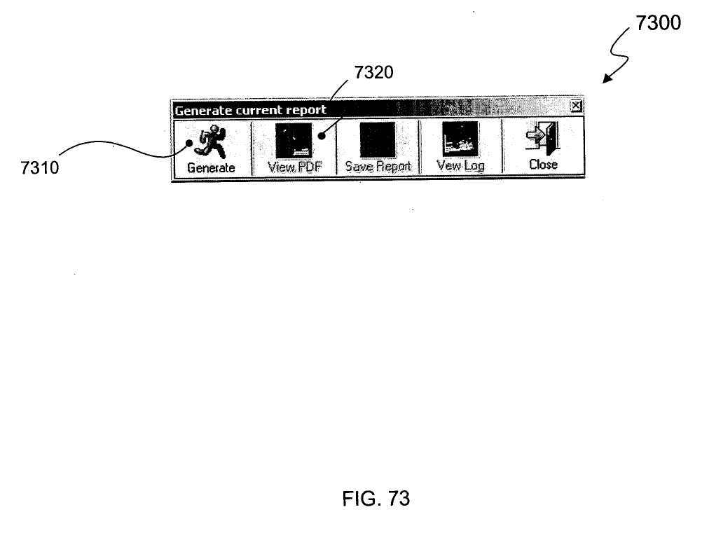

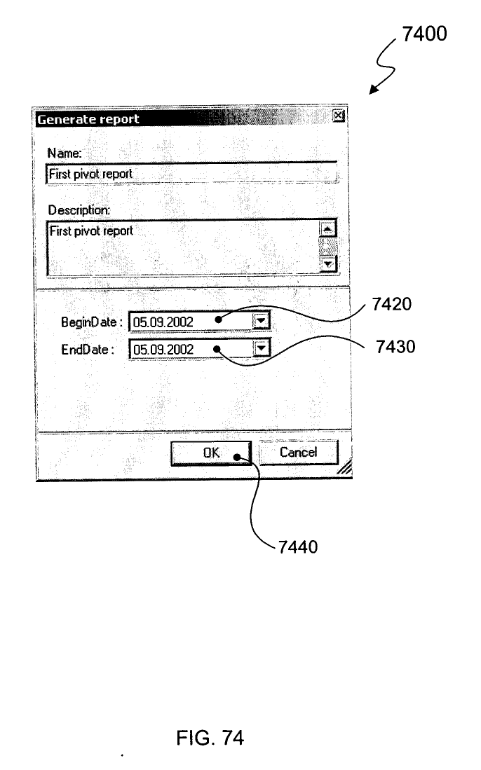

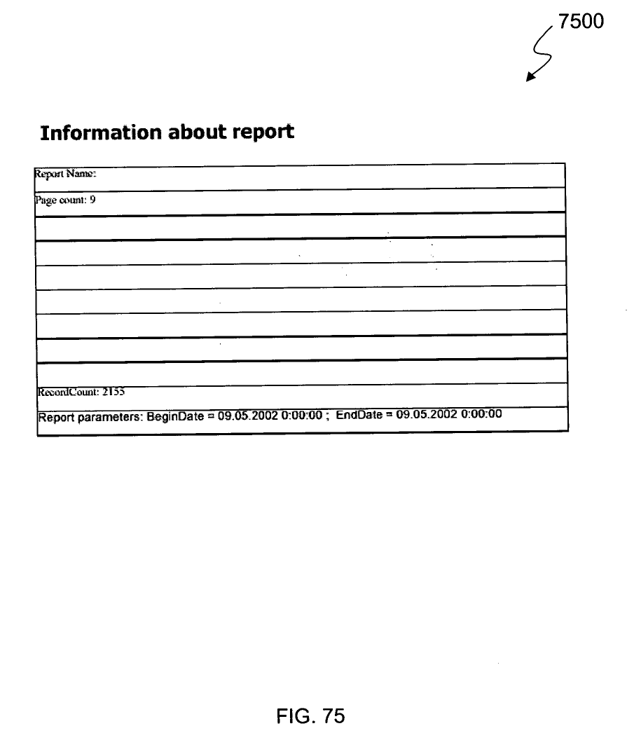

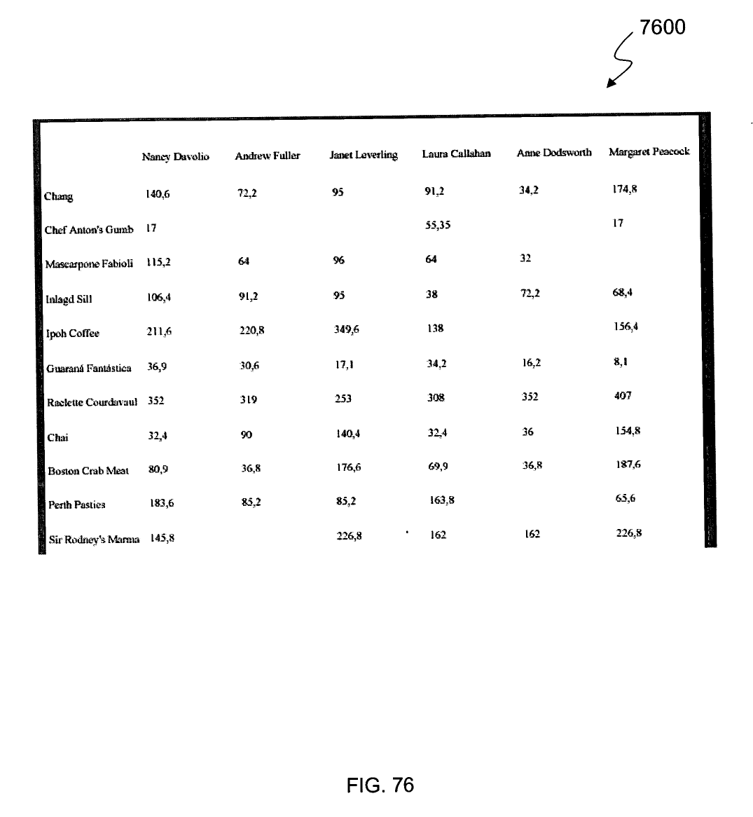

The Pivot Table Report designed in the previous sections is now ready to be generated and viewed. To this end, FileåGenerate Report is selected from within the Report Designer application 210 (see, e.g., FIG. 65). The results in appearance of a Report Generation window 7300 as shown in FIG. 73. Upon clicking of the Generate button 7310, a Report Parameter Entry window 7400 (FIG. 74) will appear to the extent the applicable report requires one or more parameters to be defined. Once values of these parameters have been entered in the appropriate fields (e.g., the BeginDate field 7420 and the EndDate field 7430), the OK button 7440 is selected and the report is generated. Following completion of generation of the report, the buttons of the Report Generation window 7300 which were previously “grayed out” (e.g., the View PDF button 7320) now become selectable. For example, if the View PDF button 7320 is now selected an initial page 7500 of the resultant PDF-based output report is displayed (FIG. 75). A portion of the second page 7600 of the report is shown in FIG. 76.

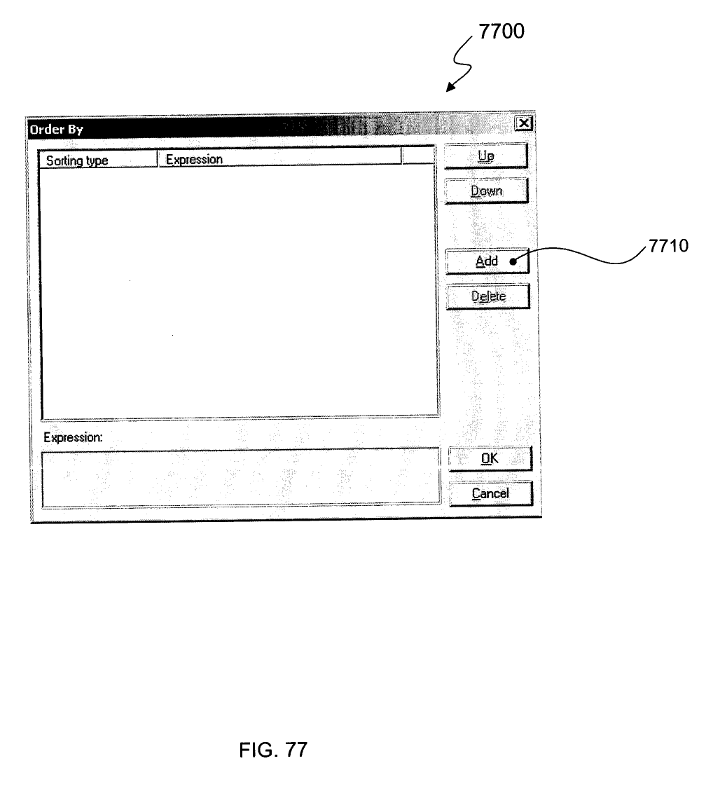

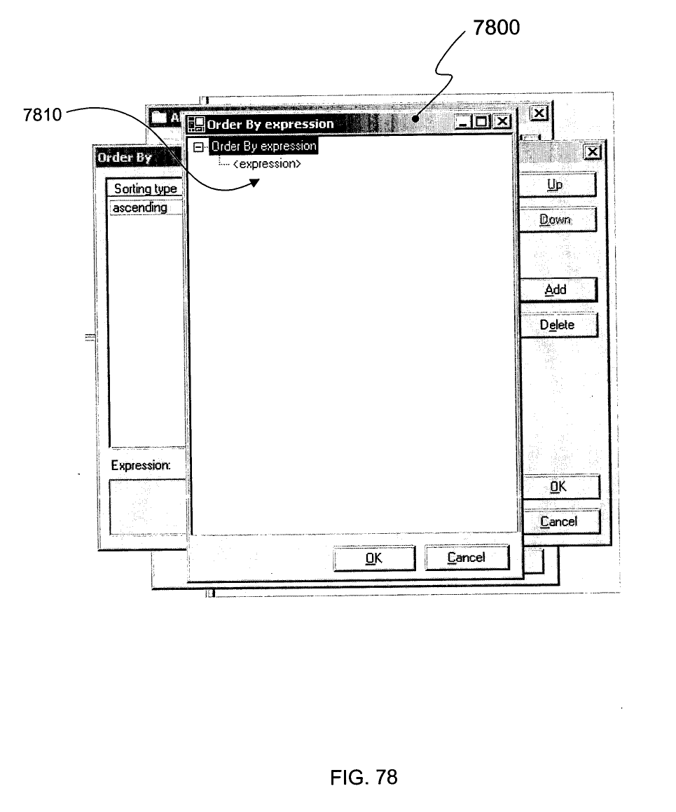

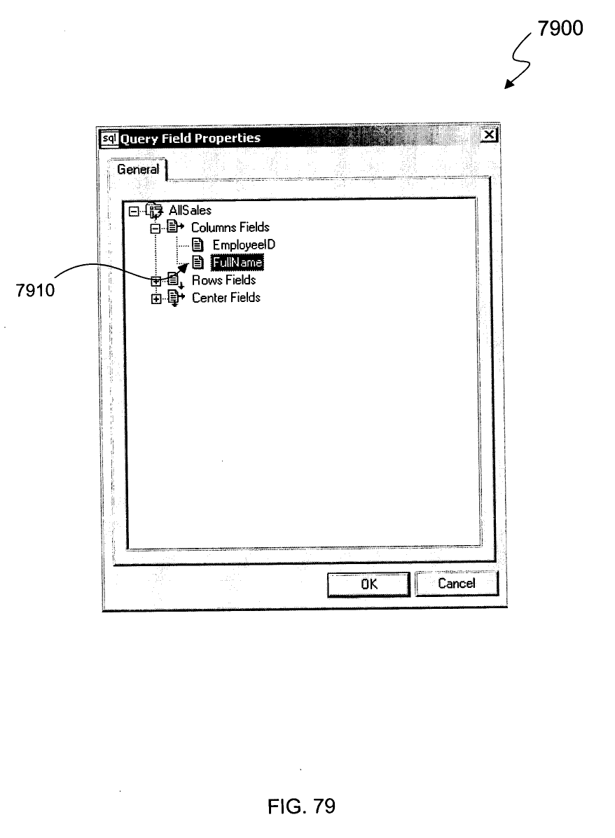

In accordance with one aspect of the invention, the information present within the rows and columns of a given report may be sorted in a desired manner. Continuing with the present example, in order to add sorting for rows and columns the Group Properties window 6700 for the AllSales group is opened after closing the Report Generation window 7300. After selecting the Pivot Table Description tab 6710 (FIG. 67), the Edit column order button 6740 is selected in order to enable report columns to be sorted. Selection of the button 6740 causes the Order By window 7700 of FIG. 77 to appear. In order to add sorting the Add button 7710 is clicked. A row with ascending-type sorting is then added and a Sort Order edit window 7800 appears (FIG. 78). Within the window 7800, the <expression> item 7810 is clicked upon and in a resulting popup menu (not shown) an Add Field button is selected. A Query Field Properties window 7900 (FIG. 79) with selection options for available groups will then appear. From within the window 7900 a FullName field 7910 is selected. In the present example all open windows (except for the Group Properties window 6700) are then closed by clicking the applicable OK button.

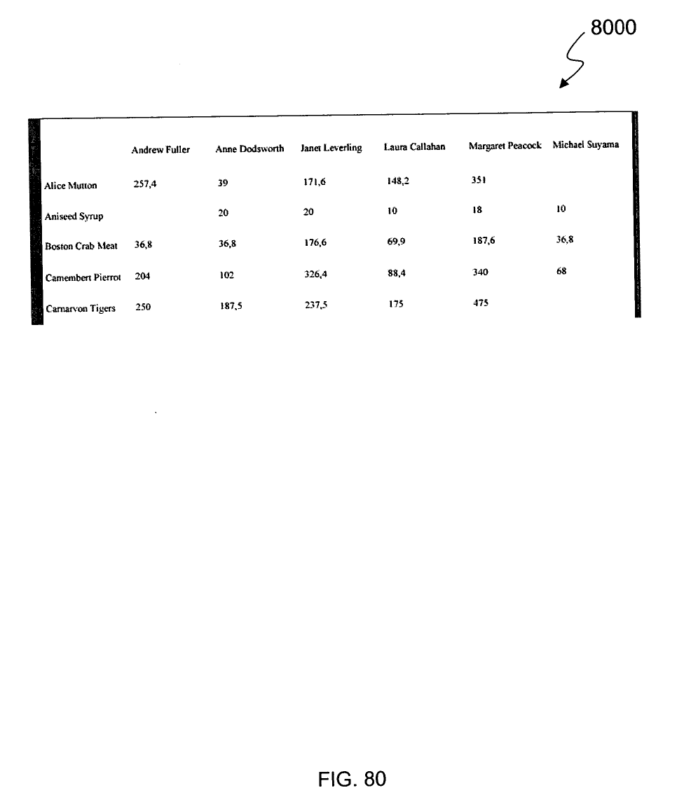

A sort order for rows can be specified in a substantially similar manner after clicking upon an Edit row order button 6750 of the Group Properties window 6700 (FIG. 67). Subsequent steps in the row ordering process are the same as for columns except for selection of ProductName from Row Fields. The row and column sorting which has been specified as described above may be verified by generating another report, which includes the page portion 8000 shown in FIG. 80.

3.4. Adding Totals

In an exemplary embodiment both Header totals and Cell totals may be appended to fields within groups of type PivotTable. In this regard Header totals are associated with total values of rows/column header fields and do not include aggregation by query fields. However, Header totals may include static text or other fields. Cell totals are associated with cell fields and may contain row and column total values. In addition, aggregation by query fields may also be associated with Cell totals. Other calculations of total values are possible:

Page Total—totals calculated for values on a page (on row or column value)

Grand Total—totals calculated for entire report (on row or column value)

Table Page Total—total calculated value of a page (on rows and columns)

Table Grand Total—totals computed for entire report (on rows and columns)

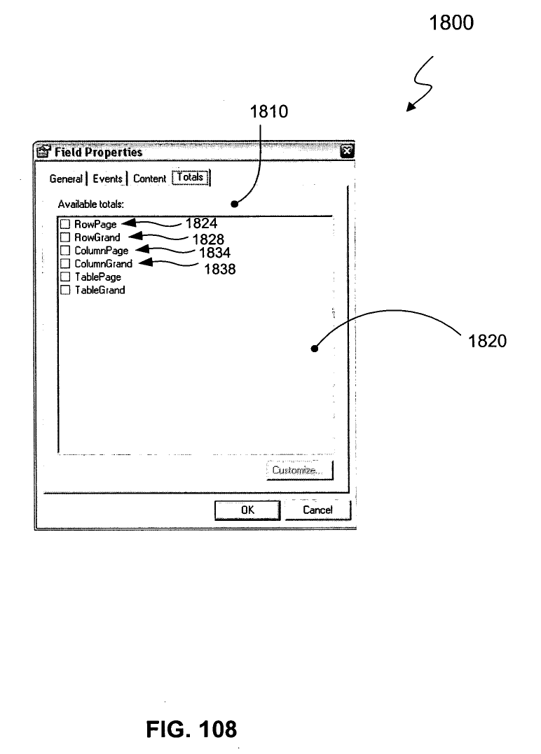

FIG. 108 is a screen shot of a Field Properties window 1800 through which totals may be appended to a given field of a report page. In order to access the window 1800, the field is selected and a right-clicking operation or the like is used to display a contextual menu (not shown) having a Properties tab. Selection of a Totals tab 1810 from the Properties screen results in display of the window 1800. Within the Available Totals pane 1820, selection of a row total (i.e., RowPage 1824 or RowGrand 1828) will cause the last row on the applicable report page to become a “totals row”. If two totals are selected then the last two rows of the applicable report page become totals rows. An analogous result occurs with respect to the columns of the applicable report page upon selection of either of the column-related totals items ColumnPage 1834 or ColumnGrand 1838.

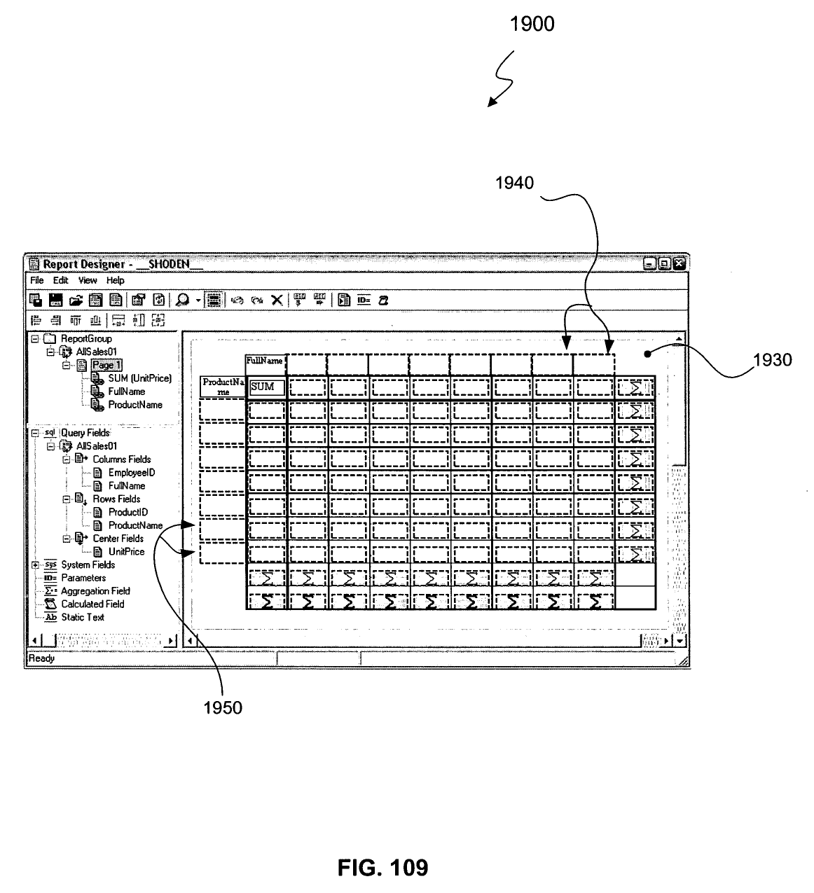

FIG. 109 is a screen shot of a window 1900 generated by the ReportDesigner application 210 which illustrates a particular example of row-based and column-based totals. Specifically, FIG. 109 reflects the case in which RowPage, RowGrand and ColumnPage totals have been selected for a particular field. If in this case the report pages have been set up to display 10 rows and columns per page (group parameters), then the illustrated page layout will appear as shown in primary pane 1930 of window 1900. As shown, this page layout will result in each report pages being comprised of 9 columns 1940 and 8 rows 1950 for data output, and of a 9^{th} row and 10^{th} column containing totals values. In addition, the last report page will further include a row grand total.

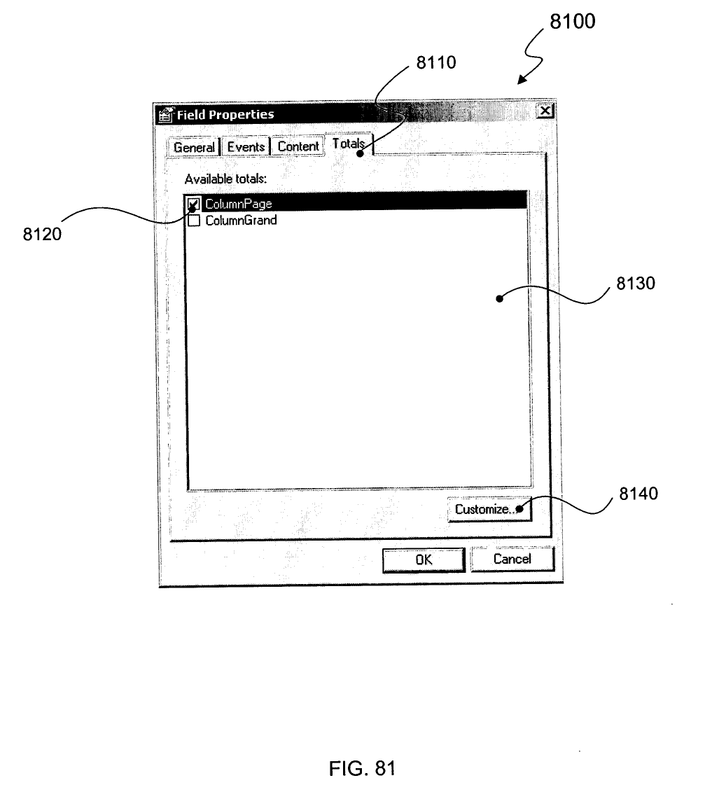

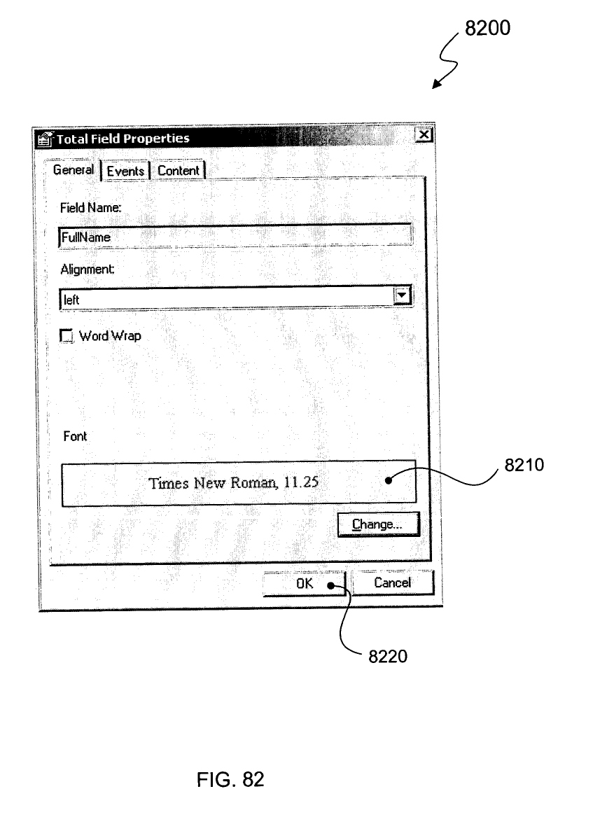

Turning now to FIG. 81, a screen shot is provided of a Field Properties window 8100 to which reference will be made in further describing one manner in which one or more totals columns may be added to a report page layout consistent with the invention. Again, the addition of a totals column to the page layout results in a column reflecting various summations to be added to each report page. In order to create such a column in the present example, a Field Properties window 8100 of the FullName field is caused to appear and a Totals tab 8110 selected (FIG. 81). A check is placed in a box 8120 associated with the ColumnPage item within the list of available totals displayed in pane 8130. As a result of these actions the Customize . . . button 8140 has become available and it is further possible to adjust the appearance of the selected type of totals field (i.e., ColumnPage). Clicking the Customize . . . button 8140 results in display of an associated Total Field Properties dialog 8200 (FIG. 82). In the present example the Font pane 8210 indicates that a font type of “Times New Roman” and a font size of “11” have been selected. The Total Field Properties dialog 8200 may then be closed by clicking upon the OK button 8220.

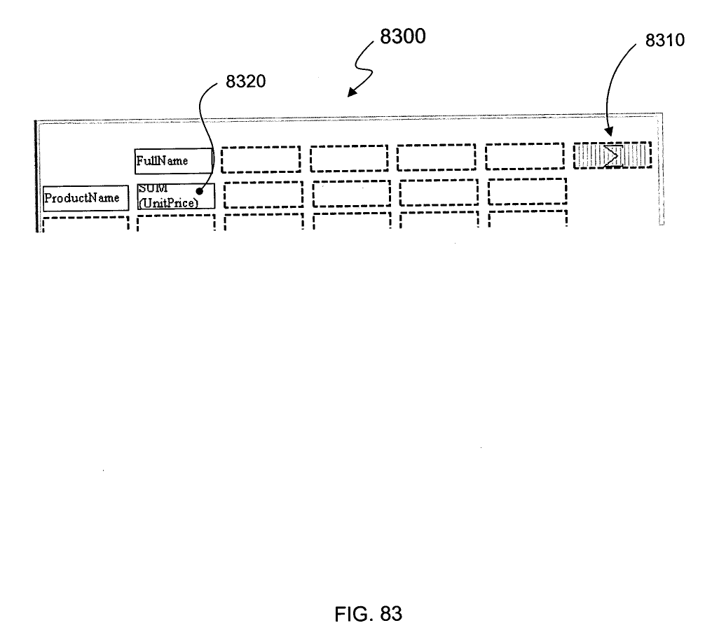

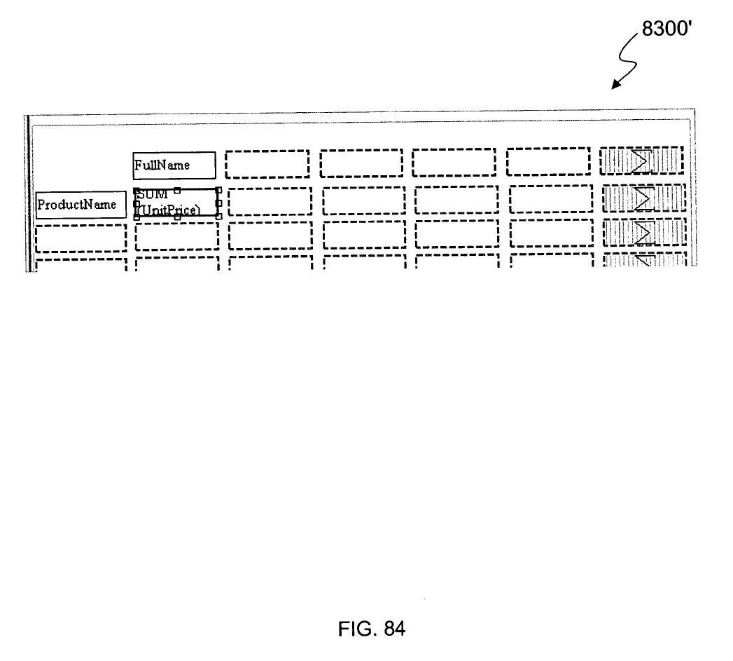

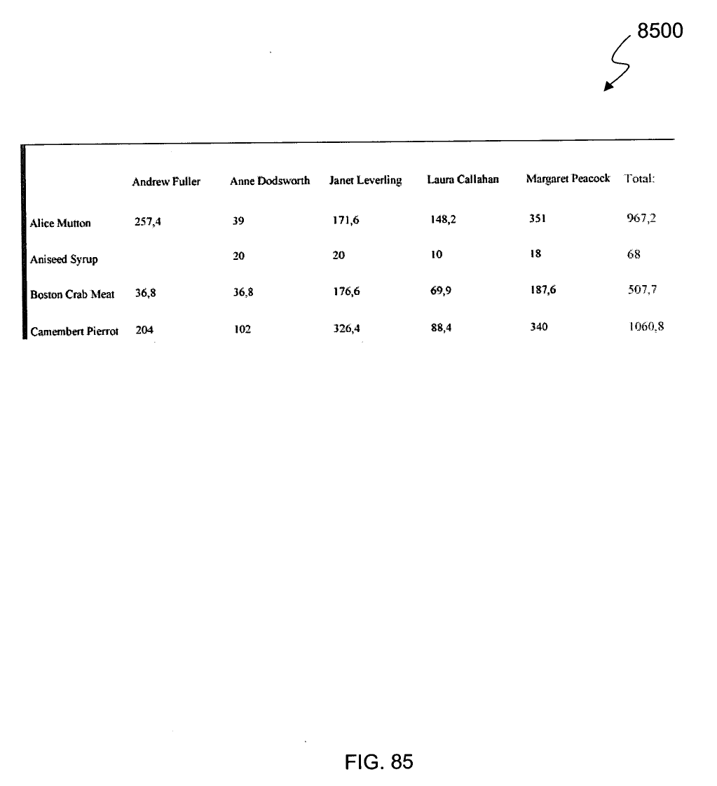

FIG. 83 provides a screenshot of a portion of a page 8300 displayed within the Page view pane 5530 which reflects modifications resulting from performance of the operations described above. Specifically, the number of columns in the page 8300 with data is seen to have been decreased by one and the last column 8310 is seen to comprise a Totals column. In order to add Totals data to the definition of the current report, properties of the central fields 8320 are accessed. This is effected by accessing the Totals tab 8110 of the Field Properties window 8100 and selecting the same total (i.e., ColumnPage). FIG. 84 provides a screenshot of the page portion 8300 as transformed to contain column fields for totals data. An output page 8500 of the PDF-based report generated in accordance with this totals column definition is depicted in FIG. 85.

4. Creating and Utilizing Pivot Master-Detail Groups

This section discusses the manner in which the group type Pivot Master-Detail may be created, set up and utilized in report generation consistent with the invention.

4.1. Creating Pivot Master-Detail Group

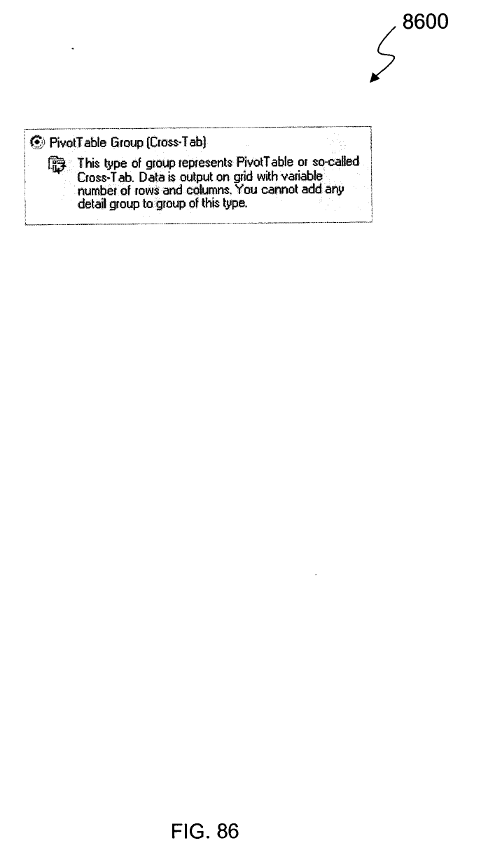

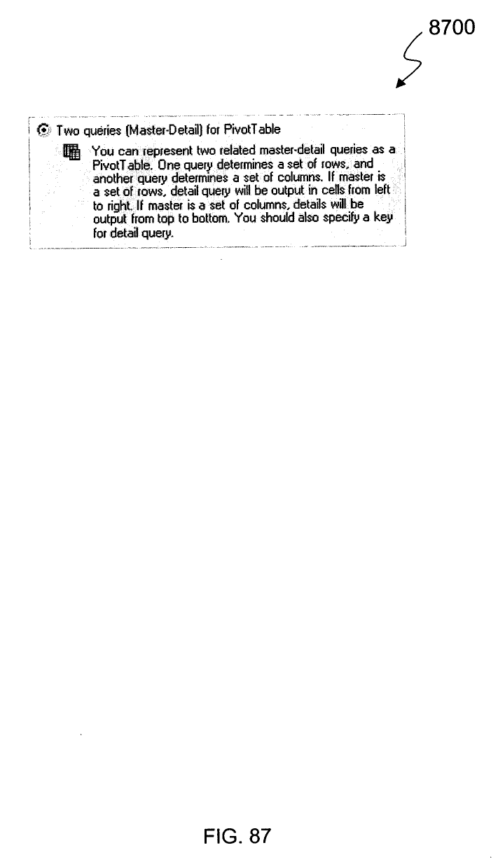

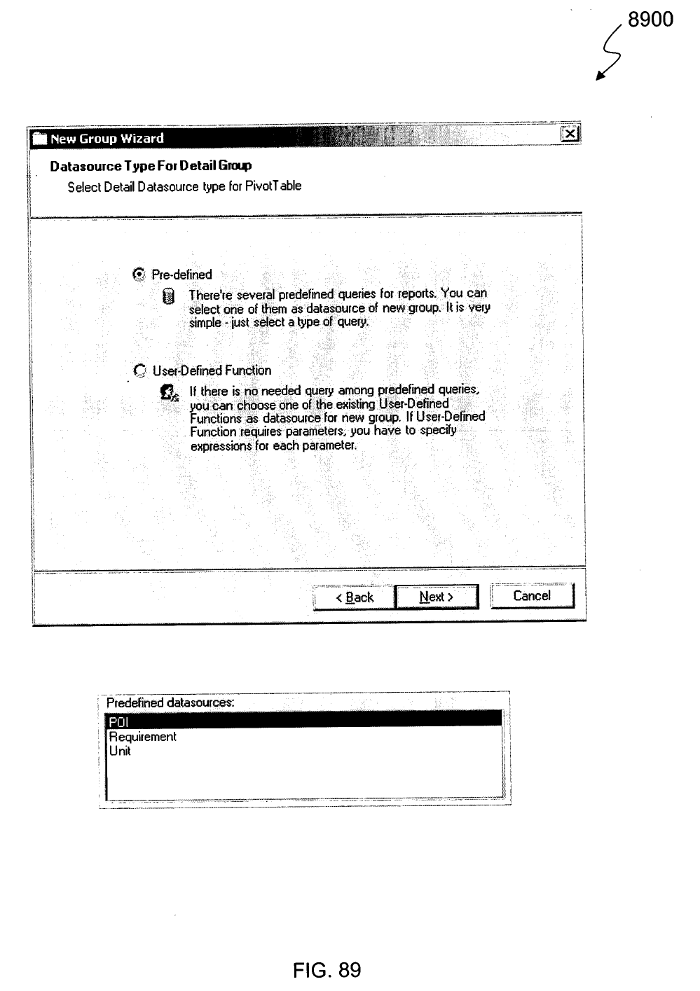

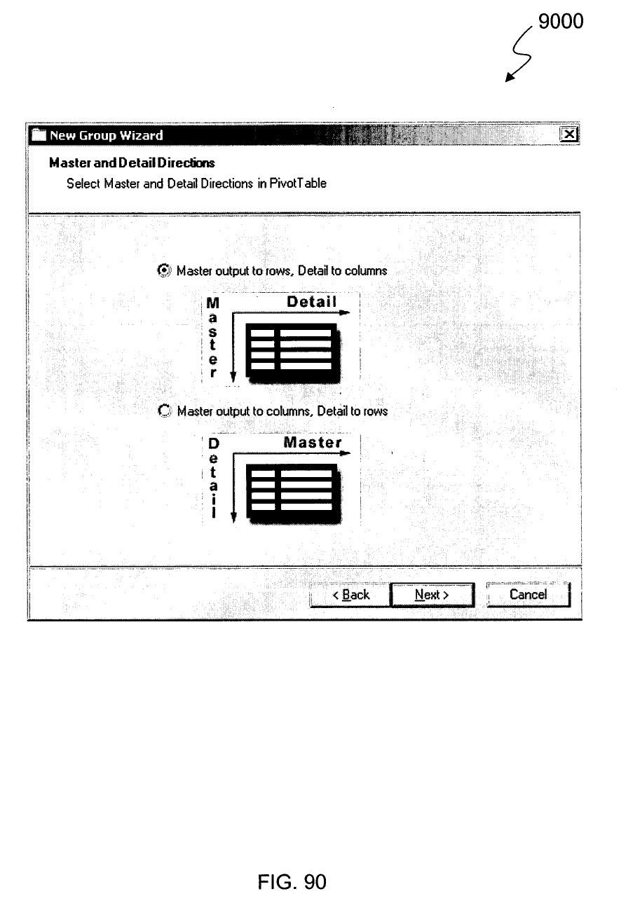

Turning to FIG. 86, a screenshot is provided of a window portion 8600 of the New Group Wizard window 4600 from which the PivotTable Group has been selected. On the next page 8700 displayed by the New Group Wizard, the parameter “Two queries (Master-Detail) for PivotTable” is selected (FIG. 87). In the present example the third page 8800 displayed by the New Group Wizard permits the selection of a datasource type for the Master (Pre-defined or User-Defined Function) and the setup the selected datasource. The same selection process is carried out for the Detail datasource via the Datasource Type for Detail Group window 8900 shown in FIG. 89. As shown in FIG. 90, a Master and Detail Directions window 9000 enables selection of the directions in which the Master and Detail datasource information should be displayed.

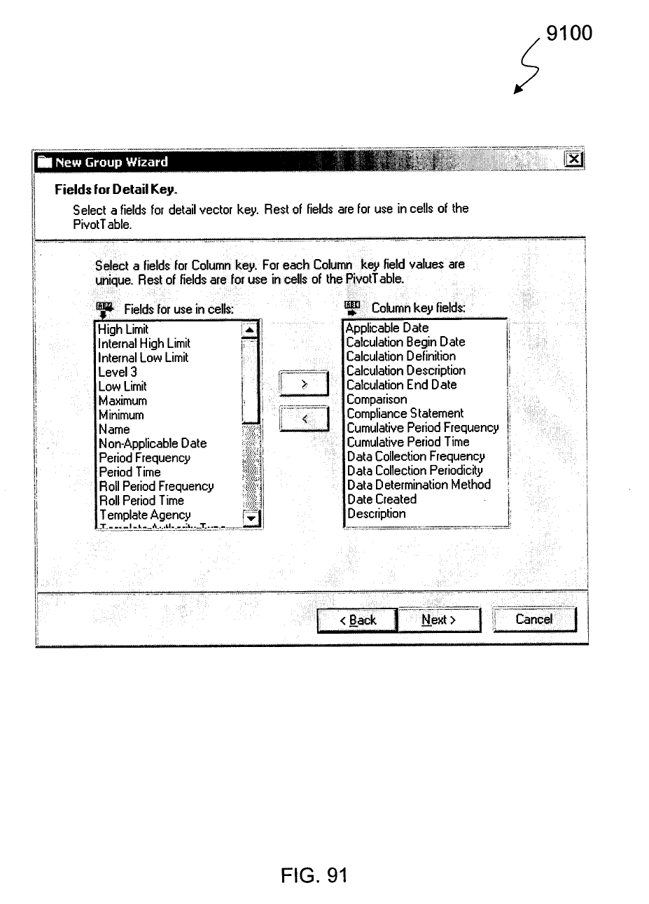

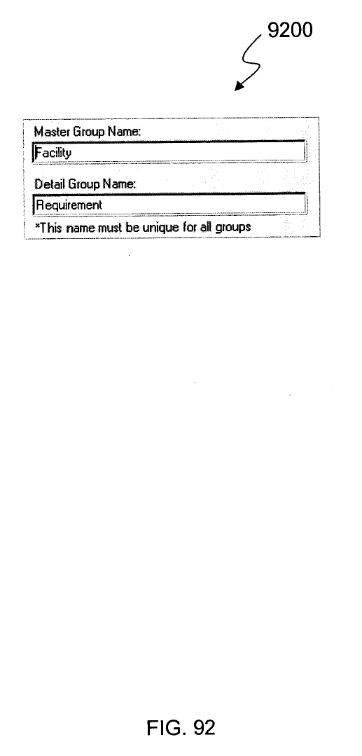

In the exemplary embodiment all Master fields may be displayed in the selected direction, and fields from source-detail are split in two parts: displayed in row or column name and displayed inside the table. This splitting of the fields may be effected through the Fields for Detail Key window 9100 of FIG. 91. Specifically, the Master and Detail group names are entered as indicated by the window portion 9200 shown in FIG. 92. The New Group Wizard is then finished (not shown).

4.2. Properties of Pivot Master-Detail Group

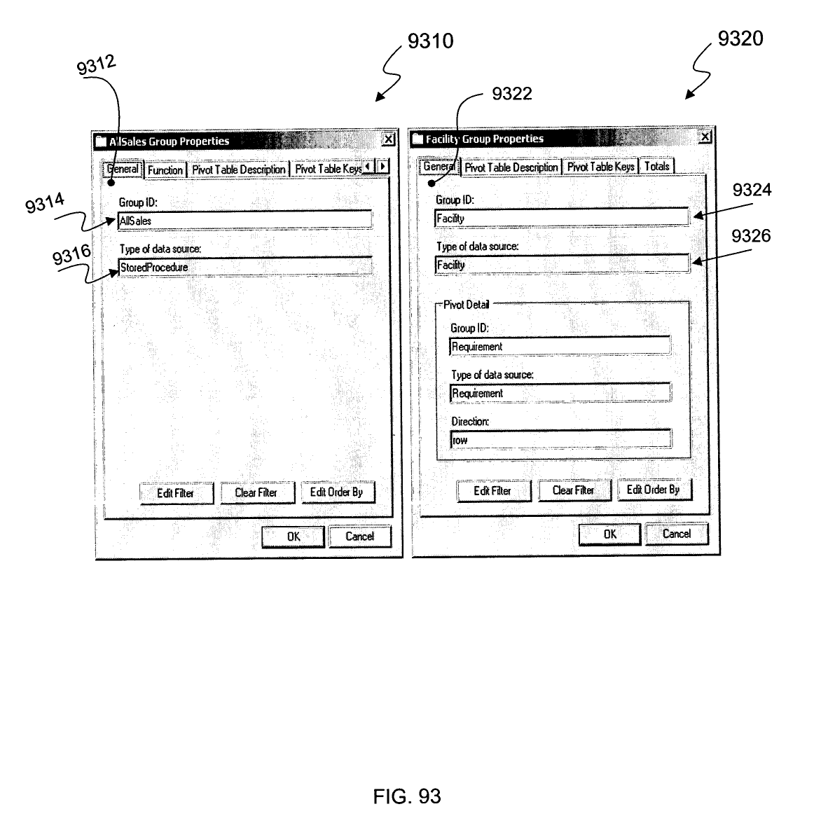

FIG. 93 illustratively represents a pair of screenshots which enable comparison of various aspects of the properties of the Pivot and Pivot Master-Detail group types. In particular, FIG. 93 includes a screenshot of a first Group Properties window 9310 representative of the AllSales group, which is of type Pivot. FIG. 93 also includes a second Group Properties window 9320 representative of the Facility group, which is of type Pivot Master-Detail. As shown, the General tabs 9312, 9322 of the windows 9310, 9320 each include a Group ID field 9314, 9324 and a Type of data source field 9316, 9326.

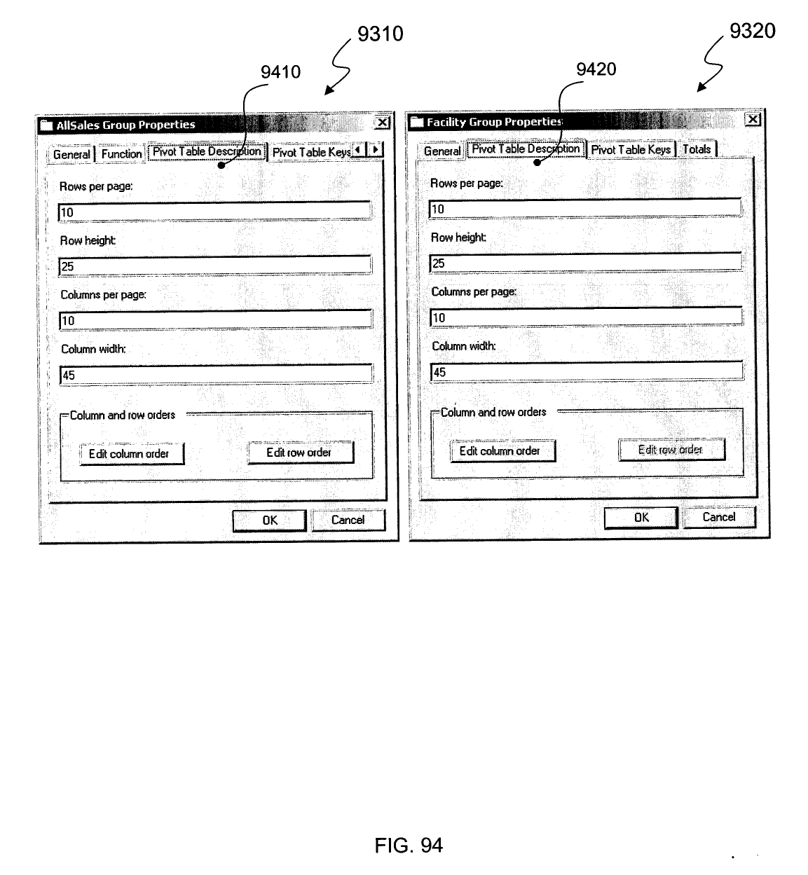

Turning now to FIG. 94, screenshots are provided of the windows 9310, 9320 upon selection of their respective Pivot Table Description tabs 9410, 9420. It is observed that row order for the Facility group of type Master-Detail is not set through the interface provided by the Pivot Table Description tab 9420, but may be set via such interface for the AllSales group of type Pivot.

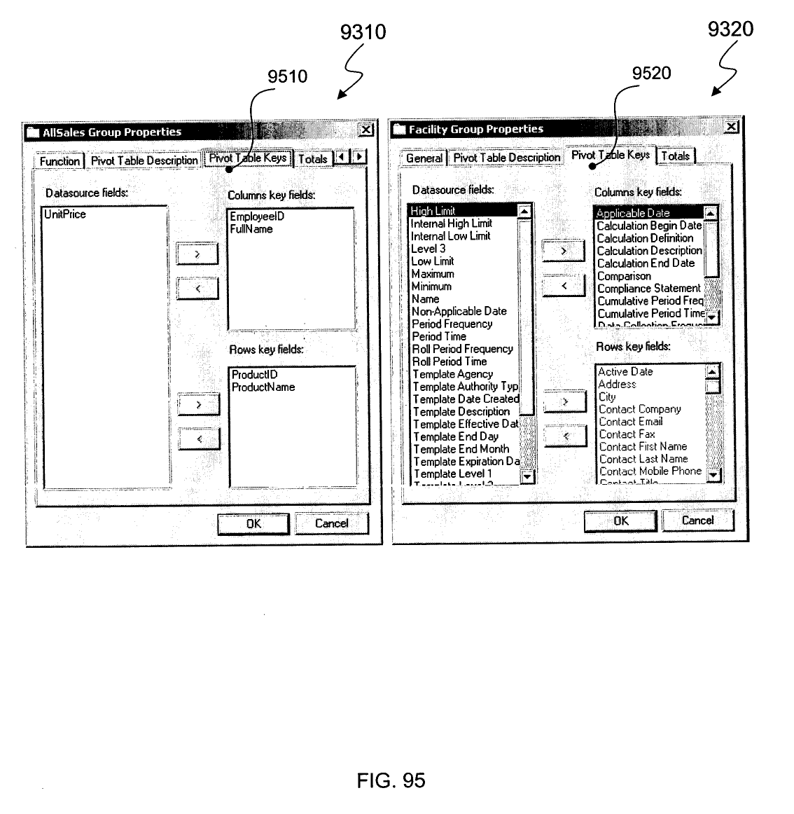

FIG. 95 depicts screenshots of the windows 9310, 9320 upon selection of their respective Pivot Table Keys tabs 9510, 9520. As may be appreciated from FIG. 95, in the exemplary embodiment all Master fields are displayed in a defined direction; that is, it is not possible to move the fields to/from the corresponding group.

5. Smartpaging

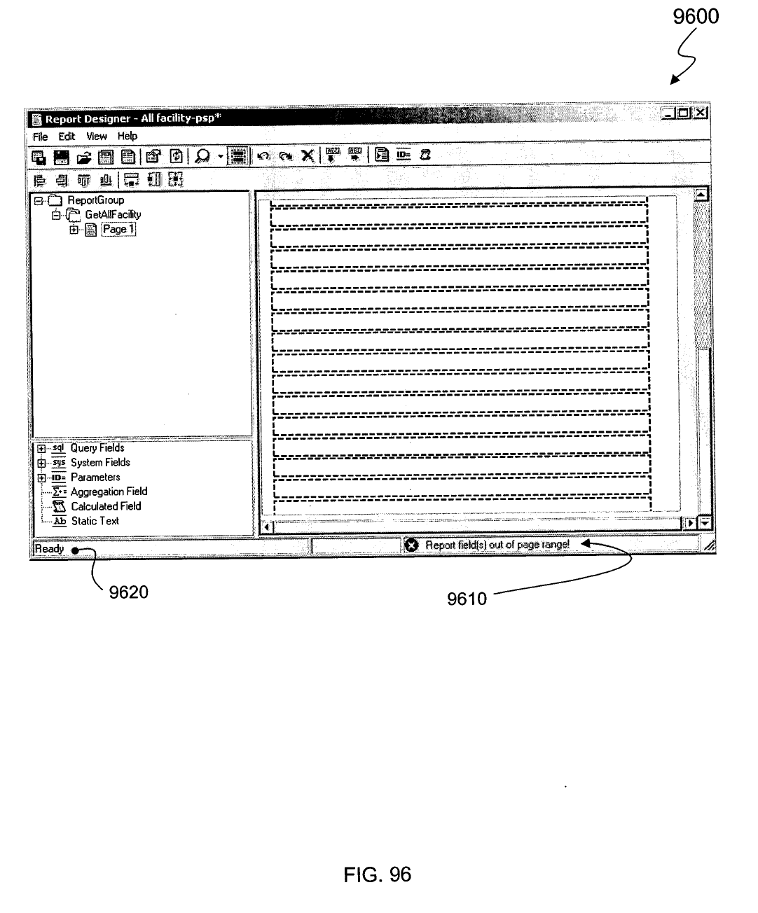

In accordance with the invention, the smartpaging feature may be employed in connection with reports comprised of all group types (i.e., MultiRow, Pivot and Pivot Master-Detail). As described above, in the exemplary embodiment it is possible to set the number of rows (columns) displayed on each report page during the process of defining an instance of each group type. Moreover, the Report Designer application 210 shows the manner in which the fields of each given page will be displayed and permits adjustment of their size (both vertically and horizontally). During this page definition process it is generally necessary to place all displayed fields on the page. If certain of the fields extend beyond the boundaries of the applicable page, an error message is displayed. See, for example, the error message 9610 displayed upon lower border 9620 of the Report Designer window 9600 of FIG. 96.

Consistent with the smartpaging feature of the invention, a user is not required to explicitly count and individually set-up the pages in a report after specifying the number of fields per page and their size. Instead, the smartpaging utility counts the number of records in the report and arranges them upon the required number of pages, displaying them in the manner the user has specified on the initial page of the report.

A number of embodiments of the present invention have been described. Nevertheless, it will be understood that various modifications may be made without departing from the scope of the invention. For example, the methods of the present invention can be executed in software or hardware, or a combination of hardware and software embodiments. As another example, it should be understood that the functions described as being part of one module may in general be performed equivalently in another module. As yet another example, steps or acts shown or described in a particular sequence may generally be performed in a different order. Moreover, the numerical values for the operational and implementation parameters set forth herein are merely exemplary, and other embodiments and implementations may differ without departing from the scope of the invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following claims and their equivalents define the scope of the invention.

What is claimed is:

1. A method of designing a report file used for automatic report generation, the method comprising:
specifying a structure of the report file by defining a first report group comprised of one or more page definitions, the first report group being of a first group type selected from among a plurality of predefined group types;
associating a first data source with the first report group;
identifying one or more fields for inclusion within each of the one or more page definitions; and
specifying an association between content from the first data source and each of the one or more fields.

2. The method of claim 1 further including associating one or more properties with each of the one or more fields.

3. The method of claim 1 wherein the plurality of predefined group types consist of form, grid and pivot table.

4. The method of claim 1 wherein the first report group is specified to also include a second report group.

5. The method of claim 1 wherein the first group type is a pivot table type comprised of a plurality of rows and a plurality of columns, the associating including associating the first data source with the plurality of rows and a second data source with the plurality of columns.

6. The method of claim 1 wherein the specifying an association includes selecting content items from a fields tree displayed to a user.

7. A report generation method comprising:
creating a report file defining a report structure based upon at least one report group comprised of or more page definitions, the report file containing information identifying one or more data sources associated with the at least one report group and field descriptive information relating to a plurality of fields included within the one or more page definitions;
retrieving data source information from the one or more data sources; and
rendering an output report document based upon the report file and the data source information, the output report document including one or more output report pages formatted consistently with each of the one or more page definitions.

8. The method of claim 7 further including prompting a user to enter parameter values associated with the plurality of fields and receiving the parameter values entered by the user.

9. The method of claim 7 wherein the output report document comprises a PDF document.

10. The method of claim 9 wherein the rendering includes automatically generating additional pages of the output report document as necessary to incorporate the entirety of the data source information into the output report document.

11. The method of claim 7 wherein the creating includes specifying a first report group and a second report group and wherein a first set of the one or more page definitions are associated with the first report group and a second set of the one or more page definitions are associated with the second report group.

12. The method of claim 11 wherein the creating includes associating a first data source with the first report group and a second data source with the second report group.

13. The method of claim 7 wherein the field descriptive information includes formatting information.

14. The method of 13 wherein the field descriptive information further includes field coordinate information.

15. The method of claim 7 wherein the rendering includes concatenating first and second values corresponding to the first and second items of the data source information.

16. The method of claim 7 wherein a first of the plurality of fields comprises a query field, the data source information including a value associated with the query field.

17. The method of claim 16 wherein a second of the plurality of fields comprises an aggregation field having a value based upon the value of the first of the plurality of fields and a third of the plurality of fields.

18. The method of claim 16 wherein the second of the plurality of fields comprises a calculated field having a value produced by execution of a script.

19. A report generation system comprising:
a client unit configured to execute plural client components including a report explorer application and a report designer application, the report designer application containing a report rendering module;
a server unit configured to execute plural server components including a business logic module and a report writer module wherein the report writer module is configured to cooperate with the client unit in producing the report file; and
a database server in communication with the server unit, the database server providing content information to the server unit in connection with production by the report rendering module of an output report document based upon the report file.

20. The system of claim 19 wherein the report file is based upon a report structure containing at least a first report group comprised of one or more page definitions.

21. The system of claim 20 wherein the report file includes a database query reflecting an association between a first data source and the first report group, the first data source being furnished by the database server.

22. The system of claim 20 wherein the report structure is based upon an association between one or more fields and each of the one or more page definitions.

23. The system of claim 22 wherein the report file includes descriptive information associated with the one or more fields.

24. A report file disposed to be executed in connection with generation of an output report document, the report file comprising:
a database query identifying a data source;
data filter information defining filter operations to be performed upon source data retrieved from the data source;
descriptive information specifying the location and appearance of the source data within pages of the output report document; and
textual data to be displayed upon the pages of the output report document.

25. The report file of claim 24 wherein the database query reflects an association between the data source and a first report group comprised of at least a first page, the first report group being of a first group type selected from among a plurality of predefined group types.

26. The report file of claim 25 wherein the first report group is further comprised of a second report group.

27. The report file of claim 25 wherein the first group type is of a pivot table type.

28. The report file of claim 25 further including user defined script information.

29. A report file disposed to be executed in connection with generation of an output report document, the report file comprising:
a first database query identifying a first data source, the first database query reflecting an association between the first data source and a first report group;
a second database query identifying a second data source, the second database query reflecting an association between the second data source and a second report group;
data filter information defining filter operations to be performed upon source data retrieved from the first data source and from the second data source;
descriptive information specifying the location and appearance of the source data within pages of the output report document; and
input parameter definitions corresponding to input parameter information to be provided to the report file by a user.

30. The report file of claim 29 further including textual data information corresponding to textual data to be displayed upon the pages of the output report document.

31. The report of claim 29 wherein the first report group is comprised of at least a first page, the first report group being of a first group type selected from among a plurality of predefined group types.

32. The report file of claim 29 wherein the first report group is further comprised of a third report group.
